(19) United States
(12) Patent Application Publication
(10) Pub. No.: US 2023/0381861 A1
(43) Pub. Date: Nov. 30, 2023

(54) METHOD FOR MANUFACTURING IRON (Fe)-NICKEL (Ni) ALLOY POWDER

(71) Applicant: SUMITOMO METAL MINING CO., LTD., Tokyo (JP)

(72) Inventors: Masaya Yukinobu, Niihama (JP); Minseob Shin, Niihama-shi (JP); Shiori Mizuno, Niihama-shi (JP)

(73) Assignee: SUMITOMO METAL MINING CO., LTD., Tokyo (JP)

(21) Appl. No.: 18/031,997

(22) PCT Filed: Oct. 15, 2021
(86) PCT No.: PCT/JP2021/038261

§ 371 Date: Apr. 14, 2023

(30) Foreign Application Priority Data
Oct. 16, 2020 (JP) 2020-175002
Mar. 9, 2021 (JP) 2021-037396
Aug. 31, 2021 (JP) 2021-140962

(51) Int. Cl. B22F 9/24; C22C 19/03; C22C 1/04; C22C 30/00; C22C 33/02; C22C 38/08; B22F 9/04; B22F 1/142; B22F 1/16; B22F 1/065; H01F 1/147

(52) U.S. Cl. CPC B22F 9/24; C22C 19/03; C22C 1/0433; C22C 30/00; C22C 33/0235; C22C 38/08; B22F 9/04; B22F 1/142; B22F 1/16; B22F 1/065; H01F 1/14733; C22C 2202/02; B22F 2301/35; B22F 2301/15; B22F 2999/00; B22F 2998/10; B22F 2302/256; B22F 2304/058; B22F 2304/056

(57) ABSTRACT

The method is: a preparation step in which a magnetic metal source, a nucleating agent, a complexing agent, a reducing agent, and a pH adjusting agent are prepared as starting materials; a crystallization step in which a reaction liquid that includes the starting materials and water is prepared, and a crystallized powder that includes the magnetic metals is made to crystallize in the reaction liquid by a reduction reaction; and a recovery step in which the crystallized powder is recovered from the reaction liquid. The magnetic metal source includes a water-soluble iron salt and a water-soluble nickel salt, the nucleating agent is a water-soluble salt of a metal that is more noble than nickel, and the complexing agent is at least one type of substance selected from the group consisting of a hydroxy carboxylic acid, a salt of a hydroxy carboxylic acid, and a derivative of a hydroxy carboxylic acid.

### TECHNICAL FIELD

The present invention relates to a method for manufacturing an iron (Fe)-nickel (Ni) alloy powder.

### BACKGROUND ART

Iron-nickel alloys known as permalloy are soft magnetic materials having high magnetic permeability and used for magnetic cores of magnetic components such as choke coils and inductors. In particular, iron-nickel alloy powders are used as a material of a dust core for a magnetic core (dust magnetic core), which is obtained by compression-forming.

Various types of permalloys are known, such as 78 permalloy (permalloy A) and 45 permalloy, and they are used according to their magnetic properties and applications. The 78 permalloy is an iron-nickel alloy with a nickel content of about 78.5% by mass and is characterized by a high magnetic permeability. The 45 permalloy is an iron-nickel alloy with a nickel content of 45% by mass and is characterized by a slightly low magnetic permeability but a high saturation magnetic flux density.

In recent years, mobile devices such as laptop computers and smartphones have rapidly been downsized, and their performances have rapidly been improved. Accordingly, magnetic components such as inductors are required not only to have an improved magnetic property but also to respond to higher frequency. To this end, the materials of the dust core require high magnetic flux density and low losses. The losses mainly include hysteresis loss and eddy current loss. To suppress the hysteresis loss, it is effective to lower a coercive force of the alloy powder. On the other hand, to suppress the eddy current loss, it is effective to apply a thin insulative coating on a particle surface of the alloy powder to lower an eddy current between the particles, or it is effective to refine the alloy powder to decrease particle size distribution. This is because the presence of coarse particles makes it easy for the eddy current to flow within the coarse particles, resulting in losses due to Joule heat.

As methods for producing fine alloy powders, dry processes such as atomizing methods, vapor-phase reduction methods, and dry reduction methods are conventionally known. In the atomizing method, water or a gas is sprayed on a molten metal to rapidly cool and solidify the molten metal. In the vapor-phase reduction method, a metal halide in a vapor phase is hydrogen-reduced. In the dry reduction method, a metal oxide is reduced using a reducing agent.

For example, Patent Document 1 describes a process in which an Ni—Fe alloy powder used as a material for a noise filter, a choke coil, an inductor, or the like is manufactured by a vapor-phase reduction method ([0001] and [0014] in Patent Document 1). Also, Patent Document 1 discloses a process in which an Ni—Fe alloy fine powder is produced by heating a mixture of NiCl₂ and FeCl₃ and bringing the vaporized chloride into contact with hydrogen gas to cause a reduction reaction ([0016] in Patent Document 1). Patent Document 2 describes a process in which a Fe—Ni alloy powder used as a material for an electronic component such as a choke coil and an inductor is produced by reducing oxides of Fe and Ni in a reducing gas (claim 1 in Patent Document 2).

On the other hand, there has been a process in which a finer alloy powder is produced using a wet process. For example, Patent Document 3 discloses a method for manufacturing nickel-iron alloy nanoparticles, in which a reducing agent such as hydrazine is added to an aqueous solution containing a nickel salt and an iron salt to simultaneously reduce nickel ions and iron ions contained in the aqueous solution, resulting in nickel-iron alloy nanoparticles (claims 1 to 6 in Patent Document 3). It is considered that this manufacturing method makes it possible to efficiently manufacture nickel-iron alloy nanoparticles suitable as a filler for imparting magnetic properties and having an average primary particle size of 200 nm or smaller, on an industrial scale at a low manufacturing cost ([0015] in Patent Document 3).
Patent Document 1: Japanese Unexamined Patent Application, Publication No. 2003-193160
Patent Document 2: Japanese Unexamined Patent Application, Publication No. 2012-197474
Patent Document 3: Japanese Unexamined Patent Application, Publication No. 2008-024961

### DISCLOSURE OF THE INVENTION

### Problems to be Solved by the Invention

Although there have been the proposed processes in which fine alloy powders are produced by the dry and wet processes as described above, the conventional techniques have had a room for improvement for obtaining an alloy powder excellent in powder properties. For example, an alloy powder manufactured by an atomizing method has a large average particle diameter of several micrometers or larger, and does not sufficiently meet the demand for refinement. In vapor-phase reduction method proposed in Patent Document 1, the obtained alloy powder has a broad particle size distribution. Thus, the alloy powder contains coarse particles, and therefore this particle size distribution is insufficient for suppressing the eddy current loss. Also, there is a problem of unstable compositions and particle diameters of the alloy powder. Since the dry reduction method proposed in Patent Document 2 requires high-temperature heating, the method has a problem that the obtained alloy powder is prone to be sintered to form coarse agglomerated particles.

The wet process proposed in Patent Document 3 has an advantage in that it is difficult for coarse agglomerated particles to form because a reduction reaction proceeds at a low temperature unlike the dry process. Even if agglomerated particles are formed, the agglomerated particles can be easily crushed because the particles do not firmly bind to each other. However, in the process proposed in Patent Document 3, a large amount of hydrazine needs to be used as a reducing agent. Thus, the cost of the reducing agent is considerably increased, making the process impractical. In addition, the particle size distribution of the obtained alloy powder was not sufficiently small enough.

The inventors of the present invention conducted extensive studies in view of these conventional problems. As a result, they found that, when manufacturing an iron-nickel alloy powder by a wet process, an alloy powder excellent in powder properties and magnetic properties could be obtained by using a specific nucleating agent and complexing agent. Also, they found that, when an iron content was high, addition of a certain content of cobalt made it possible to obtain a spherical alloy powder with little agglomeration, a smooth surface, and a high saturation magnetic flux density, using a very small amount of reducing agent, by a reduction reaction enhancing action and a spheroidization enhancing action of cobalt.

The present invention has been completed based on these findings, and an object of the present invention is to provide a method for manufacturing an iron-nickel alloy powder excellent in powder properties and magnetic properties.

### Means for Solving the Problems

The present invention encompasses the following aspects (1) to (32). Note that, the expression “X to Y” includes numerical values at both ends of the range. In other words, “X to Y” is synonymous with “X or more and Y or less”.

(1) A method for manufacturing an iron (Fe)-nickel (Ni) alloy powder containing at least iron (Fe) and nickel (Ni) as magnetic metals, the method including;
a preparation step in which a magnetic metal source, a nucleating agent, a complexing agent, a reducing agent, and a pH adjusting agent are prepared as a starting material;
a crystallization step in which a reaction liquid containing the starting material and water is prepared, and a crystallization powder containing the magnetic metals is crystallized by a reduction reaction in the reaction liquid; and
a recovery step in which the crystallized powder is recovered from the reaction liquid, in which
the magnetic metal source contains a water-soluble iron salt and a water-soluble nickel salt;
the nucleating agent is a water-soluble salt of a metal more noble than nickel;
the complexing agent is at least one selected from a group consisting of hydroxycarboxylic acids, hydroxycarboxylic acid salts, and hydroxycarboxylic acid derivatives;
the reducing agent is hydrazine (N₂H₄); and
the pH adjusting agent is an alkali hydroxide.

(2) The method according to (1), in which the water-soluble iron salt is at least one selected from a group consisting of ferrous chloride (FeCl₂), ferrous sulfate (FeSO₄), and ferrous nitrate (Fe(NO₃x)₂).

(3) The method according to (1) or (2), in which the water-soluble nickel salt is at least one selected from a group consisting of nickel chloride (NiCl₂), nickel sulfate (NiSO₄), and nickel nitrate (Ni(NO₃)₂).

(4) The method according to any one of (1) to (3), in which the nucleating agent is at least one selected from a group consisting of a copper salt, a palladium salt, and a platinum salt.

(5) The method according to any one of (1) to (4), in which the complexing agent is at least one hydroxycarboxylic acid selected from tartaric acid ((CH(OH)COOH)₂) and citric acid (C(OH) (CH₂COOH)₂COOH).

(6) The method according to any one of (1) to (5), in which the pH adjusting agent is at least one selected from sodium hydroxide (NaOH) and potassium hydroxide (KOH).

(7) The method according to any one of (1) to (6), in which
the magnetic metals further include cobalt (Co), and the magnetic metal source further contains a water-soluble cobalt salt.

(8) The method according to (7), in which
in the magnetic metals, an iron (Fe) content is 60 mol % or more and 85 mol % or less, and a cobalt (Co) content is 10 mol % or more and 30 mol % or less, and
the magnetic metal source contains 60 mol % or more and 85 mol % or less of the water-soluble iron salt and 10 mol % or more and 30 mol % or less of the water-soluble cobalt salt.

(9) The method according to (7) or (8), in which the water-soluble cobalt salt is at least one selected from a group consisting of cobalt chloride (CoCl₂), cobalt sulfate (CoSO₄), and cobalt nitrate (Co(NO₃)₂).

(10) The method according to any one of (1) to (9), in which the starting material further contains an amine compound of which the molecule has two or more primary amino groups (—NH₂), one primary amino group (—NH₂) and one or more secondary amino group (—NH—), or two or more secondary amino groups (—NH—).

(11) The method according to (10), in which the amine compound is at least one of an alkyleneamine or an alkyleneamine derivative.

(12) The method according to (11), in which the alkyleneamine and/or the alkyleneamine derivative has at least a structure represented by formula (A) below in which nitrogen atoms of an amino group in the molecule bind to each other via a carbon chain having 2 carbon atoms.

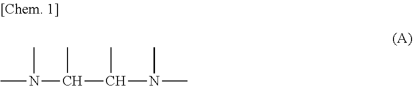

(13) The method according to any one of (10) to (12), in which the amine compound is at least one alkyleneamine selected from a group consisting of ethylenediamine (H₂NC₂H₄NH₂), diethylene triamine (H₂NC₂H₄NHC₂H₄NH₂), triethylene tetramine (H₂N(C₂H₄NH)₂C₂H₄NH₂), tetraethylene pentamine (H₂N(C₂H₄NH)₃C₂H₄NH₂), pentaethylene hexamine (H₂N(C₂H₄NH)₄C₂H₄NH₂), and propylene diamine (CH₃CH(NH₂)CH₂NH₂), and/or at least one alkyleneamine derivative selected from a group consisting of tris(2-aminoethyl)amine (N(C₂H₄NH₂)₃), N-(2-aminoethyl)ethanolamine (H₂NC₂H₄NHC₂H₄OH), N-(2-aminoethyl)propanolamine (H₂NC₂H₄NHC₃H₆OH), 2,3-diaminopropionic acid (H₂NCH₂CH(NH)COOH), ethylenediamine-N,N′-diacetic acid (HOOCCH₂NHC₂H₄NHCH₂COOH), and 1,2-cyclohexane diamine (H₂NC₆H₁₀NH₂).

(14) The method according to any one of (10) to (13), in which a blended amount of the amine compound with respect to a total amount of the magnetic metals is 0.01 mol % or more and 5.00 mol % or less.

(15) The method according to any one of (1) to (14), in which, when preparing the reaction liquid in the crystallization step, a metal salt raw material solution containing the magnetic metal source, the nucleating agent, and the complexing agent that are dissolved in water; a reducing agent solution containing the reducing agent that is dissolved in water; and a pH adjusting solution containing the pH adjusting agent that is dissolved in water, are individually prepared, the metal salt raw material solution and the pH adjusting solution are mixed to prepare a mixed solution, and the mixed solution and the reducing agent solution are mixed.

(16) The method according to (15), in which, when preparing the reaction liquid, the pH adjusting solution and the reducing agent solution are sequentially added and mixed into the metal salt raw material solution.

(17) The method according to (15) or (16), in which a time required for mixing the mixed solution and the reducing agent solution is set to 1 second or longer and 180 seconds or shorter.

(18) The method according to any one of (1) to (14), in which, when preparing the reaction liquid in the crystallization step, the metal salt raw material solution containing the magnetic metal source, the nucleating agent, and the complexing agent that are dissolved in water, and a reducing agent solution containing the reducing agent and the pH adjusting agent that are dissolved in water are individually prepared, and the metal salt raw material solution and the reducing agent solution are mixed.

(19) The method according to (18), in which, when preparing the reaction liquid, the reducing agent solution is added to the metal salt raw material solution, or conversely, the metal salt raw material solution is added and mixed into the reducing agent solution.

(20) The method according to (18) or (19), in which a time required for mixing the metal salt raw material solution and the reducing agent solution is set to 1 second or longer and 180 seconds or shorter.

(21) The method according to any one of (1) to (20), in which, in the crystallization step, before the reduction reaction is completed, an additional raw material liquid containing at least any one of the water-soluble nickel salt or the water-soluble cobalt salt that is dissolved in water is further added and mixed into the reaction liquid.

(22) The method according to any one of (15) to (21), in which an amine compound is added to at least one of the metal salt raw material solution, the reducing agent solution, the pH adjusting solution, or the reaction liquid.

(23) The method according to any one of (1) to (22), in which a temperature of the reaction liquid at the time of starting the crystallization of the crystallization powder (reaction starting temperature) is 40° C. or higher and 90° C. or lower, and a temperature of the reaction liquid maintained during the crystallization after the start of the crystallization (reaction maintaining temperature) is 60° C. or higher and 99° C. or lower.

(24) The method according to any one of (1) to (23), further including a crushing step in which the crystallized powder after the recovery step or the crystallized powder during the recovery step is subjected to a crushing treatment using a collision energy to crush agglomerated particles contained in the crystallized powder.

(25) The method according to (24), in which the crystallized powder after the recovery step is crushed by a dry crushing or a wet crushing, or the crystallized powder during the recovery step is crushed by the wet crushing.

(26) The method according to (25), in which the dry crushing is a spiral jet crushing.

(27) The method according to (25), in which the wet crushing is a high-pressure fluid collision crushing.

(28) The method according to any one of (1) to (27), further including a high-temperature heating step in which the crystallized powder after the recovery step or the crystallized powder during the recovery step is heated in an inert atmosphere, a reducing atmosphere, or a vacuum atmosphere at a temperature higher than 150° C. and 400° C. or lower to improve composition homogeneity within the particle of the iron (Fe)-nickel (Ni) alloy powder.

(29) The method according to any one of (1) to (28), further including an insulative coating step in which the crystallized powder obtained through the recovery step is subjected to an insulative coating treatment to form an insulative coat layer composed of a metal oxide on particle surfaces of the crystallized powder, thereby improving an insulating property between the particles.

(30) The method according to (29), in which, in the insulative coating step, the crystallized powder is dispersed in a mixed solvent containing water and an organic solvent, and a metal alkoxide is further added and mixed into the mixed solvent to prepare a slurry, the metal alkoxide is subjected to hydrolysis and dehydration-condensation polymerization in the slurry to form an insulative coat layer composed of a metal oxide on the particle surfaces of the crystallized powder, and then the crystallized powder having the insulative coat layer is recovered from the slurry.

(31) The method according to (30), in which the metal alkoxide is composed mainly of a silicon alkoxide (alkyl silicate), and the metal oxide is composed mainly of silicon dioxide (SiO₂).

(32) The method according to (30) or (31), in which the hydrolysis of the metal alkoxide is carried out in the coexistence of a base catalyst (alkali catalyst).

### Effects of the Invention

According to the present invention, a method for manufacturing an iron-nickel alloy powder excellent in powder properties and magnetic properties is provided.

### BRIEF DESCRIPTION OF THE DRAWINGS

FIG. 1 illustrates a process diagram for explaining a method for manufacturing an alloy powder according to this embodiment;

FIG. 2 illustrates a process diagram for explaining preparation of a reaction liquid and manufacture of an alloy powder in the first aspect;

FIG. 3 illustrates a process diagram for explaining preparation of the reaction liquid and manufacture of the alloy powder in the first aspect;

FIG. 4 illustrates a process diagram for explaining preparation of a reaction liquid and manufacture of an alloy powder in the second aspect;

FIG. 5 illustrates a process diagram for explaining preparation of the reaction liquid and manufacture of the alloy powder in the second aspect;

FIG. 6 illustrates a process diagram for explaining preparation of a reaction liquid and manufacture of an alloy powder in the third aspect;

FIG. 7 illustrates a diagram presenting the liquid temperature transition in a reaction tank in a crystallization step of Example 1;

FIG. 8 illustrates a scanning electron microscope (SEM) image of an alloy powder obtained in Example 1;

FIG. 9 illustrates an SEM image of an alloy powder obtained in Example 2;

FIG. 10 illustrates SEM images of an alloy powder obtained in Example 6 (before and after spiral jet crushing treatment);

FIG. 11 illustrates scanning transmission electron microscope (STEM) images and energy dispersive spectroscopy (EDS) spectral analysis results of an alloy powder obtained in Example 8 (before and after high-temperature heating treatment);

FIG. 12 illustrates a STEM image and an EDS spectral analysis result on a particle cross section of an alloy powder obtained in Example 9;

FIG. 13 illustrates an SEM image of an alloy powder obtained in Example 10;

FIG. 14 illustrates SEM images of an alloy powder obtained in Example 12 (before and after insulative coating treatment);

FIG. 15 illustrates an SEM image of an alloy powder obtained in Example 13;

FIG. 16 illustrates an SEM image of an alloy powder obtained in Example 14;

FIG. 17 illustrates an SEM image of an alloy powder obtained in Comparative Example 1;

FIG. 18 illustrates an SEM image of an alloy powder obtained in Comparative Example 2; and

FIG. 19 illustrates an SEM image of an alloy powder obtained in Comparative Example 3.

### PREFERRED MODE FOR CARRYING OUT THE INVENTION

A specific embodiment of the present invention (hereinafter referred to as “this embodiment”) will be explained. Note that the present invention is not limited to the following embodiment, and can be variously modified unless the gist of the invention is changed.

### <<1. Method for Manufacturing Iron-Nickel Alloy Powder>>

The method for manufacturing the iron (Fe)-nickel (Ni) alloy powder according to this embodiment includes the following steps: a preparation step in which a starting material containing a magnetic metal source, a nucleating agent, a complexing agent, a reducing agent, and a pH adjusting agent is prepared; a crystallization step in which a reaction liquid containing this starting material and water is prepared, and a crystallization powder containing the magnetic metals is crystallized by a reduction reaction in this reaction liquid; and a recovery step in which the crystallized powder is recovered from the obtained reaction liquid. The iron (Fe)-nickel (Ni) alloy powder contains at least iron (Fe) and nickel (Ni) as magnetic metals. The magnetic metal source contains water-soluble iron salts and water-soluble nickel salts. The nucleating agent is a water-soluble salt of a metal more noble than nickel. The complexing agent is at least one selected from a group consisting of hydroxycarboxylic acids, hydroxycarboxylic acid salts, and hydroxycarboxylic acid derivatives. The reducing agent is hydrazine (N₂H₄).

The iron (Fe)-nickel (Ni) alloy powder according to this embodiment (hereinafter simply referred to as “alloy powder” in some cases) contains at least iron (Fe) and nickel (Ni). Also, the alloy powder may contain cobalt (Co) if necessary. That means, the alloy powder may be an iron-nickel alloy powder containing only iron and nickel, or an iron-nickel-cobalt alloy powder containing iron, nickel, and cobalt. Iron, nickel, and cobalt are all magnetic metals that exhibit ferromagnetism. Hence, the iron-nickel alloy powder and the iron-nickel-cobalt alloy powder have high saturation magnetic flux density and excellent magnetic properties. In this specification, the magnetic metal refers to a generic term for iron, nickel, and cobalt. That means, when the alloy does not contain cobalt, the magnetic metal refers to a generic term for iron and nickel, and when the alloy also contains cobalt, it refers to a generic term for iron, nickel, and cobalt.

Proportions of iron (Fe), nickel (Ni), and cobalt (Co) in the alloy powder according to this embodiment is not particularly limited. The amount of iron may be 10 mol % or more and 95 mol % or less, 25 mol % or more and 90 mol % or less, or 40 mol % or more and 80 mol % or less. The amount of nickel may be 5 mol % or more and 90 mol % or less, 10 mol % or more and 75 mol % or less, or 20 mol % or more and 60 mol % or less. The amount of cobalt may be 0 mol % or more and 40 mol % or less, or 5 mol % or more and 20 mol % or less. Note that the total amount of iron, nickel, and cobalt is 100 mol % or less.

The alloy powder according to this embodiment may contain other additive components other than the magnetic metals (Fe, Ni, and Co). Examples of such additive components include copper (Cu) and/or boron (B), and the like. However, in terms of maximally utilizing the effects based on the magnetic metals, the less the content of additive components other than the magnetic metals, the more desirable. The content of other components other than magnetic metals may be 10% by mass or less, 5% by mass or less, 1% by mass or less, or even 0% by mass. The alloy powder unavoidably contains impurities (unavoidable impurities) during the manufacturing process in some cases. Examples of such unavoidable impurities may include oxygen (O), carbon (C), chlorine (Cl), and alkali components (Na, K, etc.). Since unavoidable impurities may deteriorate the properties of the alloy powder, it is preferable to minimize the amount of impurities. In the unavoidable impurity, an amount of oxygen (O) contained in the oxide film that is necessarily formed on the alloy powder surface is preferably 5% by mass or less, more preferably 3% by mass or less. On the other hand, carbon (C), chlorine (Cl), and alkali components (Na, K, etc.) are preferably 1% by mass or less, more preferably 0.5% by mass or less, even more preferably 0.1% by mass or less. The alloy powder may have a composition including magnetic metals and residual unavoidable impurities.

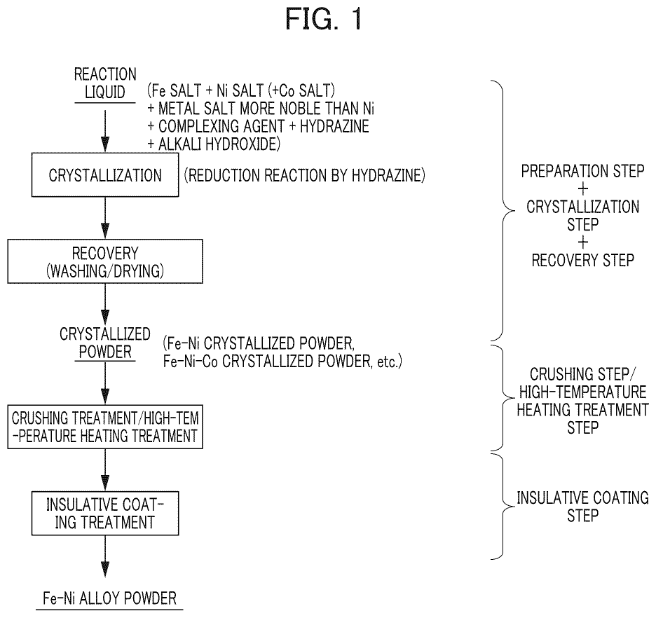

The method for manufacturing the alloy powder according to this embodiment includes at least a preparation step, a crystallization step, and a recovery step. If necessary, a crushing step and a high-temperature heating step may be provided after or during the recovery step, or an insulative coating step may be provided after the recovery step. FIG. 1 schematically illustrates an example of a process in the manufacturing method according to this embodiment. Although the crushing treatment, the high-temperature heating treatment, and the insulative coating treatment are illustrated in FIG. 1, it is only necessary to provide these treatments as needed, and these treatments are not essential. When performing the crushing treatment, the high-temperature heating treatment, and/or the insulative coating treatment, the order of these treatments is not particularly restricted. To stretch a point, it is preferable that the crushing treatment is performed after the high-temperature heating treatment. This is because the linkage (bonding) between the alloy particles strengthened by the high-temperature heating treatment can be weakened or released. In addition, it is preferable that the crushing treatment is performed before the insulative coating. This is because a homogeneous insulative coat can be applied on each of the entire surfaces of the alloy particles with weakened or released linkage. On the other hand, if the alloy particles are linked to each other, no insulative coat layer is formed on the linkage portions. Thus, it is preferable that the linkage has been weakened or released as much as possible before the insulative coating. Each step will be explained below in detail.

### <Preparation Step>

In the preparation step, a magnetic metal source, a nucleating agent, a complexing agent, a reducing agent, and a pH adjusting agent are prepared as a starting material. The magnetic metal source is a raw material for iron and nickel but may contain a cobalt raw material if necessary. The starting material may also contain an amine compound. Each raw material will be explained below.

### (a) Magnetic Metal Source

The magnetic metal source is a raw material for the magnetic metals and contains at least water-soluble iron salts and water-soluble nickel salts. The iron salt is a raw material for the iron component (iron source) contained in the alloy powder, and is not particularly limited as long as it is an easily water-soluble iron salt. Examples of the iron salt may include iron chloride, iron sulfate, iron nitrate, containing divalent and/or trivalent iron ions, or a mixture thereof. The water-soluble iron salt is preferably at least one selected from a group consisting of ferrous chloride (FeCl₂), ferrous sulfate (FeSO₄), and ferrous nitrate (Fe(NO₃)₂). The nickel salt is a raw material for the nickel component (nickel source) contained in the alloy powder and is not particularly limited as long as it is an easily water-soluble nickel salt. The water-soluble nickel salt is preferably at least one selected from a group consisting of nickel chloride (NiCl₂), nickel sulfate (NiSO₄), and nickel nitrate (Ni(NO₃)₂), particularly preferably at least one selected from a group consisting of nickel chloride (NiCl₂) and nickel sulfate (NiSO₄).

If necessary, in an aspect, the magnetic metals may further contain cobalt (Co), and the magnetic metal source may further contain a water-soluble cobalt salt. This makes it possible to manufacture the iron-nickel-cobalt alloy powder. An iron-nickel-cobalt alloy powder in which iron and nickel are partially replaced by cobalt is particularly characterized by a high saturation magnetic flux density.

The water-soluble cobalt salts act to enhance a reduction reaction during the crystallization of the alloy powder (reduction enhancing action), and particularly when the magnetic metals have a high iron (Fe) content of 60 mol % or more, this reduction enhancing action becomes more remarkable. Furthermore, the water-soluble cobalt salts also act to render the alloy powder into spherical particles with a smooth surface (spheroidization enhancing action). Thus, when the content of the water-soluble iron salt is set to 60 mol % or more and 85 mol % or less and the content of the water-soluble cobalt salt is set to 10 mol % or more and 30 mol % or less in the magnetic metal source, a spherical iron-nickel-cobalt alloy powder having an extremely high saturation magnetic flux density (e.g. 2 T (tesla) or higher) and a smooth surface can be obtained even if an amount of hydrazine used as a reducing agent is considerably decreased. This alloy powder contains for example, 60 mol % or more and 85 mol % or less of iron and 10 mol % or more and 30 mol % or less of cobalt.

The water-soluble cobalt salt is not particularly limited as long as it is an easily water-soluble cobalt salt. The water-soluble cobalt salt is preferably at least one selected from a group consisting of cobalt chloride (CoCl₂), cobalt sulfate (CoSO₄), and cobalt nitrate (Co(NO₃)₂), particularly preferably at least one selected from a group consisting of cobalt chloride (CoCl₂) and cobalt sulfate (CoSO₄).

### (b) Nucleating Agent

The nucleating agent is a water-soluble salt of a metal more noble than nickel. This nucleating agent (water-soluble salt of a metal more noble than nickel) acts to produce an initial nucleus by being preferentially reduced in a reaction liquid in the subsequent crystallization step, so that the initial nucleus enhances precipitation of the crystallized powder. Herein, a metal more noble than nickel refers to a metal of which a potential in the standard potential series is higher than of nickel in an aqueous solution. A metal more noble than nickel can also be referred to as a metal having a lower ionization tendency than of nickel. Examples of such metals may include tin (Sn), lead (Pb), antimony (Sb), bismuth (Bi), copper (Cu), silver (Ag), palladium (Pd), iridium (Ir), platinum (Pt), and gold (Au).

The formation of the crystallized powder in the reaction liquid can be controlled in the subsequent crystallization step, by using a water-soluble salt of a metal more noble than nickel as a nucleating agent. For example, a fine crystallized powder can be obtained by increasing the addition amount of the nucleating agent. That means, in the crystallization step, ions and complex ions of the magnetic metals contained in the reaction liquid are reduced and precipitated to form a crystallized powder. Among magnetic metals, nickel is more noble and has a lower ionization tendency compared to iron and cobalt. Thereby, when water-soluble salts (nucleating agent) of metals more noble than nickel are contained in the reaction liquid, the metals more noble than nickel are reduced and precipitated prior to all magnetic metals. The precipitated metals more noble than nickel serve as initial nuclei, and the initial nuclei grow as particles to form a crystallized powder composed of magnetic metals, and therefore a particle diameter of the crystallized powder can be controlled by the nucleating agent addition amount that influences the number of the initial nuclei.

The nucleating agent is not particularly limited as long as it is a water-soluble salt of a metal more noble than nickel. However, the nucleating agent is preferably at least one selected from a group consisting of a copper salt, a palladium salt, and a platinum salt. Particularly, copper (Cu), palladium (Pd), and platinum (Pt) are remarkably noble and have a low ionization tendency. Thus, they exhibit particularly excellent effects as nucleating agents. Examples of a water-soluble copper salt include, but are not limited to, copper sulfate. Examples of a water-soluble palladium salt include, but are not limited to, sodium palladium(II) chloride, ammonium palladium(II) chloride, palladium(II) nitrate, and palladium(II) sulfate. The nucleating agent is particularly preferably a palladium salt. Use of the palladium salt makes it possible to control the particle diameter of the crystallized powder (alloy powder) so as to be even finer.

The blended amount of the nucleating agent should be adjusted such that the final alloy powder has a desired particle diameter value. For example, the blended amount of the nucleating agent based on the total amount of the magnetic metals may be 0.001 mol ppm or more and 5.0 mol ppm or less, or 0.005 mol ppm or more and 2.0 mol ppm or less. By setting the blended amount of the nucleating agent within this range, an alloy powder with an average particle diameter of 0.2 μm or larger and 0.6 μm or smaller can be obtained. However, the blended amount of the nucleating agent is not limited to within the aforementioned range. For example, when producing a fine alloy powder having an average particle diameter of smaller than 0.2 μm, the blended amount of the nucleating agent should be set to more than 5.0 mol ppm.

### (c) Complexing Agent

The complexing agent is at least one selected from a group consisting of hydroxycarboxylic acids, hydroxycarboxylic acid salts, and hydroxycarboxylic acid derivatives. The complexing agent (hydroxycarboxylic acid, etc.) acts to make the reaction uniform in the subsequent crystallization step. That means, although the magnetic metal components are dissolved as magnetic metal ions (Fe²⁺, Ni²⁺, etc.) in the reaction liquid, the reaction liquid becomes strongly alkaline due to the pH adjusting agent (NaOH, etc.), and therefore the amount of the magnetic metal ions dissolved in the reaction liquid is trace. However, the presence of the complexing agent makes it possible to dissolve a large amount of the magnetic metal components as complex ions (Fe complex ions, Ni complex ions, etc.). The presence of such complex ions makes it possible to increase the reduction reaction rate and suppresses a local uneven distribution of the magnetic metal components, to make the reaction system uniform. Also, the complexing agent acts to change a balance of complexation stability among the multiple magnetic metal ions in the reaction liquid. Thus, the presence of the complexing agent changes the reduction reaction of the magnetic metals and a balance between a nucleation rate and a particle growth rate. By using the complexing agent (hydroxycarboxylic acid, etc.) specified in this embodiment, the aforementioned effects are exhibited in combination, and the reaction proceeds in a favorable direction, so that the powder properties (particle diameter, particle size distribution, sphericity, and surface properties of the particles) of the obtained alloy powder are improved. The alloy powder with improved powder properties is excellent in filling properties and therefore suitable as a dust core raw material. In this regard, the complexing agent (hydroxycarboxylic acid, etc.) according to this embodiment can functionally serves as a reduction reaction enhancing agent, a spheroidization enhancing agent, and a surface smoothing agent. A suitable complexing agent contains at least one hydroxycarboxylic acid selected from tartaric acid ((CH(OH)COOH)₂) and citric acid (C(OH) (CH₂COOH)₂COOH).

A blended amount of the complexing agent based on the total amount of the magnetic metals is preferably 5 mol % or more and 100 mol % or less, more preferably 10 mol % or more and 75 mol % or less, even more preferably 15 mol % or more and 50 mol % or less. If the blended amount of the complexing agent is 5 mol % or more, the functions as the reduction reaction enhancing agent, the spheroidization enhancing agent, and the surface smoothing agent are fully exhibited, and therefore the powder properties (particle diameter, particle size distribution, sphericity, and surface properties of the particles) of the alloy powder become even more superior. If the blended amount of the complexing agent is 100 mol % or less, an amount of the complexing agent used can be decreased while an expression degree of the function as the complexing agent does not significantly vary, leading to a low manufacturing cost.

### (d) Reducing Agent

The reducing agent is hydrazine (N₂H₄, molecular weight: 32.05). This reducing agent (hydrazine) acts to reduce ions and complex ions of the magnetic metals in a reaction liquid in the subsequent crystallization step. Hydrazine has advantages that a reducing power is strong and no byproducts of the reduction reaction are generated in the reaction liquid. High-purity hydrazine with few impurities can be easily obtained.

As hydrazine, anhydrous hydrazine, as well as water-holding hydrazine (N₂H₄-H₂O, molecular weight: 50.06) that is hydrazine hydrate are known. Either hydrazine may be used. For example, a commercially available 60 mass %-water-holding hydrazine of industrial grade can be used as the water-holding hydrazine.

A blended amount of the reducing agent considerably depends on the composition of the iron (Fe)-nickel (Ni) alloy powder. The more the content of iron that is difficult to reduce is, the more the reducing agent is required. In addition, the blended amount of the reducing agent is affected by not only the composition of the alloy powder but also the temperature of the reaction liquid, the blended amounts of the complexing agent and the pH adjusting agent, or the like. For example, if the iron-nickel alloy powder contains 60 mol % or less of iron, the molar ratio of the reducing agent to the total amount of the magnetic metals is preferably 1.8 or higher and 7.0 or lower, more preferably 2.0 or higher and 6.0 or lower, even more preferably 2.5 or higher and 5.0 or lower. If the iron-nickel alloy powder contains more than 60 mol % and 75 mol % or less of iron, the molar ratio of the reducing agent to the total amount of the magnetic metals is preferably 2.5 or higher and 9.0 or lower, more preferably 3.5 or higher and 8.0 or lower. If the iron-nickel alloy powder contains more than 75 mol % and 95 mol % or less of iron, the molar ratio of the reducing agent to the total amount of the magnetic metals is preferably 3.5 or higher and 10.0 or lower, more preferably 4.5 or higher and 9.0 or lower. On the other hand, when manufacturing an iron-nickel-cobalt alloy powder, the blended amount of the reducing agent can be significantly decreased compared to the iron-nickel alloy powder owing to the aforementioned action of the water-soluble cobalt salt. Particularly when manufacturing an alloy powder with a high iron content, the action of the water-soluble cobalt salt is remarkable. For example, when manufacturing an alloy powder containing 60 mol % or more and 85 mol % or less of iron and 10 mol % or more and 30 mol % or less of cobalt (Co), the molar ratio of the reducing agent to the total amount of the magnetic metals is preferably 1.0 or higher and 4.0 or lower, more preferably 1.2 or higher and 2.0 or lower.

In any case, if the blended amount of the reducing agent is not less than the aforementioned lower limit, the reduction of the magnetic metal ions and complex ions sufficiently proceeds, so that a crystallized powder (alloy powder) without contamination of unreduced substances such as iron hydroxide can be obtained. If the blended amount of the complexing agent is not more than the aforementioned upper limit, the amount of the reducing agent (hydrazine) used can be decreased, leading to a low manufacturing cost.

### (e) pH Adjusting Agent

The pH adjusting agent is an alkali hydroxide. This pH adjusting agent (alkali hydroxide) acts to enhance the reduction reaction of hydrazine as the reducing agent. That means, the higher the pH of the reaction liquid is, the stronger the reducing power of hydrazine is. Thus, use of an alkali hydroxide as a pH adjusting agent enhances the reduction reaction of the magnetic metal ions and complex ions in the reaction liquid and the accompanying precipitation of the crystallized powder. The type of the alkali hydroxide is not particularly limited. However, in terms of availability and price, the pH adjusting agent preferably contains at least one selected from sodium hydroxide (NaOH) and potassium hydroxide (KOH).

A blended amount of the pH adjusting agent (alkali hydroxide) should be adjusted such that the reducing power of the reducing agent (hydrazine) is sufficiently high. Specifically, a pH of the reaction liquid at the reaction temperature is preferably 9.5 or higher, more preferably 10 or higher, even more preferably 10.5 or higher. Thus, the blended amount of the alkali hydroxide should be adjusted such that the pH falls within this range.

### (f) Amine Compound

If necessary, the starting material may further contain an amine compound. The molecule of this amine compound has two or more primary amino groups (—NH₂), one primary amino group (—NH₂), and one or more secondary amino groups (—NH—), or two or more secondary amino groups (—NH—).

The amine compound acts to enhance a reduction reaction in the subsequent crystallization step. That means, the amine compound functionally serves as a complexing agent, and acts to complex the magnetic metal ions (Fe²⁺, Ni²⁺, etc.) in the reaction liquid to form complex ions (Fe complex ion, Ni complex ion, etc.). It is considered that the reduction reaction further proceeds as a result of the presence of the complex ions in the reaction liquid.

The amine compound also acts to suppress autolysis of hydrazine as the reducing agent. In other words, when the crystallized powder composed of the magnetic metals precipitates in the reaction liquid, nickel (Ni) in the magnetic metals serves as a catalyst, resulting in decomposition of hydrazine in some cases. This decomposition is referred to as autolysis of hydrazine. In this decomposition reaction, hydrazine (N₂H₄) is decomposed into nitrogen (N₂) and ammonia (NH₃) as presented in Eq. (1) below. Such autolysis is undesirable because the function of hydrazine as a reducing agent is impaired.

[Eq. 1]

3N₂H₄→N₂⬆+4N H₃ (1)

The addition of the amine compound in the compounded liquid can suppress the autolysis of hydrazine. Although the detailed mechanism is unknown, it is assumed that this is because excessive contact between hydrazine and the crystallized powder in the reaction liquid is prevented. That means, among the amino groups in the amine compound molecule, particularly primary amino groups (—NH₂) and secondary amino groups (—NH—) are strongly adsorbed to the surface of the crystallized powder in the reaction liquid. It is considered that the amine compound molecules cover and protect the crystallized powder to prevent excessive contact between the hydrazine molecules and the crystallized powder, thereby suppressing the autolysis of hydrazine. The more the nickel content in the magnetic metals is, the more remarkable the autolysis of hydrazine is, and therefore, particularly in this case, the amine compound effectively acts.

The amine compound is preferably at least one of alkyleneamines and alkyleneamine derivatives. The alkyleneamines and/or alkyleneamine derivatives preferably have at least a structure represented by formula (A) below, in which nitrogen atoms of an amino group in the molecule bind to each other via a carbon chain having 2 carbon atoms.

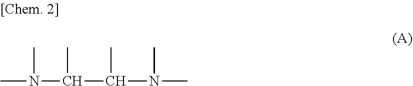

Use of such alkyleneamines or alkyleneamine derivatives as amine compounds makes it possible to more effectively exhibit the effect of suppressing the autolysis of hydrazine (reducing agent). It is considered that this is because such alkyleneamines and alkyleneamine derivatives effectively suppress the contact of the hydrazine molecules with the crystallized powder owing to short carbon chains contained in the alkyleneamines and alkylene amine derivatives. In contrast, when nitrogen atoms in the amino group bind to each other via an excessively long carbon chain, the carbon chain has a high degree of freedom of movement even if this amino group is adsorbed to the crystallized powder. Thus, it is assumed that the contact between the crystallized powder and the hydrazine molecules will not be effectively prevented.

Specific examples of the alkyleneamines having the structure represented by formula (A) above include one or more selected from a group consisting of ethylenediamine (abbreviation: EDA) (H₂NC₂H₄NH₂), diethylenetriamine (abbreviation: DETA) (H₂NC₂H₄NHC₂H₄NH₂), triethylenetetramine (abbreviation: TETA) (H₂N(C₂H₄NH)₂C₂H₄NH₂), tetraethylenepentamine (abbreviation: TEPA) (H₂N(C₂H₄NH)₃C₂H₄NH₂), pentaethylenehexamine (abbreviation: PEHA) (H₂N(C₂H₄NH)₄C₂H₄NH₂), and propylenediamine (another name: 1,2-diaminopropane, 1,2-propanediamine) (abbreviation: PDA) (CH₃CH(NH₂)CH₂NH₂). Specific examples of the alkyleneamine derivatives having the structure represented by formula (A) above include one or more selected from tris(2-aminoethyl)amine (abbreviation: TAEA) (N(C₂H₄NH₂)₃), N-(2-aminoethyl)ethanolamine (another name: 2-(2-aminoethylamino) ethanol) (abbreviation: AEEA) (H₂NC₂H₄NHC₂H₄₀H), N-(2-aminoethyl)propanolamine (another name: 2-(2-aminoethylamino) propanol) (abbreviation: AEPA) (H₂NC₂H₄NHC₃H₆₀H), L (or D, DL)-2,3-diaminopropionic acid (another name: 3-amino-L(or D, DL)-alanine) (abbreviation: DAPA) (H₂NCH₂CH(NH)COOH), ethylenediamine-N,N′-diacetic acid (another name: ethylene-N,N′-diglycine) (abbreviation: EDDA) (HOOCCH₂NHC₂H₄NHCH₂COOH), and 1,2-cyclohexanediamine (another name: 1,2-diaminocyclohexane) (abbreviation: CHDA) (H₂NC₆H₁₀NH₂). These alkyleneamines and alkyleneamine derivatives are water-soluble. Above all, ethylenediamine and diethylenetriamine are preferable because they have a relatively strong effect of suppressing the autolysis of hydrazine and are easily available and inexpensive.

Structural formulas of ethylenediamine (EDA), diethylenetriamine (DETA), triethylenetetramine (TETA), tetraethylenepentamine (TEPA), pentaethylenehexamine (PEHA), propylenediamine (PDA), tris(2-aminoethyl) amine (TAEA), N-(2-aminoethyl) ethanolamine (AEEA), N-(2-aminoethyl) propanolamine (AEPA), and L (or D, DL)-2,3-diaminopropionic acid (DAPA) are presented in formulas (B) to (M) below.

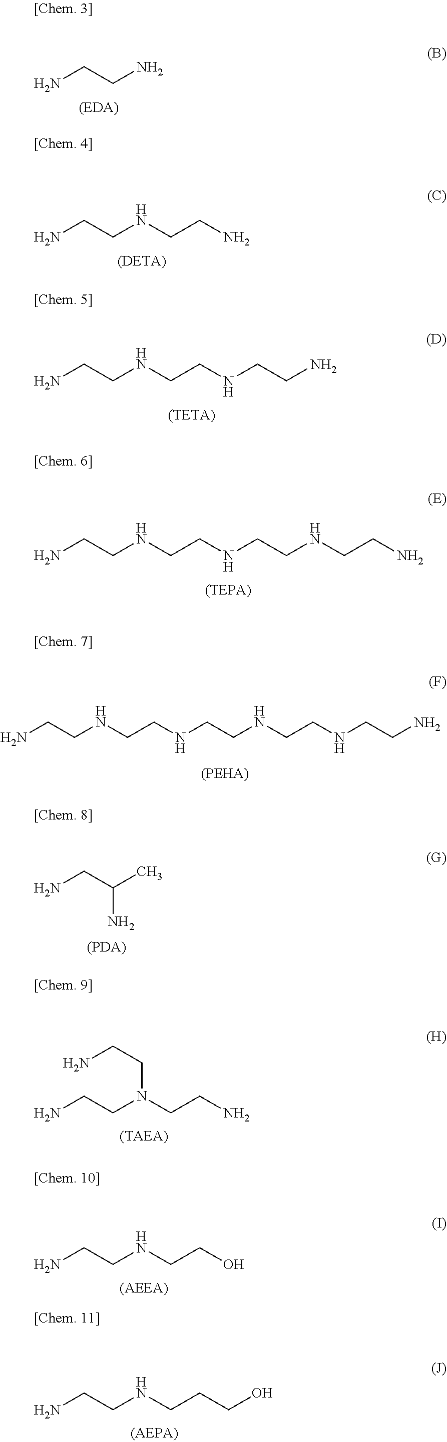

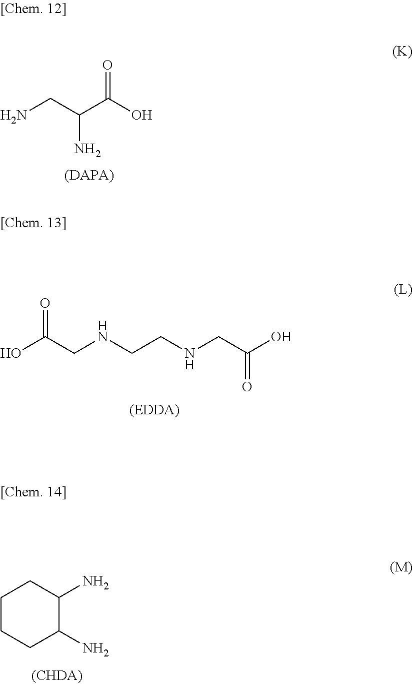 [SMILES: NCC(N)C(=O)O ; O=C(O)CNCCNCC(=O)O ; NC1CCCCC1N]

The blended amount of the amine compound based on the total amount of the magnetic metals is preferably 0.00 mol % or more and 5.00 mol % or less, more preferably 0.01 mol % or more and 5.00 mol % or less, even more preferably 0.03 mol % or more and 5.00 mol % or less. The blended amount of the amine compound may be 0.00 mol %, i.e., the amine compound need not be compounded. However, when the blended amount of the amine compound is 0.01 mol % or more, the effects of suppressing the hydrazine autolysis and of enhancing the reduction reaction resulting from the amine compound can be fully exhibited. In addition, when the blended amount of the amine compound is 5.00 mol % or less, the amine compound can appropriately exhibit the function as the complexing agent. Thereby, the powder properties (particle diameter, particle size distribution, sphericity, and surface properties of particles) of the alloy powder can be made superior. If the blended 21-00706PCT(SMMF-212PCT) amount of the amine compound exceeds 5.00 mol %, the action of the amine compound as the complexing agent becomes too strong. The particles may abnormally grow, and the powder properties of the alloy powder may deteriorate.

### <Crystallization Step>

In the crystallization step, a reaction liquid containing the prepared starting material and water is prepared, and a crystallization powder containing the magnetic metals is crystallized by a reduction reaction in the reaction liquid. Preparation of the reaction liquid and crystallization of the crystallization powder will be individually explained below. In actual manufacture, the crystallization reaction starts as soon as the reaction liquid is prepared in most cases, but there is a possibility that even a low level of crystallization reaction starts during preparation of the reaction liquid. The crystallization reaction described herein refers to a reaction that occurs during the crystallization process. In other words, although the crystallization reaction is mainly composed of the reduction reaction with hydrazine (e.g., Eq. (6) below), the crystallization reaction also includes other reactions such as the autolysis reaction of hydrazine (Eq. (1) above). For this reason, the term crystallization reaction having a broader sense than of the reduction reaction is used.

In the crystallization step, at least some of a plurality of solutions such as a metal salt raw material solution and a reducing agent solution are heated and then mixed to prepare a reaction liquid, and the reaction liquid is maintained at a predetermined temperature while being heated and agitated in a reaction tank, and in this state, the crystallization reaction is proceeded. A general-purpose method can be applied for heating, such as a method in which a reaction tank (reaction vessel) is disposed in a water bath, and a method using a reaction tank equipped with a steam jacket or a heater. The reaction tank (reaction vessel) and agitation blades for agitating the reaction liquid need to be made of inert materials that prevent nucleation as much as possible on their surfaces when coming into contact with the reaction liquid from the viewpoint of not interfering with the action of the nucleating agent, and need to be excellent in strength and thermal conductivity. For satisfying these requirements, for example, metal containers (Teflon (registered trademark)-coated stainless steel containers) and agitation blades (e.g., Teflon (registered trademark)-coated stainless steel agitation blades) coated with fluororesin (PTFE, PFA, etc.) are suitable.

### (a) Preparation of Reaction Liquid

First, the starting materials, i.e., the magnetic metal source, the nucleating agent, the complexing agent, the reducing agent, the pH adjusting agent, and optionally the amine compound are, if necessary, after dissolved in water, mixed to prepare the reaction liquid. As water used in preparing the reaction liquid, it is preferable to use high-purity water for the purpose of decreasing the amount of impurities in the final alloy powder. As high-purity water, pure water with an electrical conductivity of 1 μS/cm or lower or ultrapure water with an electrical conductivity of 0.06 μS/cm or lower can be used, and, above all, inexpensive and easily available pure water is preferable.

If the starting materials are solids such as iron salts, nickel salts, cobalt salts, and alkali hydroxide, it is preferable that the starting materials are previously mixed and dissolved into water to form an aqueous solution. It is only necessary to mix the starting materials and water by a known method such as an agitation mixing method. The procedure for mixing the starting materials and the aqueous solution is not particularly limited unless the homogeneity of the reaction liquid is impaired. However, from the viewpoint of ensuring the homogeneity of the reaction liquid, it is preferable that aqueous solutions containing each starting material are separately prepared in advance and then the prepared aqueous solutions are mixed. It is more preferable that the reaction liquid is prepared according to the first or second aspect described below.

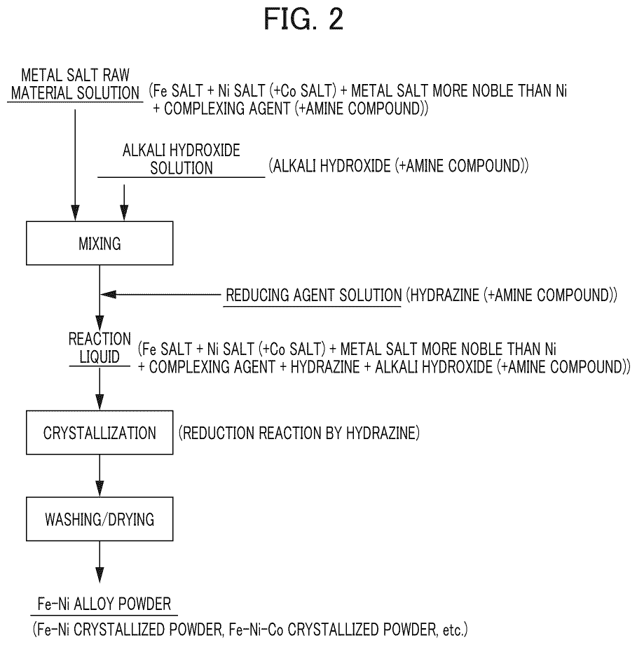

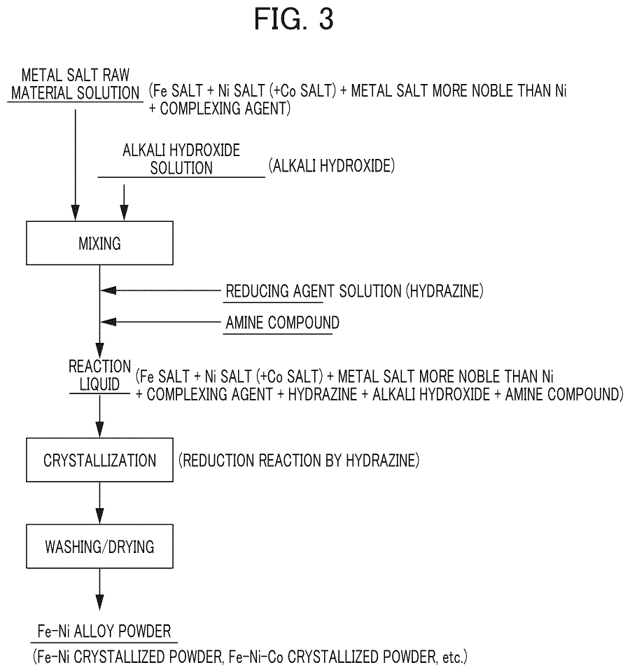

In the first aspect, when preparing the reaction liquid in the crystallization step, a metal salt raw material solution containing a magnetic metal source, a nucleating agent, and a complexing agent that are dissolved in water, a reducing agent solution containing a reducing agent dissolved in water, and a pH adjusting solution containing a pH adjusting agent dissolved in water, are each prepared, the metal salt raw material solution and the pH adjusting solution are mixed to form a mixed solution, and the resulting mixed solution is mixed with the reducing agent solution. Each of FIG. 2 and FIG. 3 illustrates a process diagram of an example of the reaction liquid preparation and the alloy powder manufacture in the first aspect.

In the first aspect, three solutions: the metal salt raw material solution, the reducing agent solution, and the pH adjusting solution, are separately prepared. The metal salt raw material solution is prepared by dissolving the magnetic metal source (water-soluble iron salt, water-soluble nickel salt, etc.), the nucleating agent (water-soluble salt of a metal more noble than nickel), and the complexing agent (hydroxycarboxylic acid, etc.) in water. The reducing agent solution is prepared by dissolving the reducing agent (hydrazine) in water. The pH adjusting solution is prepared by dissolving the pH adjusting agent (alkali hydroxide) in water. Subsequently, the metal salt raw material solution and the pH adjusting solution are mixed to prepare a mixed solution. In this process, the magnetic metal salt (water-soluble iron salt, water-soluble nickel salt, etc.) contained in the metal salt raw material solution reacts with the alkali hydroxide contained in the pH adjusting agent to form a magnetic metal hydroxide. Examples of this hydroxide include iron hydroxide (Fe(OH)₂), nickel hydroxide (Ni(OH)₂), cobalt hydroxide (Co(OH)₂), iron-nickel hydroxide ((Fe, Ni) (OH)₂), iron-nickel-cobalt hydroxide ((Fe, Ni, Co) (OH)₂), and the like. Then, the obtained mixed solution is mixed with the reducing agent solution to prepare a reaction liquid.

In a specific preparation procedure of the reaction liquid in the first aspect, preferably the pH adjusting solution and the reducing agent solution are sequentially added and mixed into the metal salt raw material solution. In the first aspect using three solutions: the metal salt raw material solution, the reducing agent solution, and the pH adjusting solution, the amount (volume) of the metal salt raw material solution is largest. Consequently, the procedure in which the other solutions are sequentially added and mixed into the large amount of metal salt raw material solution can achieve a more homogeneous mixed state and proceed a more uniform reduction reaction in the reaction liquid, compared to the procedure in which the metal salt raw material solution is added to the other solutions.

When blended the amine compound, the amine compound should be added to at least one of the metal salt raw material solutions, the reducing agent solution, and the pH adjusting solution. After mixing all of these solutions, the amine compound may be added to the mixed solution. FIG. 2 illustrates an aspect that the amine compound is added to at least one of the metal salt raw material solutions, the reducing agent solution, and the pH adjusting solution. FIG. 3 illustrates an aspect that the amine compound is added to the reaction liquid obtained by mixing all of the metal salt raw material solution, the reducing agent solution, and the pH adjusting solution.

In the first aspect, the reaction liquid is prepared by mixing the reducing agent solution into the mixed solution of the metal salt raw material solution and the pH adjusting agent, and the reduction reaction proceeds from the time of adding the reducing agent solution. During the mixing of the reducing agent solution, the concentration of the reducing agent (hydrazine) rapidly rises locally in a minute region to which the reducing agent is added. Since the mixed solution also contains the pH adjusting agent (alkali hydroxide), the pH of the mixed solution (reaction liquid) is still high at the initial stage where the reducing agent solution is mixed into the mixed solution. As mentioned above, the higher the pH is, the stronger the reducing power exhibited by the reducing agent (hydrazine) is. Thus, at the initial stage of the mixing of the reducing agent solution, the concentration and pH of the reducing agent are locally high, and nucleation resulting from the nucleating agent, and a reduction reaction that produces the crystallized powder rapidly occur. On the other hand, the pH of the mixed solution (reaction liquid) gradually decreases in association with addition of the reducing agent solution. Thereby, at the final stage of the mixing of the reducing agent solution, the reducing power of the reducing agent is not as strong as at the initial stage, and the nucleation and the reduction reaction slowly proceed. Consequently, there is a difference in the reducing power of the reducing agent between the initial stage and the final stage of the mixing of the reducing solution.

The large difference in the reducing power between the initial stage and the final stage may decrease the uniformity of the nucleation reaction and the reduction reaction, resulting in significant unevenness in the powder properties (particle diameter, surface smoothness, etc.) of the resulting crystallized powder. Therefore, it is desirable to minimize the difference in the reducing power. For this purpose, it is preferable to mix the reducing agent solution as quick as possible. The time required for mixing the reducing agent solution into the mixed solution of the metal salt raw material solution and the pH adjusting agent (mixing time) is preferably 180 seconds or shorter, more preferably 120 seconds or shorter, even more preferably 60 seconds or shorter. On the other hand, it is difficult to excessively shorten the mixing time due to restriction of the manufacturing device in some cases. The mixing time may be 1 second or longer, 3 seconds or longer, or 5 seconds or longer.

Also, when the pH adjusting solution is mixed into the metal salt raw material solution, the properties of the formed magnetic metal hydroxide are uneven due to a long mixing time, which may lead to unevenness in the powder properties of the crystallized powder. Although the influence of the long mixing time is not as great as at the mixing of the reducing agent solution, a shorter mixing time is preferable. The time required for mixing the pH adjusting agent (mixing time) is preferably 180 seconds or shorter, more preferably 120 seconds or shorter, even more preferably 80 seconds or shorter. The mixing time may be 1 second or longer, 3 seconds or longer, or 5 seconds or longer.

For suppressing the unevenness in the powder properties of the crystallized powder, an agitation mixing in which the solution is mixed while agitating is also effective when mixing the reducing agent solution or the pH adjusting solution. Since the agitation suppresses a rapid increase in the concentration of the components in the solution, the unevenness in the properties of the crystallized powder can be suppressed. The agitation mixing should be carried out using an agitator such as agitation blades.

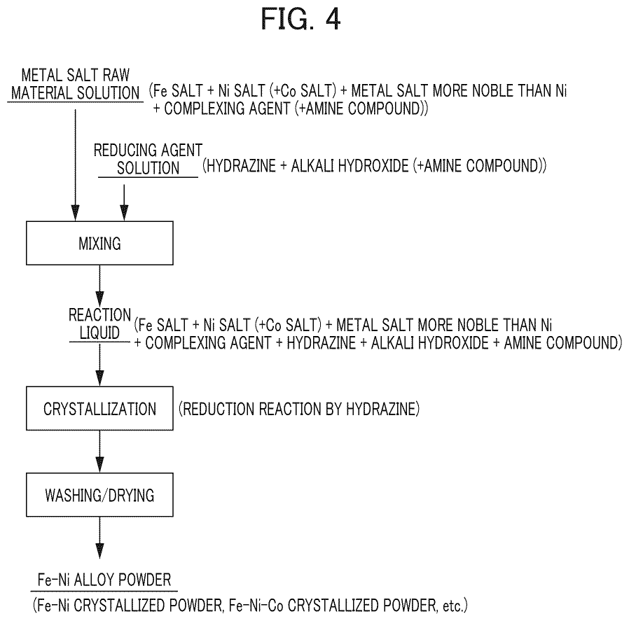

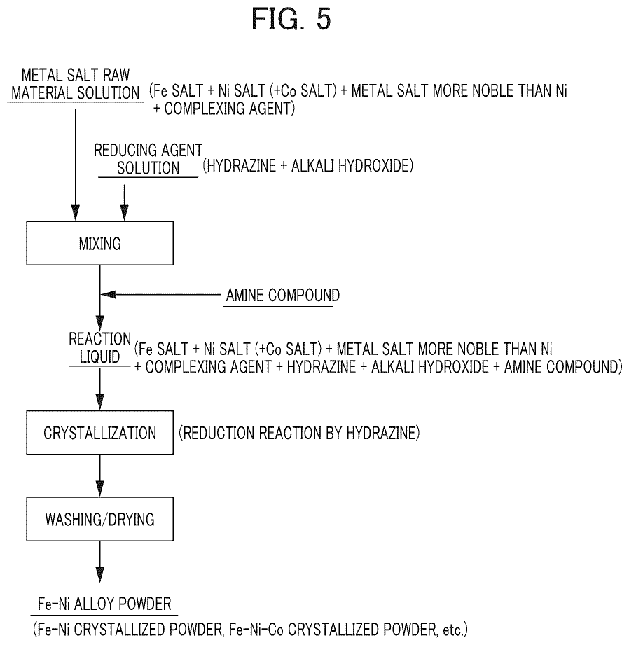

In the second aspect, when preparing the reaction liquid in the crystallization step, a metal salt raw material solution containing the magnetic metal source, the nucleating agent, and the complexing agent that are dissolved in water, and a reducing agent solution containing the reducing agent and the pH adjusting agent that are dissolved in water are individually prepared, and the metal salt raw material solution and the reducing agent solution are mixed. Each of FIG. 4 and FIG. 5 illustrates a process diagram of an example of the reaction liquid preparation and the alloy powder manufacture in the second aspect.

In the second aspect, two solutions: the metal salt raw material solution and the reducing agent solution are separately prepared. The metal salt raw material solution is prepared by dissolving the magnetic metal source (water-soluble iron salt, water-soluble nickel salt, etc.), the nucleating agent (water-soluble salt of a metal more noble than nickel), and the complexing agent (hydroxycarboxylic acid, etc.) in water. The reducing agent solution is prepared by dissolving the reducing agent (hydrazine) and the pH adjusting agent (alkali hydroxide) in water. Subsequently, the metal salt raw material solution and the reducing agent solution are mixed to prepare a mixed solution. The second aspect is different from the first aspect in that the reducing agent solution in the second aspect contains the pH adjusting agent.

As a specific preparation procedure of the reaction liquid in the second aspect, two ways can be adopted, such as a way in which the reducing agent solution is added and mixed into the metal salt raw material solution, and a way in which, conversely, the metal salt raw material solution is added and mixed into the reducing agent solution. Unlike the first aspect, the amount (volume) of the reducing agent solution containing both the reducing agent and the pH adjusting agent (alkali hydroxide) is at the same level as the amount (volume) of the metal salt raw material solution. Thus, by adding and mixing one of the reducing agents and the pH adjusting agent into the other one, a uniform mixed state can basically be achieved, so that a uniform reduction reaction can proceed in the reaction liquid.

However, under a crystallization condition where a proportion of the reducing agent and the pH adjusting agent (alkali hydroxide) to the metal salt raw material is high, it is preferable that the metal salt raw material solution is added and mixed into the reducing agent solution. This is because the concentration of the metal salt raw material in the reaction liquid needs to be maintained at a predetermined level or higher (30 to 40 g/L in terms of metal components) from the viewpoint of ensuring the productivity in the crystallization step. That means, under the aforementioned crystallization condition, the amount (volume) of the reducing agent solution is considerably larger than the amount (volume) of the metal salt raw material solution. Consequently, the procedure in which a small amount (volume) of metal salt raw material solution is added and mixed into a large amount (volume) of reducing agent solution can achieve a more homogeneous mixed state and proceed a more uniform reduction reaction in the reaction liquid.

Also in the second aspect, for the same reason as the first aspect, the time required for mixing the reducing agent solution into the metal salt solution (mixing time) is preferably 180 seconds or shorter, more preferably 120 seconds or shorter, even more preferably 60 seconds or shorter. In addition, the mixing time may be 1 second or longer, 3 seconds or longer, or 5 seconds or longer. The agitation mixing is also effective when mixing the reducing agent solution.

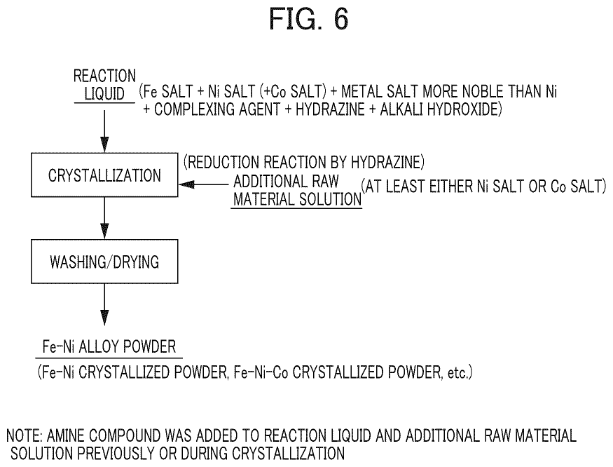

In the third aspect, an additional raw material liquid is further added and mixed into the reaction liquid before the reduction reaction is completed in the crystallization step of the first and second aspects. This makes the surface of the crystallized powder rich in nickel and cobalt components. Herein, the additional raw material liquid is a solution containing at least any one of the aforementioned water-soluble nickel salt and water-soluble cobalt salt dissolved in water. FIG. 6 illustrates a process diagram of an example of the alloy powder production in the third aspect.

In the third aspect, an additional raw material liquid is prepared in addition to the solutions used for preparing the reaction liquid in the first and second aspects. This additional raw material liquid is prepared by dissolving at least any one of a water-soluble nickel salt and a water-soluble cobalt salt in water. The additional raw material liquid may be added to the reaction liquid by single addition, divided addition, and/or dropwise addition. The addition is preferably, but not necessarily, carried out before the reduction reaction is completed. When the reduction reaction is thoroughly completed, the crystallized particles begin to agglomerate. At this timing, the additional raw material liquid is added to the reaction liquid to proceed the precipitation of the metal components by the reduction reaction, and then the bond between the particles in the agglomerate is strengthened in some cases.

The third aspect has an advantage that the amount of the reducing agent used can be decreased compared to the first aspect and the second aspect. Iron ions (or iron hydroxide) are less likely to be reduced than nickel ions (or nickel hydroxide) and cobalt ions (or cobalt hydroxide). When the additional raw material liquid containing nickel or cobalt components is added to the reaction liquid, the reduction reaction of iron ions (or iron hydroxide) that are difficult to reduce can be enhanced at the end stage of crystallization.

The amount of the magnetic metals (Ni, Co) in the additional raw material liquid should be set according to the degree to which the surface of the crystallized powder is enriched with the nickel and cobalt components. However, considering the composition homogeneity of the entire particles, the amount of the magnetic metals in the additional raw material liquid is preferably 5 mol % to 50 mol % based on the total amount of the magnetic metals (Ni, Co) excluding iron in the alloy powder. When the particle surface is rich in nickel and cobalt components, the iron component that tends to form a porous oxide film decreases. Thereby, a dense oxide film is formed and the amount of oxides on the particle surface is decreased, so that the magnetic metals are more stable in ambient air and also have improved magnetic properties such as a saturation magnetic flux density.

### (b) Crystallization of Crystallization Powder

When the reaction liquid is prepared, a reduction reaction occurs in the reaction liquid. In other words, the ions and complex ions of the magnetic metal source are reduced by the reducing agent (hydrazine) in the coexistence of the pH adjusting agent (alkali hydroxide) and the nucleating agent (salt of a metal more noble than nickel) to form a crystallized powder containing magnetic metals.

The reduction reaction in the crystallization step will be explained with reference to a reaction equation. The reduction reactions of iron (Fe), nickel (Ni), and cobalt (Co) are two-electron reactions as presented in Eq. (2) to Eq. (4) below. On the other hand, the reaction of hydrazine (N₂H₄) as a reducing agent is a four-electron reaction as presented in Eq. (5) below.

[Eq. 2]

Fe²⁺+2e⁻→Fe⬇ (two-electron reaction) (2)

[Eq. 3]

Ni²⁺+2e⁻→Ni⬇ (two-electron reaction) (3)

[Eq. 4]

Co²⁺+2e⁻→Co ⬇ (two-electron reaction) (4)

[Eq. 5]

N₂H₄→N₂⬆+4H⁺+4e⁻(four-electron reaction) (5)

When using magnetic metal chlorides (FeCl₂, NiCl₂, CoCl₂) as the magnetic metal sources and using sodium hydroxide (NaOH) as the pH adjusting agent, a neutralization reaction first occurs between the magnetic metal chlorides and sodium hydroxide to produce hydroxides ((Fe, Ni, Co) (OH)₂, etc.), as presented in Eq. (6) below. Then, the hydroxides ((Fe, Ni, Co) (OH)₂, etc.) are reduced by an action of the reducing agent (hydrazine) to form a crystallized powder. Reduction of 1 mol of magnetic metals (Fe, Ni, Co) requires 0.5 mol of reducing agent (hydrazine). As can be seen from Eq. (5) above, the higher the alkalinity (pH) is, the higher the reducing power of hydrazine is. For this reason, sodium hydroxide used as a pH adjusting agent also exhibits an effect of enhancing the reduction reaction with hydrazine.

[Eq. 6]

(Fe,Ni,Co)Cl₂+1/2N₂H₄+2NaOH→(Fe,Ni,Co)(OH)₂⬇+1/2N₂H₄+2 NaCl→(Fe,Ni,Co)⬇+1/2N₂⬆2NaCl+2H₂O (6)

In the reduction reaction according to Eq. (6) above, reductions of ions (or hydroxides) of each magnetic metal element (Fe, Ni, Co) proceed simultaneously to some extent by co-reduction. Herein, the co-reduction refers to a phenomenon that, when a reduction reaction of one element occurs, another reduction reaction associatively occurs. However, as mentioned above, iron ions (or iron hydroxide) are less likely to be reduced compared to nickel ions (or nickel hydroxide) or cobalt ions (or cobalt hydroxide). For this reason, there is a tendency that nickel ions (or nickel hydroxide) and cobalt ions (or cobalt hydroxide) are consumed and disappear by the reduction reaction in the reaction liquid, and iron ions (or iron hydroxide) remain at the end stage of the crystallization reaction. This tendency is particularly remarkable when the iron content is high (e.g., the iron content in the alloy powder is more than 60 mol %). When such a phenomenon occurs, it takes a long time to complete the crystallization reaction (reduction reaction), and furthermore an inclined structure with an uneven composition is likely to be formed within the particle. When the inclined structure is formed, the obtained alloy powder has a composition in which the nearer to the particle center, nickel and cobalt are more abundant, the nearer to the particle surface, iron is more abundant.

In contrast, in the aforementioned third aspect, the additional raw material liquid is added to the reaction liquid during the crystallization reaction to enhance the reduction reaction of iron ions (or iron hydroxide) that are difficult to reduce, at the end stage of the crystallization. This makes it possible to improve the prolonged crystallization reaction (reduction reaction) particularly in a case of high iron content, and the composition unevenness within the obtained alloy powder particle.

The temperature of the reaction liquid at the start of crystallization of the crystallized powder (reaction starting temperature) is preferably 40° C. or higher and 90° C. or lower, more preferably 50° C. or higher and 80° C. or lower, even more preferably 60° C. or higher and 70° C. or lower. Herein, the reaction liquid at the start of crystallization refers to a reaction liquid containing starting materials immediately after preparation, and water. The temperature of the reaction liquid maintained during the crystallization after the crystallization starts (reaction maintaining temperature) is preferably 60° C. or higher and 99° C. or lower, more preferably 70° C. or higher and 95° C. or lower, even more preferably 80° C. or higher and 90° C. or lower. For adjusting the reaction starting temperature within a suitable range, it is desirable to preheat at least any one of the plurality of solutions such as the metal salt raw material solution and the reducing agent solution to be used to prepare the reaction liquid. For adjusting the reaction maintaining temperature within a suitable range, it is desirable to continue the heating of the reaction liquid after the preparation of the reaction liquid.

From the viewpoint of making the nucleation more uniform to obtain a crystallized powder with a sharp particle size distribution, it is preferable that, if possible, any one of the plurality of solutions such as the metal salt raw material solution and the reducing agent solution is preheated (e.g., heated to 70° C.), while the other solutions are not preheated (e.g., maintained at 25° C.), then these solutions are blended to prepare a reaction liquid at a predetermined temperature (e.g., 55° C.). On the other hand, if both two solutions (e.g., the metal salt raw material solution and the reducing agent solution) are preheated (e.g., heated to 70° C.), ununiform nucleation is likely to occur. That means, when blending two solutions, the solutions cause mixing heat generation. As a result, the blended solution (reaction liquid) becomes locally hot (e.g., about 78° C.) at the start of the mixing, and nucleation instantly occurs. This results in a state where the two solutions are blended during nucleation, and this state tends to cause ununiform nucleation.

Although it can be considered that nucleation ununiformity is improved by extremely shortening the time taken to add the two solutions or by vigorously agitating the two solutions, but such methods are not necessarily preferable. In the aforementioned method in which only one of the solutions is preheated (e.g., heated to 70° C.), and then blended to prepare the reaction liquid, the blended solution (reaction liquid) is maintained at a low temperature (e.g., 55° C.) and is not locally heated to a high temperature. Since the timing of nucleation is delayed, nucleation proceeds after the two solutions are well mixed. Thereby, uniform nucleation easily occurs. The above description explains a more preferable case, and does not exclude cases where all of the plurality of the solutions such as the metal salt raw material solution and the reducing agent solution are preheated. The heating and the heating temperature of the solutions should be set such that the reaction starting temperature and the reaction maintaining temperature fall within the aforementioned ranges.

If the reaction starting temperature is excessively low, nucleation is more uniform, but progress of the reduction reaction is slow, which prolongs the heating time required for raising the temperature to the reaction maintaining temperature where the reduction reaction can be enhanced. Similarly, if the reaction maintaining temperature is excessively low, progress of the reduction reaction is slow, which prolongs the heating time required for crystallization. In both cases, the cycle time required for the crystallization step is prolonged, resulting in lowered productivity. In addition, since the autolysis of hydrazine proceeds, a large amount of hydrazine is required, resulting in an increased manufacturing cost. If the reaction starting temperature and the reaction maintaining temperature are high, the reduction reaction is enhanced, the cycle time required for the crystallization step is shortened, and the required crystallized powder tends to highly crystallize. At the same time, however, an autolysis rate of hydrazine increases. Thus, if the reaction starting temperature or the reaction maintaining temperature is excessively high, there are possibilities that not only nucleation becomes ununiform, but also smoothness of the particle surface deteriorates due to excessively high crystallization, resulting in significant surface irregularity. If crystallization is not terminated at an appropriate timing, hydrazine may autolyze due to the reduction reaction and be precedentially consumed. Hence, there is a concern that a large amount of hydrazine is required, leading to an increased manufacturing cost. By setting the reaction starting temperature and the reaction maintaining temperature within the aforementioned suitable ranges, a high-performance alloy powder can be manufactured at a low cost while maintaining high productivity.

### <Recovery Step>

In the recovery step, the crystallized powder is recovered from the reaction liquid obtained in the crystallization step. The crystallized powder may be recovered by any known method. Examples of known methods include a solid-liquid separation of a crystallized powder from a reaction liquid using a separation device such as a Denver filter, a filter press, a centrifuge, or a decanter. The crystallized powder may be washed during or after solid-liquid separation. Washing should be carried out using a washing liquid. As the washing liquid, a high-purity pure water having an electrical conductivity of 1 μS/cm or lower, or the like should be used. The washed crystallized powder may be dried. The drying treatment should be performed using a general-purpose dryer such as an ambient air dryer, a hot air dryer, an inert gas atmosphere dryer, a reducing gas atmosphere dryer, or a vacuum dryer at temperatures of 40° C. or higher and 150° C. or lower, preferably 50° C. or higher and 120° C. or lower. However, from the viewpoint of preventing deterioration of magnetic properties due to excessive oxidation of the crystallized powder during the drying treatment, use of an inert gas atmosphere dryer, a reducing gas atmosphere dryer, or a vacuum dryer is more preferable than use of an ambient air dryer or a hot air dryer with ambient air.

The crystallized powder dried in a sealed container of an inert gas atmosphere dryer, a reducing gas atmosphere dryer, or a vacuum dryer has a less oxidized particle surface. Thus, if the crystallized powder is taken out immediately after drying from the dryer to ambient air, the particle surface is rapidly oxidized, and the crystallized powder may burn by heat generation due to the oxidation reaction. This phenomenon is likely to occur particularly in a fine crystallized powder (e.g., particle diameter of 0.1 μm or smaller). Thus, it is desirable that the particle surface of the dried crystallized powder having the less oxidized particle surface is subjected to a slow oxidation treatment in which the particle surface is previously coated with a thin oxide film for stabilization. Specific examples of the slow oxidation treatment procedure may include a method, in which a temperature of a crystallized powder heated and dried in a sealed container of an inert gas atmosphere dryer, a reducing gas atmosphere dryer, or a vacuum dryer is lowered to room temperature to about 40° C., then a gas with a low oxygen concentration (e.g. nitrogen gas or argon gas containing 0.1 to 2% oxygen by volume) is fed into the sealed container, and a particle surface of the crystallized powder is gradually and slowly oxidized to form a thin oxide film. The crystallized powder that has undergone the slow oxidation treatment is stable and difficult to oxidize, and therefore the crystallized powder has no risk of heat generation or combustion even when left in ambient air.

### <High-Temperature Heating Treatment Step>

After or during the recovery step, a high-temperature heating treatment step may be provided, in which the crystallized powder is subjected to a high-temperature heating treatment. When the high-temperature heating treatment is performed after the recovery step, the high-temperature heating treatment should be performed after the drying treatment. When the high-temperature heating treatment is performed during the recovery step, the high-temperature heating treatment should be performed instead of the drying treatment. The high-temperature heating treatment should be performed in an inert atmosphere, a reducing atmosphere, or a vacuum atmosphere at a temperature higher than 150° C. and 400° C. or lower, preferably 200° C. or higher and 350° C. or lower. The high-temperature heating treatment makes it possible to enhance diffusion of heterogeneous elements such as Fe—Ni in the iron (Fe)-nickel (Ni) alloy particles to improve the composition homogeneity within the particle, or to adjust the magnetic properties such as magnetic force. If necessary, the aforementioned slow oxidation treatment may be performed after the high-temperature heating treatment.

### <Crushing Step>

If necessary, a crushing step may be provided, in which the crystallized powder recovered in the recovery step, or the crystallized powder during recovery and before the drying treatment is crushed. When alloy particles constituting the crystallized powder are precipitated in the crystallization step, the alloy particles may come into contact with each other and fuse together to form agglomerated particles in some cases. Thus, the crystallized powder obtained through the crystallization step may include coarse agglomerated particles. As mentioned above, coarse agglomerated particles increase the loss due to Joule heat by an eddy current flowing through the agglomerated particles, or inhibit the filling property of the powder in some cases. The agglomerated particles can be crushed by providing a crushing step after or during the recovery step. The crushing should be carried out by a dry crushing such as spiral jet crushing and counter jet mill crushing, a wet crushing such as high-pressure fluid collision crushing, or other general-purpose crushing methods. The dry crushing can be directly applied to the dried crystallized powder recovered in the recovery step. If the dried crystallized powder after the recovery step is made into a slurry, this crystallized powder can be subjected to the wet crushing. Furthermore, any slurry crystallized powder obtained during the recovery step and before drying can be directly subjected to the wet crushing. In these crushing methods, agglomerated particles are crushed into pieces by utilizing a collision energy of the particles. Since the surface smoothening also proceeds by collision during the crushing process, this effect also helps to improve the filling property of the powder.

### <Insulative Coating Step>

If necessary, an insulative coating step may be provided after the recovery step. In the insulative coating step, the crystallized powder obtained through the recovery step is subjected to the insulative coating treatment to form an insulative coat layer composed of a highly resistive metal oxide on the particle surface of the crystallized powder, thereby improving the insulating property between the particles. Similarly to the increased loss due to an eddy current in the coarse agglomerated particles, the eddy current that flows between the particles may increase due to the contact between the alloy particles in the dust core obtained by compression-forming the iron-nickel alloy powder. Generation of the eddy current due to the contact between the alloy particles can be suppressed by forming an insulative coat layer.

In the insulative coating treatment, the crystallized powder is dispersed in a mixed solvent containing water and an organic solvent, furthermore a metal alkoxide is added and mixed into the mixed solvent to prepare a slurry, the metal alkoxide is hydrolyzed and dehydration-condensation polymerized in the obtained slurry to form an insulative coat layer on the particle surface of the crystallized powder, then the cake-like crystallized powder having the insulative coat layer is solid-liquid separated from the slurry, the separated crystallized powder is dried to recover the crystallized powder having the insulative coat layer composed of a highly resistive metal oxide. If necessary, the crystallized powder that has been separated and dried may be subjected to a heat treatment. Since the hydrolysis reaction of the metal alkoxide in a mixed solvent containing water and an organic solvent proceeds very slowly with no additive, a trace amount of hydrolysis catalyst such as an acid or a base (alkali) is generally added to the solvent to enhance the reaction. Also in this embodiment, it is preferable to add a base catalyst (alkali catalyst).

Preferably, the highly resistive metal oxides are composed mainly of at least one or more selected from a group consisting of silicon dioxide (SiO₂), aluminum oxide (Al₂O₃), zirconium oxide (ZrO₂), and titanium dioxide (TiO₂). Above all, a highly resistive metal oxides composed mainly of silicon dioxide (SiO₂) is particularly preferable because it is inexpensive and excellent in an insulating property.

For the purpose of obtaining such a metal oxide, an alkoxide that can ultimately form a metal oxide by hydrolysis and dehydration-condensation polymerization is selected as the metal alkoxide to be used for the slurry in the insulative coating treatment. Specifically, an alkoxide mainly composed of at least one or more selected from a group consisting of silicon alkoxide (alkyl silicate), aluminum alkoxide (alkyl aluminate), zirconium alkoxide (alkyl zirconate), and titanium alkoxide (alkyl titanate) is preferable, above all, an alkoxide mainly composed of silicon alkoxide (alkyl silicate) is particularly preferable. If necessary, a small amount of a component (e.g., boron alkoxide) that is incorporated into the insulative coat layer by hydrolysis or the like may be added to the aforementioned metal alkoxide, when the metal alkoxide is hydrolyzed and dehydration-condensation polymerized to form the insulative coat layer.

The surface of the alloy powder subjected to the insulative coating treatment is coated with a highly resistive metal oxide that is an inorganic substance. If necessary, an organic functional group may be introduced to the surface of the inorganic substance. In a specific method, for example, a small amount of a coupling agent based on silicon, titanium, zirconium, or aluminum is compounded into a metal alkoxide to be used in an insulative coating treatment, and an organic functional group is incorporated into a metal oxide during hydrolysis and dehydration-condensation polymerization of the metal alkoxide. In another method, a surface of an insulative coating-treated alloy powder is treated with the aforementioned coupling agent so that the metal oxide surface is modified with an organic functional group. In both methods, the introduction of the organic functional group increases the affinity with resin, and therefore, when the alloy powder subjected to the insulative coating treatment is compounded and formed with a resin binder or the like, a strength of the molded body can be expected to be improved.

Specific examples of the silicon alkoxide (alkyl silicate) include one or more selected from tetramethoxysilane (another name: tetramethyl orthosilicate, silicon tetramethoxide) (abbreviation: TMOS) (Si(OCH₃)₄), tetraethoxysilane (another name: tetraethyl orthosilicate, silicon tetraethoxide) (abbreviation: TEOS) (Si(OC₂H₅)₄), tetrapropoxysilane (another name: tetrapropyl orthosilicate, silicon tetrapropoxide) (Si(OC₃H₇)₄), tetrabutoxysilane (another name: tetrabutyl orthosilicate, and silicon tetrabutoxide) (Si(OC₄H₉)₄), and the like. In addition, the examples may include an alkoxide in which an alkoxyl group is substituted by another alkoxyl group, or a commercially available alkyl silicate as a silicate oligomer that has already been polymerized to a tetramer or pentamer (e.g., ETHYL SILICATE 40 (trade name), ETHYL SILICATE 48 (trade name), or METHYL SILICATE 51 (trade name), manufactured by COLCOAT Co., Ltd.). Above all, tetraethoxysilane (TEOS) is preferable because of its low toxicity, easy availability, and low cost.

Specific examples of aluminum alkoxide (alkyl aluminate) include one or more selected from aluminum trimethoxide (Al(OCH₃)₃), aluminum triethoxide (Al(OC₂H₅)₃), aluminum triisopropoxide (Al(O-iso-C₃H₇)₃), aluminum tri-n-butoxide (Al(O-n-C₄H₉)₃), aluminum tri-sec-butoxide (Al(O-s-C₄H₉)₃), aluminum tri-tert-butoxide (Al(O-t-C₄H₉)₃), and the like.

Specific examples of zirconium alkoxide (alkyl zirconate) include one or more selected from zirconium tetraethoxide (Zr(OC₂H₅)₄), zirconium tetra-n-propoxide (Zr(O-n-C₃H₇)₄), zirconium tetraisopropoxide (Zr(O-iso-C₃H₇)₄), zirconium tetra-n-butoxide (Zr(O-n-C₄H₉)₄), zirconium tetra-tert-butoxide (Zr(O-t-C₄H₉)₄), zirconium tetraisobutoxide (Zr(O-iso-C₄H₉)₄), and the like.

Specific examples of titanium alkoxide (alkyl titanate) include one or more selected from titanium tetramethoxide (Ti(OCH₃)₄), titanium tetraethoxide (Ti(OC₂H₅)₄), titanium tetraisopropoxide (Ti(O-iso-C₃H₇)₄), titanium tetraisobutoxide (Ti(O-iso-C₄H₉)₄), titanium tetra-n-butoxide (Ti(O-n-C₄H₉)₄), titanium tetra-tert-butoxide (Ti(O-t-C₄H₉)₄), titanium tetra-sec-butoxide (Ti(O-s-C₄H₉)₄), and the like.

Examples of other metal alkoxides include one or more selected from boron alkoxide (alkyl boronate), e.g., boron trimethoxide (B(OCH₃)₃), boron triethoxide (B(OC₂H₅)₃), boron tri-tert-butoxide (B(O-t-C₄H₉)₃), and the like.

The organic solvent used for the slurry in the insulative coating treatment is preferably a solvent that can form a mixed solvent with water and is easy to moderately dry. In other words, a solvent having a high compatibility with water and a relatively low boiling point (around 60° C. to 90° C.) is preferable. In addition, a solvent that is highly safe, easy to handle, easily available, and inexpensive is preferable. Considering these factors, a denatured alcohol composed mainly of ethyl alcohol is preferable.

The hydrolysis reaction and the dehydration-condensation polymerization reaction of the metal alkoxide in the insulative coating treatment will be explained with reference to reaction equations in a case of using silicon alkoxide (Si(OR)₄, R: alkyl group) as the metal alkoxide.

In the hydrolysis reaction, as presented in Eq. (7) below, silicon atom (Si) is directly attacked by nucleophilic hydroxy ions (OH—) and then one of the alkoxy groups (—OR) is first hydrolyzed in the coexistence of a base catalyst (alkali catalyst) such as ammonia (NH₃). Thereby, charges on silicon atom decrease and silicon atom becomes more susceptible to attack from the nucleophilic hydroxy ions (OH—). As a result, four alkoxy groups (—OR) are all hydrolyzed into silanol groups (Si—OH) as presented in Eq. (8) below. In this way, when a base catalyst (alkali catalyst) is used, all alkoxy groups (—OR) are hydrolyzed in the hydrolyzed silicon alkoxide molecules, resulting in coexistence of completely hydrolyzed molecules (Si(OH)₄) and completely unhydrolyzed molecules (Si(OR)₄) in the slurry.

[Eq. 7]

Si(OR)₄+H₂O[+OH^{-]→Si(OH)(OR)}₃ROH[+OH⁻] (7)

[Eq. 8]

Si(OR)₄+4H₂O[+OH⁻]→Si(OH)₄+4ROH[OH⁻] (8)

On the other hand, as presented in Eq. (9) below, silicon atom (Si) becomes more susceptible to attack from water (H₂O) through protonation of the alkoxy groups (—OR) by protons (H+) in the coexistence of an acid catalyst such as nitric acid (HNO₃). As a result, one of the alkoxy groups (—OR) is first hydrolyzed into a silanol group (Si—OH). Although detailed description is omitted, in this state, the charges on silicon atom and charges on oxygen atom (O) decrease, and therefore silicon atom becomes less susceptible to attack from proton (H⁺). Thus, the next hydrolysis does not occur immediately, and, instead, the alkoxy groups (—OR) of the other unhydrolyzed silicon alkoxide molecules become more susceptible to hydrolysis. In this way, use of the acid catalyst proceeds uniform hydrolysis of the alkoxy groups (—OR) in all silicon alkoxide molecules as presented in Eq. (10) below. Consequently, there are no completely hydrolyzed molecules and no completely unhydrolyzed molecules, and there are uniformly hydrolyzed molecules (Si(OH)ₓ(OR)₄₋ₓ; 0<x<4) in the slurry.

[Eq. 9]

Si(OR)₄+4+H₂O[+H⁺]→Si(OH)(OR)₂+ROH[+H+] (9)

[Eq. 10]

Si(OR)₄+xH₂O[+H⁺]→Si(OH)ₓ(OR)₄₋ₓ+xROH[+H^{+](0<x<4)} (10)

The dehydration-condensation polymerization reaction makes it possible to proceed formation of siloxane bonds (Si—O—Si) by the dehydration-condensation polymerization reaction of the silanol groups (Si—OH) between the hydrolyzed silicon alkoxide molecules, as presented in Eq. (11) below. When this dehydration-condensation polymerization reaction proceeds to completion, silicon dioxide (SiO₂) is produced as presented in Eq. (12) below.

[Eq. 11]

Si(OH)₄+Si(OH)₄→(OH)₃Si—O—Si(OH)₃+H₂O (1)

[Eq. 12]

Si(OH)₄→SiO₂+2H₂O (12)

In summary, once the hydrolysis and dehydration-condensation polymerization of the silicon alkoxide is completed, silicon dioxide (SiO₂) and alcohol are produced as presented in Eq. (13) below. For example, use of tetraethoxysilane (TEOS: Si(OR)₄, R: C₂H₅) produces silicon dioxide (SiO₂) and ethyl alcohol (C₂H₅OH).

[Eq. 13]

Si(OR)₄+H₂O→SiO₂+4ROH (13)

Although Eq. (13) above is established whether a base catalyst (alkali catalyst) or an acid catalyst as long as the silicon alkoxide is hydrolyzed, the form of silicon dioxide (SiO₂) produced by progress of the dehydration-condensation polymerization is greatly affected by a state of hydrolysis with the aforementioned hydrolysis catalyst.

Silicon alkoxide molecules (Si(OH)ₓ(OR)₄₋ₓ; 0<x<4) that have been uniformly hydrolyzed by the acid catalyst have alkoxy groups (—OR) that have not been hydrolyzed. Thus, when the dehydration-condensation polymerization of the silanol groups (Si—OH) between molecules proceeds, hydrolyzed polymers polymerized in a linear shape or a branching line shape are produced. When these polymers are produced in the slurry during the insulative coating treatment, hydrolyzed polymers of the silicon alkoxide are produced on the particle surface composed of iron oxide (FeO) and nickel oxide (NiO). However, since these polymers are polymerized in a linear shape or a branching line shape, they are difficult to densify in the slurry solvent, and therefore a dense insulative coat layer is not easy to form.

On the other hand, when using a base catalyst (alkali catalyst), there are completely hydrolyzed molecules (Si(OH)₄). Thereby, when dehydration-condensation polymerization of the silanol group (Si—OH) between molecules proceeds, a dense hydrolyzed polymer polymerized in a lump shape is produced. Thus, even in the slurry solvent during the insulative coating treatment, a dense hydrolyzed polymer of the silicon alkoxide is produced on the particle surface composed of iron oxide (FeO) and nickel oxide (NiO) of the crystallized powder, and as a result, a dense insulative coat layer can be formed. When using a base catalyst (alkali catalyst), there may be completely unhydrolyzed molecules (Si(OR)₄). However, as described below, the completely unhydrolyzed molecules that are not consumed by the insulative coat of the crystallized powder in the insulative coating treatment and remain in the slurry, and particulate hydrolyzed polymers (silica sol) of the silicon alkoxide having a very small molecular weight are removed to the outside of the system together with the filtrate during filtration washing in the insulative coating step. Consequently, the insulative coating treatment is not affected.

For the above reasons, it is preferable that the hydrolysis of the metal alkoxide in the insulative coating treatment is carried out by using a base catalyst (alkali catalyst) rather than an acid catalyst. In this case, a suitable catalyst is different from that in a case of coating a substrate with a solvent. That means, when a metal alkoxide is used not for coating the particle surface in a solvent but as a binder for a coating liquid that is applied to a substrate to dry the solvent, it is more preferable that an alkoxide polymerized in a linear shape or a branching line shape is hydrolyzed by the aforementioned acid catalyst.

Regarding the timing of hydrolysis of the metal alkoxide in the insulative coating treatment, the aspect in which the metal alkoxide is hydrolyzed by the hydrolysis catalyst in a state that the crystallized powder and the metal alkoxide are homogeneously mixed in the slurry, has been explained above. However, this embodiment is not limited to the aspect in which the hydrolysis is performed at this timing. For example, a metal alkoxide is previously hydrolyzed by a hydrolysis catalyst to prepare a metal oxide sol (silica sol in the case of silicon alkoxide), and this metal oxide sol can be mixed with the crystallized powder to produce a slurry. If the metal oxide sol has an average molecular weight of as small as about 500 to 5000, there is no influence of the timing for hydrolyzing the metal alkoxide. This is because the particle surface of the crystallized powder is covered by small metal oxide sol particles due to a bond between iron oxide (FeO) or nickel oxide (NiO) on the surface of the crystallized powder and a hydrolysis group (silanol group (Si—OH) in the case of silicon alkoxide) of the metal oxide sol, and then polymerization between the sol particles proceeds.

In the insulative coating treatment, from the viewpoint of homogeneously forming the insulative coat layer, the slurry containing the crystallized powder, water, the organic solvent, the metal alkoxide, and the hydrolysis catalyst is preferably subjected to agitation by agitation blades using an agitator, or agitation by rotation of a container using a special roller. The treatment time and the treatment temperature of the insulative coating treatment depend on a type of a metal alkoxide to be applied, and a required thickness of an insulative coat layer. For example, metal methoxides generally have a higher hydrolysis speed than of metal ethoxides. Hence, the treatment time and the treatment temperature only need to be appropriately set and are not particularly limited. For example, the treatment time should be several hours to a week, and the treatment temperature should be room temperature to 60° C. If the treatment temperature is as high as 40° C. to 60° C., the treatment speed can be increased to several times that of the speed in the case of treatment at room temperature.

The thickness of the insulative coat layer is not generally limited, because the thickness also depends on the degree of required insulation. To stretch a point, the thickness is preferably 1 nm to 30 nm, more preferably 2 nm to 25 nm, even more preferably 3 nm to 20 nm. Even if the thickness is excessively increased, insulation is saturated, meanwhile the content of soft magnetic components is decreased, and magnetic properties such as saturation magnetic flux density merely deteriorate. If the thickness is within the above range, the insulating function of the insulative coat layer can be exhibited without much deterioration of magnetic properties and other properties.

The crystallized powder that has been coated with the insulative coat layer by the hydrolysis and the dehydration-condensation polymerization of the metal alkoxide is solid-liquid separated as a cake-like crystallized powder from the slurry by using a known separation device such as a Denver filter, a filter press, a centrifuge, or a decanter. If necessary, the crystallized powder may be washed during the solid-liquid separation or the like. For washing, water, an organic solvent such as an alcohol with a relatively low boiling point, or a mixed solvent thereof should be used as a washing liquid. As mentioned above, if there are metal alkoxides remaining in the slurry without being consumed by the insulative coat, and hydrolyzed polymers thereof (unhydrolyzed molecules, or metal oxide sol with a small molecular weight), they are removed to the outside of the system together with a filtrate and a washing waste liquid during the solid-liquid separation or the washing.

The solid-liquid separated cake-like crystallized powder is dried and, if necessary, heated, and the crystallized powder having an insulative coat layer composed of highly resistive metal oxides is recovered. Drying is not restricted as long as excessive oxidation during drying can be suppressed. However, drying is preferably carried out using a dryer such as an inert gas atmosphere dryer, a reducing gas atmosphere dryer, and a vacuum dryer, and at a temperature of 40° C. or higher and 150° C. or lower. The higher the drying temperature is, the faster the dehydration-condensation polymerization of the metal alkoxide hydrolyzed polymer constituting the insulative coat layer proceeds, and therefore a harder, denser, and more insulative metal oxide can be obtained. If further improvement is desired, the crystallized powder may be heated in an inert gas atmosphere or a reducing gas atmosphere, or under vacuum, at higher than 150° C. and 450° C. or lower. Basically, there is no need to perform slow oxidation treatment after drying, because the insulative coat layer has already been formed.

The insulating property of the crystallized powder (alloy powder) is significantly improved by the insulative coating treatment. For example, while an iron-nickel alloy powder without insulative coating treatment normally has a green compact resistivity of 0.1 Ω·cm or lower (applied pressure: 64 MPa), the iron-nickel alloy powder subjected to an insulative coating treatment of forming an insulative coat layer with a thickness of about 0.015 μm (15 nm) and composed of silicon dioxide (SiO₂) has an improved green compact resistivity of 10⁶ 0-cm or higher.

In this way, the iron (Fe)-nickel (Ni) alloy powder according to this embodiment can be manufactured. The manufacturing method according to this embodiment is characterized by use of a specific nucleating agent (water-soluble salt of a metal more noble than nickel) effective in alloy powder refinement, and a specific complexing agent (hydroxycarboxylic acid, etc.) effective in reduction reaction enhancement, spheroidization enhancement, and surface smoothing. This characteristic makes it possible to improve powder properties while maintaining magnetic properties of the alloy powder after manufacture. Specifically, an average particle diameter of the alloy powder after manufacture can be freely controlled to obtain a fine alloy powder. In addition, the obtained alloy powder has a narrow particle size distribution and a uniform particle diameter. Furthermore, the alloy powder is spherical and has a smooth surface. Thereby, the alloy powder has an excellent filling property. Although not limited, an amine compound that functionally serves as a hydrazine autolysis suppressing agent and a reduction reaction enhancing agent can be used to decrease the amount of hydrazine used. Thereby, the manufacturing cost can be decreased, and the powder properties of the alloy powder can be made better.

### <<2. Iron-Nickel Alloy Powder>>

The iron (Fe)-nickel (Ni) alloy powder according to this embodiment has a small particle size distribution. The average particle diameter of this alloy powder can be freely controlled. Thus, the alloy powder can be easily refined so as to have a decreased particle size distribution. In addition, the alloy powder is spherical and has a high surface smoothness and an excellent filling property. The alloy powder according to this embodiment having these advantages can be used for various electronic component applications such as noise filters, choke coils, inductors, and wave absorbers, particularly suitably used as a dust core material for choke coils and inductors.

The average particle diameter of the alloy powder is preferably 0.10 μm or larger and 0.60 μm or smaller, more preferably 0.10 μm or larger and 0.50 μm or smaller. When the average particle diameter is moderately increased, deterioration of the magnetic property and the filling property due to surface oxidation can be suppressed. When the average particle diameter is moderately decreased, eddy current loss can be suppressed.

A coefficient of variation (CV value) in the particle size distribution of the alloy powder is preferably 25% or lower, more preferably 20% or lower, even more preferably 15% or lower. Herein, the coefficient of variation is an indicator of particle diameter variation, which indicates that the lower the coefficient of variation is, the narrower the particle size distribution is. Since the lowered coefficient of variation decreases coarse particles and excessively fine particles with high surface oxidation, the increase in eddy current loss can be prevented while maintaining excellent magnetic properties. The coefficient of variation (CV value) is calculated according to Eq. (14) below by determining an average particle diameter and a standard deviation in a number particle size distribution of the alloy powder.

$$\begin{matrix}[ Eq . 14 ] & \\ CV value ( \% ) = \frac{standard deviation of particle diameter}{a v erage particle diameter} \times 100 & ( 14 )\end{matrix}$$

The green compact density of the alloy powder depends on the composition and the particle diameter of the alloy powder, and there is a tendency that, when the iron content is low, the green compact density decreases due to a lower specific gravity of the alloy, and similarly when the particle diameter is small, the green compact density decreases due to difficulty for particles to fill in amongst each other. In the case of an iron-nickel alloy powder having an average particle diameter of 0.3 μm to 0.5 μm, a specific gravity of 8.2 to 8.3, and an iron (Fe) content of 45 mol % to 60 mol %, a green compact density (applied pressure: 100 MPa) of the alloy powder is preferably 3.60 g/cm³ or higher, more preferably 3.70 g/cm³ or higher. In the case of an iron-nickel alloy powder having an average particle diameter of 0.3 μm to 0.5 μm, a specific gravity of 7.9 to 8.0, and an iron (Fe) content of 10 mol % to 20 mol %, a green compact density (applied pressure: 100 MPa) of the alloy powder is preferably 3.45 g/cm³ or higher, more preferably 3.55 g/cm³ or higher. In terms of the particle diameter of the alloy powder, there is a tendency that, when the average particle diameter is decreased from about 0.3 μm to 0.5 μm to about 0.2 μm to 0.25 μm, the green compact density (applied pressure: 100 MPa) decreases by about 0.1 g/cm³. A dust core having an excellent magnetic property (magnetic flux density) can be produced by increasing the green compact density. A crystallite diameter of the alloy powder is preferably 30 nm or smaller, more preferably 10 nm or smaller. When the crystallite diameter is kept moderately small, the alloy powder exhibits an effect of facilitating acquisition of a low coercive force like an amorphous soft magnetic material. The saturation magnetic flux density of the alloy powder is preferably 1 T (tesla) or higher, more preferably 1.2 T or higher, even more preferably 1.5 T or higher. Further preferably, the saturation magnetic flux density is not lower than the saturation magnetic flux density of pure iron powder (1.95 T to 2.0 T). The magnetic property (magnetic flux density) of the dust core can be improved by increasing the saturation magnetic flux density of the alloy powder. The coercive force of the alloy powder is preferably 2000 A/m or lower, more preferably 1600 A/m or lower, and even more preferably 1200 A/m or lower. Increase in the hysteresis loss can be prevented by suppressing the coercive force of the alloy powder.

As mentioned above, iron ions (or iron hydroxide) are less likely to be reduced than nickel ions (or nickel hydroxide) and cobalt ions (or cobalt hydroxide), and therefore the iron (Fe)-nickel (Ni) alloy powder with a high iron content (e.g., iron content in the alloy powder is more than 60 mol %) has a composition that the particle center is rich in nickel and cobalt. An inclined structure in which the nearer to the particle surface, iron is more abundant (or a core-shell structure) is likely to be formed in the particle. The composition tends to be uneven within the particle.

A manner that such an uneven composition within the particle acts on the properties of the alloy powder does not significantly affect the magnetic properties (saturation magnetic flux density, coercive force, etc.). This is because, for example, the saturation magnetic flux density shows a positive correlation with the iron content (the more the iron content is, the higher the saturation magnetic flux density is), therefore, even if the particle has a region with an iron content more than an average value and a region with an iron content less than the average value due to the uneven composition, a region with a saturation magnetic flux density higher than an average value and a region with a saturation magnetic flux density lower than the average value are also formed, so that, when the values are averaged over the entire alloy powder, the saturation magnetic flux density is almost the same as that of the homogeneous composition. Also, the coercive force does not significantly change with a degree of compositional unevenness caused merely within the particle, because originally the coercive force does not considerably depend on the composition in the iron-nickel (-cobalt) system.

On the other hand, the aforementioned uneven composition within the particle may affect chemical and physical properties such as oxidation resistance and thermal expansion coefficient. In an example of such a case, with regard to oxidation resistance, for example, if the particle surface has a more iron-rich composition because of the inclined structure, oxidation may easily progress to deteriorate the oxidation resistance. However, on the contrary, the oxidation resistance can be improved when the particle surface can be modified so as to have a nickel-rich composition according to the aforementioned third aspect. Next, regarding the thermal expansion coefficient, unlike the saturation magnetic flux density, the thermal expansion coefficient of the iron-nickel alloys does not show a positive or negative correlation with the iron content, and is characterized in that it significantly decreases only when the iron content is around 65 mol % (64% by mass). The alloy having this composition with low thermal expansion coefficient is called an invar alloy (main components: 65 mol % of iron and 35 mol % of nickel). In the case of this composition, if the composition is uneven within the particle, the thermal expansion coefficient does not decrease in both the region with an iron content of more than 65 mol % and the region with an iron content of less than 65 mol %, and therefore, it is necessary to make the composition uniform by the aforementioned high-temperature heating treatment or the like when using an iron (Fe)-nickel (Ni) alloy powder as an invar alloy powder.

To the best of the inventors' knowledge, there has been no known method for simply and inexpensively manufacturing an iron-nickel alloy powder having such excellent properties. For example, Patent Document 3 discloses a method for manufacturing a nickel-iron alloy nanoparticles by a wet process, but this method does not use a nucleating agent composed of a water-soluble salt of a metal more noble than nickel, or a complexing agent composed of hydroxycarboxylic acids and the like. Therefore, it is assumed that an alloy powder manufactured by this method has inferior powder characteristics (particle diameter, particle size distribution, sphericity, and surface properties of particles). In fact, Patent Document 3 presents a transmission electron micrograph of a fine powder as an example sample (FIG. 1 in Patent Document 3), and a coefficient of variation (CV value) in the particle size distribution of the fine powder is estimated to be as high as about 35% from this photograph.

Besides, in the method of Patent Document 3 without using any nucleating agent or complexing agent, a large amount of reducing agent (hydrazine) needs to be used to obtain a fine alloy powder. In fact, in Examples in Patent Document 3, 16.6 g of nickel chloride hexahydrate, 4.0 g of ferrous chloride tetrahydrate, and 135 g of hydrazine monohydrate were used as raw materials to manufacture alloy nanoparticles. When converted from these blended amounts, a large amount of hydrazine, approximately 30 times the total amount of iron and nickel in the molar ratio, is compounded. Thus, the method requiring a large amount of hydrazine is impractical because a cost of the reducing agent is very high.

### EXAMPLES

The present invention will be explained in more detail with reference to the following Examples and Comparative Examples. However, the invention is not limited to the following examples.

(1) Preparation of Iron-Nickel Alloy Powder

### Example 1

In Example 1, an iron-nickel alloy powder containing 50 mol % of iron (Fe) and 50 mol % of nickel (Ni) (iron-nickel alloy powder) was prepared according to the procedure illustrated in FIG. 5. In Example 1, when preparing a reaction liquid, a reducing solution at normal temperature was added and mixed into a metal salt raw material solution heated using a water bath.

### <Preparation Step>

Ferric chloride tetrahydrate (FeCl₂·4H₂O, molecular weight: 198.81, a reagent manufactured by Wako Pure Chemical Industries, Ltd.) was prepared as a water-soluble iron salt, and nickel chloride hexahydrate (NiCl₂·6H₂O, molecular weight: 237.69, a reagent manufactured by Wako Pure Chemical Industries, Ltd.) was prepared as a water-soluble nickel salt. Ammonium palladium (II) chloride (another name: ammonium tetrachloropalladate (II)) ((NH₄)₂PdCl₄, molecular weight: 284.31, a reagent manufactured by Wako Pure Chemical Industries, Ltd.) was prepared as a nucleating agent, trisodium citrate dihydrate (Na₃(C₃H₅O(COO)₃)·2H₂O, molecular weight: 294.1, a reagent manufactured by Wako Pure Chemical Industries, Ltd.) was prepared as a complexing agent, a commercial industrial grade 60 mass %-water-holding hydrazine (manufactured by Otsuka MGC Chemical Company, Inc.) was prepared as a reducing agent, and sodium hydroxide (NaOH, molecular weight: 40.0, a reagent manufactured by Wako Pure Chemical Industries, Ltd.) was prepared as a pH adjusting agent. The 60 mass %-water-holding hydrazine contained a water-holding hydrazine (N₂H₄-H₂O, molecular weight: 50.06) diluted 1.67 times with pure water. Furthermore, ethylenediamine (EDA; H₂NC₂H₄NH₂, molecular weight: 60.1, a reagent manufactured by Wako Pure Chemical Industries, Ltd.) was prepared as an amine compound.

### <Crystallization Step>

### (a) Preparation of Metal Salt Raw Material Solution

A metal salt raw material solution containing ferrous chloride tetrahydrate (water-soluble iron salt), nickel chloride hexahydrate (water-soluble nickel salt), ammonium palladium (II) chloride (nucleating agent), trisodium citrate dihydrate (complexing agent) and water was prepared. In this process, the components were weighed out such that an amount of palladium (Pd) based on the total amount of the magnetic metals (Fe and Ni) was 0.037 ppm by mass (0.02 mol ppm) in the resulting metal salt raw material solution. In addition, the weighing was carried out such that the molar ratio of trisodium citrate to the total amount of the magnetic metals (Fe and Ni) was 0.362 (36.2 mol %). Specifically, ferrous chloride tetrahydrate: 173.60 g, nickel chloride hexahydrate: 207.55 g, ammonium palladium (II) chloride: 9.93 μg, and trisodium citrate dihydrate: 185.9 g were dissolved in pure water: 1200 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe and Ni) was 4.85 in a reaction liquid to be prepared in the subsequent crystallization step. In addition, the weighing was carried out such that the molar ratio of sodium hydroxide to the total amount of the magnetic metals (Fe and Ni) was 4.96. Specifically, 346 g of sodium hydroxide was dissolved in 850 mL of pure water to prepare a sodium hydroxide solution, and 707 g of 60 mass %-water-holding hydrazine was added and mixed into this sodium hydroxide solution to prepare the reducing agent solution.

### (c) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe and Ni) was as low as 0.01 (1.0 mol %) in a reaction liquid to be prepared in the subsequent crystallization step. Specifically, 1.05 g of ethylenediamine was dissolved in 18 mL of pure water to prepare the amine compound solution.

### (d) Preparation of Reaction Liquid and Precipitation of Crystallized Powder

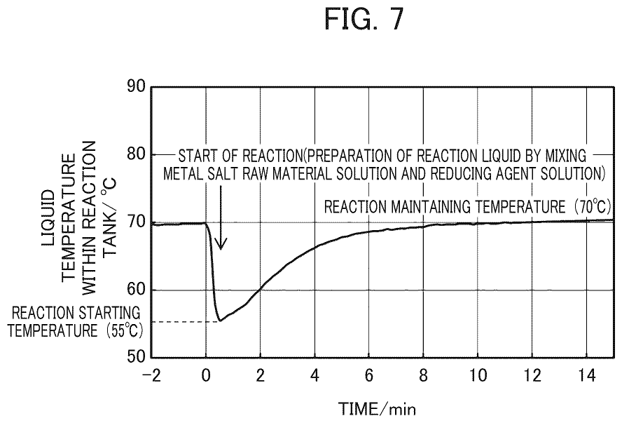

The prepared metal salt raw material solution was placed in a Teflon (registered trademark)-coated stainless steel vessel (reaction tank) equipped with agitation blades disposed in a water bath, and heated while agitated such that the liquid temperature was 70° C. Then, the reducing agent solution at 25° C. was added and mixed into the metal salt raw material solution that had been heated in the water bath for a mixing time of 10 seconds to obtain a reaction liquid at 55° C. A concentration of the magnetic metals (Fe and Ni) in the reaction liquid was 32.3 g/L. Thereby, a reduction reaction (crystallization reaction) was started (reaction starting temperature: 55° C.). As presented in FIG. 7, the temperature of the reaction liquid continued to rise by the heating with the water bath from the start of the reaction, and, 10 minutes after the start of the reaction, the liquid temperature was maintained at 70° C. (reaction maintaining temperature: 70° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂) and nickel hydroxide (Ni(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel crystallized powder was precipitated in the reaction liquid. At this time, the color tone of the reaction liquid was black, but a supernatant of the reaction liquid became transparent within 20 minutes from the start of the reaction. This may be because all of the iron and nickel components in the reaction liquid were reduced into metallic iron and metallic nickel after the reduction reaction according to Eq. (6) above was completed. The reaction liquid after completion of the reaction was a slurry containing an iron-nickel crystallized powder.

### <Recovery Step>

The slurry reaction liquid obtained in the crystallization step was subjected to filtration washing and solid-liquid separation to recover a cake-like iron-nickel crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, the iron-nickel alloy powder was obtained. The obtained alloy powder was composed of spherical particles with a smooth surface. The alloy powder had a sharp particle size distribution and an average particle diameter of 0.41 μm.

### Example 2

In Example 2, an iron-nickel alloy powder containing 50 mol % of iron (Fe), 40 mol % of nickel (Ni), and 10 mol % of cobalt (Co) (iron-nickel-cobalt alloy powder) was produced according to the procedure illustrated in FIG. 3. In Example 2, when preparing the reaction liquid, first, a pH adjusting solution (alkali hydroxide solution) at normal temperature, and subsequently a reducing agent solution at normal temperature were added and mixed into a metal salt raw material solution heated using a water bath.

### <Preparation Step>

The same raw materials as in Example 1 were prepared as a water-soluble iron salt, a water-soluble nickel salt, a nucleating agent, a complexing agent, a reducing agent, a pH adjusting agent, and an amine compound. Besides, cobalt chloride hexahydrate (CoCl₂·6H₂O, molecular weight: 237.93, a reagent manufactured by Wako Pure Chemical Industries, Ltd.) was prepared as a water-soluble cobalt salt.

### <Crystallization Step>

### (a) Preparation of Metal Salt Raw Material Solution

A metal salt raw material solution containing ferrous chloride tetrahydrate (water-soluble iron salt), nickel chloride hexahydrate (water-soluble nickel salt), cobalt chloride hexahydrate (water-soluble cobalt salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe, Ni, and Co) was 0.037 ppm by mass (0.02 mol ppm) in the obtained metal salt raw material solution. In addition, the weighing was carried out such that the molar ratio of trisodium citrate to the total amount of the magnetic metals (Fe, Ni, and Co) was 0.362 (36.2 mol %). Specifically, ferrous chloride tetrahydrate: 173.60 g, nickel chloride hexahydrate: 166.04 g, cobalt chloride hexahydrate: 41.55 g, ammonium palladium (II) chloride: 9.93 μg, and trisodium citrate dihydrate: 185.9 g were dissolved in pure water: 1200 mL to prepare the metal salt raw material solution.

### (b) Preparation of Reducing Agent Solution

A reducing agent solution containing hydrazine (reducing agent) and water was prepared. In this process, a blended amount of hydrazine was set such that the molar ratio of hydrazine to the total amount of the magnetic metals (Fe, Ni, and Co) was 4.85 in a reaction liquid to be prepared in the subsequent crystallization step. Specifically, 707 g of 60 mass %-water-holding hydrazine was weighed out to prepare the reducing agent solution.

### (c) Preparation of pH Adjusting Solution (Alkaline Hydroxide Solution)

A pH adjusting solution (alkali hydroxide solution) containing sodium hydroxide (pH adjusting agent) and water was prepared. In this process, sodium hydroxide was weighed out such that the molar ratio of sodium hydroxide to the total amount of the magnetic metals (Fe, Ni, and Co) was 4.96 in a reaction liquid to be prepared in the subsequent crystallization step. Specifically, 346 g of sodium hydroxide was dissolved in 850 mL of pure water to prepare the pH adjusting solution.

### (d) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe, Ni, and Co) was as low as 0.01 (1.0 mol %) in a reaction liquid to be prepared in the subsequent crystallization step. Specifically, 1.05 g of ethylenediamine was dissolved in 18 mL of pure water to prepare the amine compound solution.

### (e) Preparation of Reaction Liquid and Precipitation of Crystallized Powder

The prepared metal salt raw material solution was placed in a Teflon (registered trademark)-coated stainless steel vessel (reaction tank) equipped with agitation blades disposed in a water bath, and heated while agitated such that the liquid temperature was 70° C. Then, the pH adjusting solution (alkali hydroxide solution) at 25° C. was added and mixed into the metal salt raw material solution that had been heated in the water bath for a mixing time of 10 seconds, to which the reducing agent solution at 25° C. was subsequently added for a mixing time of 10 seconds to obtain a reaction liquid at 55° C. A concentration of the magnetic metals (Fe, Ni, and Co) in the reaction liquid was 32.3 g/L. Thereby, a reduction reaction (crystallization reaction) was started (reaction starting temperature: 55° C.). The temperature of the reaction liquid continued to rise by the heating with the water bath from the start of the reaction, and, 10 minutes after the start of the reaction, the liquid temperature was maintained at 70° C. (reaction maintaining temperature: 70° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂), nickel hydroxide (Ni(OH)₂), and cobalt hydroxide (Co(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel-cobalt crystallized powder was precipitated in the reaction liquid. At this time, the color tone of the reaction liquid was black, but a supernatant of the reaction liquid became transparent within 20 minutes from the start of the reaction. This may be because all of the iron, nickel, and cobalt components in the reaction liquid were reduced into metallic iron, metallic nickel, and metallic cobalt after the reduction reaction according to Eq. (6) above was completed. The reaction liquid after completion of the reaction was a slurry containing an iron-nickel-cobalt crystallized powder.

### <Recovery Step>

The slurry reaction liquid obtained in the crystallization step was subjected to filtration washing and solid-liquid separation to recover a cake-like iron-nickel-cobalt crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, the iron-nickel-cobalt alloy powder was obtained. The obtained alloy powder was composed of spherical particles with a smooth surface. The alloy powder had a sharp particle size distribution and an average particle diameter of 0.33 μm.

### Example 3

In Example 3, an iron-nickel alloy powder containing 50 mol % of iron (Fe) and 50 mol % of nickel (Ni) (iron-nickel alloy powder) was produced according to the procedure illustrated in FIG. 5. In Example 3, when preparing the reaction liquid, a reducing solution at normal temperature was added and mixed into a metal salt raw material solution heated using a water bath.

### <Preparation Step>

The same raw materials as in Example 1 were prepared as a water-soluble iron salt, a water-soluble nickel salt, a nucleating agent, a reducing agent, a pH adjusting agent, and an amine compound. As a complexing agent, tartaric acid ((CH(OH)COOH)₂, molecular weight: 150.09, a reagent manufactured by Wako Pure Chemical Industries, Ltd.) was prepared instead of trisodium citrate dihydrate.

### <Crystallization Step>

### (a) Preparation of Metal Salt Raw Material Solution

A metal salt raw material solution containing ferrous chloride tetrahydrate (water-soluble iron salt), nickel chloride hexahydrate (water-soluble nickel salt), ammonium palladium (II) chloride (nucleating agent), tartaric acid (complexing agent), and water was prepared. In this process, the components were weighed out such that an amount of palladium (Pd) based on the total amount of the magnetic metals (Fe and Ni) was 0.037 ppm by mass (0.02 mol ppm) in the obtained metal salt raw material solution. In addition, the weighing was carried out such that the molar ratio of tartaric acid to the total amount of the magnetic metals (Fe and Ni) was 0.200 (20.0 mol %). Specifically, ferrous chloride tetrahydrate: 173.60 g, nickel chloride hexahydrate: 207.55 g, ammonium palladium (II) chloride: 9.93 μg, and tartaric acid: 52.4 g were dissolved in pure water: 1200 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe and Ni) was 4.85 in a reaction liquid to be prepared in the subsequent crystallization step. In addition, the weighing was carried out such that the molar ratio of sodium hydroxide to the total amount of the magnetic metals (Fe and Ni) was 4.96. Specifically, 346 g of sodium hydroxide was dissolved in 850 mL of pure water to prepare a sodium hydroxide solution, and 707 g of 60 mass %-water-holding hydrazine was added and mixed into this sodium hydroxide solution to prepare the reducing agent solution.

### (c) Preparation of Amine Compound Solution

An amine compound solution was prepared in the same manner as in Example 1.

### (d) Preparation of Reaction Liquid and Precipitation of Crystallized Powder

Using the metal salt raw material solution, the reducing agent solution, and the amine compound solution, a reaction liquid was prepared and a crystallized powder was precipitated in the same manner as in Example 1. A concentration of the magnetic metals (Fe and Ni) in the reaction liquid was 33.0 g/L.

### <Recovery Step>

From the slurry reaction liquid obtained in the crystallization step, an iron-nickel alloy powder (iron-nickel alloy powder) was produced in the same manner as in Example 1. The obtained alloy powder was composed of spherical particles with a smooth surface. The alloy powder had a sharp particle size distribution and an average particle diameter of 0.40 μm.

### Example 4

In Example 4, an iron-nickel alloy powder containing 56 mol % of iron (Fe) and 44 mol % of nickel (Ni) (iron-nickel alloy powder) was produced according to the procedure illustrated in FIG. 5. In Example 4, when preparing the reaction liquid, a metal salt raw material solution at normal temperature was added and mixed into a reducing solution heated using a water bath.

### <Preparation Step>

The same raw materials as in Example 1 were prepared as a nucleating agent, a reducing agent, a pH adjusting agent, a complexing agent, and an amine compound. As a water-soluble iron salt, ferrous sulfate heptahydrate (FeSO₄·7H₂O, molecular weight: 278.05, a reagent manufactured by Wako Pure Chemical Industries, Ltd.) was prepared instead of the ferrous chloride tetrahydrate, and as a water-soluble nickel salt, nickel sulfate hexahydrate (NiSO₄·6H₂O, molecular weight: 262.85, a reagent manufactured by Wako Pure Chemical Industries, Ltd.) was prepared instead of the nickel chloride hexahydrate.

### <Crystallization Step>

### (a) Preparation of Metal Salt Raw Material Solution

A metal salt raw material solution containing ferrous sulfate heptahydrate (water-soluble iron salt), nickel sulfate hexahydrate (water-soluble nickel salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe and Ni) was 0.037 ppm by mass (0.2 mol ppm) in the obtained metal salt raw material solution. In addition, the weighing was carried out such that the molar ratio of trisodium citrate dihydrate to the total amount of the magnetic metals (Fe and Ni) was 0.318 (31.8 mol %). Specifically, ferrous sulfate heptahydrate: 272.0 g, nickel sulfate hexahydrate: 202.0 g, ammonium palladium (II) chloride: 99.3 μg, and trisodium citrate dihydrate: 163.5 g were dissolved in pure water: 950 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe and Ni) was 6.41 in a reaction liquid to be prepared in the subsequent crystallization step. In addition, the weighing was carried out such that the molar ratio of sodium hydroxide to the total amount of the magnetic metals (Fe and Ni) was 4.67. Specifically, 326 g of sodium hydroxide was dissolved in 800 mL of pure water to prepare a sodium hydroxide solution, and 934 g of 60 mass %-water-holding hydrazine was added and mixed into this sodium hydroxide solution to prepare the reducing agent solution.

### (c) Preparation of Amine Compound Solution

An amine compound solution was prepared in the same manner as in Example 1.

### (d) Preparation of Reaction Liquid and Precipitation of Crystallized Powder

The prepared reducing agent solution was placed in a Teflon (registered trademark)-coated stainless steel vessel (reaction tank) equipped with agitation blades disposed in a water bath, and heated while agitated such that the liquid temperature was 70° C. Then, the metal salt raw material solution at 25° C. was added and mixed into the reducing agent solution that had been heated in the water bath for a mixing time of 10 seconds to obtain a reaction liquid at 59° C. A concentration of the magnetic metals (Fe and Ni) in the reaction liquid was 32.6 g/L. Thereby, a reduction reaction (crystallization reaction) was started (reaction starting temperature: 59° C.). The temperature of the reaction liquid continued to rise by the heating with the water bath from the start of the reaction, and, 10 minutes after the start of the reaction, the liquid temperature was maintained at 70° C. (reaction maintaining temperature: 70° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂) and nickel hydroxide (Ni(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel crystallized powder was precipitated in the reaction liquid. At this time, the color tone of the reaction liquid was black, but a supernatant of the reaction liquid became transparent within 30 minutes from the start of the reaction. This may be because all of the iron and nickel components in the reaction liquid were reduced into metallic iron and metallic nickel after the reduction reaction according to Eq. (6) above was completed. The reaction liquid after completion of the reaction was a slurry containing an iron-nickel crystallized powder.

### <Recovery Step>

The slurry reaction liquid obtained in the crystallization step was subjected to filtration washing and solid-liquid separation to recover a cake-like iron-nickel crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, the iron-nickel alloy powder was obtained. The obtained alloy powder was composed of spherical particles with a smooth surface. The alloy powder had a sharp particle size distribution and an average particle diameter of 0.38 μm.

### Example 5

In Example 5, an iron-nickel alloy powder having a nickel-rich surface composition and containing 51 mol % of iron (Fe) and 49 mol % of nickel (Ni) (iron-nickel alloy powder) was produced according to the procedure illustrated in FIG. 6. In this process, an additional raw material liquid was added and mixed into the reaction liquid at the end stage of the crystallization step. Specifically, first, the crystallization of the iron-nickel alloy powder containing 56 mol % of iron (Fe) and 44 mol % of nickel (Ni) (iron-nickel alloy powder) was proceeded in the same manner as in Example 4, except that the blended amount of hydrazine as a reducing agent was changed. Next, during this crystallization, a water-soluble nickel salt aqueous solution as the additional raw material liquid was added and mixed into the reaction liquid.

### <Preparation Step>

The same raw materials as in Example 4 were prepared as a water-soluble iron salt, a water-soluble nickel salt, a nucleating agent, a reducing agent, a pH adjusting agent, a complexing agent, and an amine compound.

### <Crystallization Step>

### (a) Preparation of Metal Salt Raw Material Solution

A metal salt raw material solution containing ferrous sulfate heptahydrate (water-soluble iron salt), nickel sulfate hexahydrate (water-soluble nickel salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe and Ni) was 0.37 ppm by mass (0.2 mol ppm) in the obtained metal salt raw material solution. In addition, the weighing was carried out such that the molar ratio of trisodium citrate dihydrate to the total amount of the magnetic metals (Fe and Ni) was 0.318 (31.8 mol %). Specifically, ferrous sulfate heptahydrate: 272.0 g, nickel sulfate hexahydrate: 202.0 g, ammonium palladium (II) chloride: 99.3 μg, and trisodium citrate dihydrate: 163.5 g were dissolved in pure water: 950 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe and Ni) at the time of starting the reaction was 4.85 (the molar ratio of hydrazine to the total amount of the magnetic metals (Fe and Ni) at the time of adding the additional raw material liquid was 4.41) in a reaction liquid to be prepared in the subsequent crystallization step. In addition, the weighing was carried out such that the molar ratio of sodium hydroxide to the total amount of the magnetic metals (Fe and Ni) at the time of starting the reaction was 4.67 (the molar ratio of sodium hydroxide to the total amount of the magnetic metals (Fe and Ni) at the time of adding the additional raw material liquid was 4.24). Specifically, 326 g of sodium hydroxide was dissolved in 800 mL of pure water to prepare a sodium hydroxide solution, and 707 g of 60 mass %-water-holding hydrazine was added and mixed into this sodium hydroxide solution to prepare the reducing agent solution.

### (c) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe and Ni) after addition of the additional raw material liquid was as low as 0.01 (1.0 mol %) in a reaction liquid in the subsequent crystallization step. Specifically, 1.16 g of ethylenediamine was dissolved in 18 mL of pure water to prepare the amine compound solution.

(d) Preparation of Additional raw material liquid

An additional raw material liquid containing nickel sulfate hexahydrate (water-soluble nickel salt) and water was prepared. In this process, nickel sulfate hexahydrate was weighed out such that an amount of the magnetic metal (Ni) in the obtained additional raw material liquid was 0.175 mol, which was 0.10 times the total amount of 1.747 mol of the magnetic metals (Fe and Ni) in the metal salt raw material solution. Specifically, 46.0 g of nickel sulfate hexahydrate was dissolved in 200 mL of pure water to prepare the additional raw material liquid.

### (e) Preparation of Reaction Liquid and Precipitation of Crystallized Powder

The prepared reducing agent solution was placed in a Teflon (registered trademark)-coated stainless steel vessel (reaction tank) equipped with agitation blades disposed in a water bath, and heated while agitated such that the liquid temperature was 70° C. Then, the metal salt raw material solution at 25° C. was added and mixed into the reducing agent solution that had been heated in the water bath for a mixing time of 10 seconds to obtain a reaction liquid at 57° C. A concentration of the magnetic metals (Fe and Ni) in the reaction liquid was 35.2 g/L. Thereby, a reduction reaction (crystallization reaction) was started (reaction starting temperature: 57° C.). The temperature of the reaction liquid continued to rise by the heating with the water bath from the start of the reaction, and, 10 minutes after the start of the reaction, the liquid temperature was maintained at 70° C. (reaction maintaining temperature: 70° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂) and nickel hydroxide (Ni(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel crystallized powder was precipitated in the reaction liquid. From 11 minutes after the start of the reaction to 16 minutes later, the additional raw material liquid was added and mixed dropwise into the reaction liquid little by little to enhance reduction of iron ions (or iron hydroxide) that are difficult to reduce, meanwhile the reduction reaction was proceeded so that the surface of the precipitated iron-nickel crystallized powder became richer in nickel. A concentration of the magnetic metals (Fe and Ni) in the reaction liquid after addition of the additional raw material liquid was 32.8 g/L. At this time, the color tone of the reaction liquid was black, but a supernatant of the reaction liquid became transparent within 30 minutes from the start of the reaction. This may be because all of the iron and nickel components in the reaction liquid were reduced into metallic iron and metallic nickel after the reduction reaction was thoroughly completed. The reaction liquid after completion of the reaction was a slurry containing an iron-nickel crystallized powder.

### <Recovery Step>

The slurry reaction liquid obtained in the crystallization step was subjected to filtration washing and solid-liquid separation to recover a cake-like iron-nickel crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, the iron-nickel alloy powder was obtained. The obtained alloy powder was composed of spherical particles with a smooth surface. The alloy powder had a sharp particle size distribution and an average particle diameter of 0.40 μm.

### Example 6

In Example 6, the crystallized powder obtained in Example 1 was subjected to a spiral jet crushing treatment in a dry process at a crushing gas pressure of 0.5 MPa using an ultra-compact jet crusher (JKE-30, NIPPON PNEUMATIC MFG. CO., LTD.) to produce an iron-nickel alloy powder containing 50 mol % of iron (Fe) and 50 mol % of nickel (Ni) (iron-nickel alloy powder). The obtained alloy powder had a sharp particle size distribution similarly to Example 1, and an average particle diameter of 0.41 μm. By the spiral jet crushing treatment, the number of agglomerated particles was decreased to improve the filling property (increased green compact density), and the surface irregularity was decreased, so that the alloy powder was composed of spherical particles with a very smooth surface.

### Example 7

In Example 7, after the crystallization step and during the recovery step, the slurry crystallized powder before drying was subjected to a high-pressure fluid collision crushing treatment in a wet process as described below, to produce an iron-nickel alloy powder containing 50 mol % of iron (Fe) and 50 mol % of nickel (Ni) (iron-nickel alloy powder).

<Recovery Step (including Crushing Step)>

The slurry reaction liquid containing the iron-nickel crystallized powder obtained in the same crystallization step as in Example 1 was filtration-washed, and then a washed crystallized powder slurry containing 20% iron-nickel crystallized powder by mass was prepared using pure water with an electrical conductivity of 1 μS/cm. The aforementioned filtration washing was carried out using pure water with an electrical conductivity of 1 μS/cm until an electrical conductivity of a filtrate filtered from the slurry was 10 μS/cm or lower. The aforementioned washed crystallized powder slurry was passed through a high-pressure fluid collision crusher (manufactured by SUGINO MACHINE LIMITED CO., LTD.; pressure: 200 MPa) twice to crush the slurry, then subjected to solid-liquid separation to recover a cake-like iron-nickel crystallized powder. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume, to obtain an iron-nickel alloy powder. The obtained alloy powder had a sharp particle size distribution similarly to Example 1, and an average particle diameter of 0.41 μm. By the high-pressure fluid collision crushing treatment, the number of agglomerated particles was decreased to improve the filling property (increased green compact density), and the surface irregularity was decreased, so that the alloy powder was composed of spherical particles with a very smooth surface.

### Example 8

In Example 8, a crystallized powder obtained according to a procedure illustrated in FIG. 6 was subjected to a high-temperature heating treatment to produce an iron-nickel alloy powder containing 65 mol % of iron (Fe) and 35 mol % of nickel (Ni) (iron-nickel alloy powder). In Example 8, when preparing a reaction liquid, a metal salt raw material solution at normal temperature was added and mixed into a reducing solution heated using a water bath.

### <Preparation Step>

The same raw materials as in Example 4 were prepared as a water-soluble iron salt, a water-soluble nickel salt, a nucleating agent, a reducing agent, a pH adjusting agent, a complexing agent, and an amine compound.

### <Crystallization Step>

### (a) Preparation of Metal Salt Raw Material Solution

A metal salt raw material solution containing ferrous sulfate heptahydrate (water-soluble iron salt), nickel sulfate hexahydrate (water-soluble nickel salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe and Ni) was 2.81 ppm by mass (1.50 mol ppm) in the obtained metal salt raw material solution. In addition, the weighing was carried out such that the molar ratio of trisodium citrate dihydrate to the total amount of the magnetic metals (Fe and Ni) was 0.724 (72.4 mol %). Specifically, ferrous sulfate heptahydrate: 318.1 g, nickel sulfate hexahydrate: 161.9 g, ammonium palladium (II) chloride: 750.5 μg, and trisodium citrate dihydrate: 374.7 g were dissolved in pure water: 950 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe and Ni) at the time of starting the reaction was 8.98 in a reaction liquid to be prepared in the subsequent crystallization step. In addition, the weighing was carried out such that the molar ratio of sodium hydroxide to the total amount of the magnetic metals (Fe and Ni) at the time of starting the reaction was 7.07. Specifically, 497.5 g of sodium hydroxide was dissolved in 1218 mL of pure water to prepare a sodium hydroxide solution, and 1318 g of 60 mass %-water-holding hydrazine was added and mixed into this sodium hydroxide solution to prepare the reducing agent solution.

### (c) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe and Ni) was as low as 0.01 (1.0 mol %) in a reaction liquid in the subsequent crystallization step. Specifically, 1.06 g of ethylenediamine was dissolved in 18 mL of pure water to prepare the amine compound solution.

### (d) Preparation of Reaction Liquid and Precipitation of Crystallized Powder

The prepared reducing agent solution was placed in a Teflon (registered trademark)-coated stainless steel vessel (reaction tank) equipped with agitation blades disposed in a water bath, and heated while agitated such that the liquid temperature was 80° C. Then, the metal salt raw material solution at 25° C. was added and mixed into the reducing agent solution that had been heated in the water bath for a mixing time of 10 seconds to obtain a reaction liquid at 71° C. A concentration of the magnetic metals (Fe and Ni) in the reaction liquid was 25.0 g/L. Thereby, a reduction reaction (crystallization reaction) was started (reaction starting temperature: 71° C.). The temperature of the reaction liquid continued to rise by the heating with the water bath from the start of the reaction, and, 10 minutes after the start of the reaction, the liquid temperature was maintained at 80° C. (reaction maintaining temperature: 80° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂) and nickel hydroxide (Ni(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel crystallized powder was precipitated in the reaction liquid. At this time, the color tone of the reaction liquid was black, but a supernatant of the reaction liquid became transparent within 40 minutes from the start of the reaction. This may be because all of the iron and nickel components in the reaction liquid were reduced into metallic iron and metallic nickel after the reduction reaction was thoroughly completed. The reaction liquid after completion of the reaction was a slurry containing an iron-nickel crystallized powder.

### <Recovery Step>

The slurry reaction liquid obtained in the crystallization step was subjected to filtration washing and solid-liquid separation to recover a cake-like iron-nickel crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume.

### <High-Temperature Heating Treatment Step>

The crystallized powder thus obtained was subjected to high-temperature heating treatment in a nitrogen atmosphere at 350° C. for 60 minutes to produce an iron-nickel alloy powder containing 65 mol % of iron (Fe) and 35 mol % of nickel (Ni) (iron-nickel alloy powder). The obtained alloy powder had a sharp particle size distribution similarly to Example 1, and an average particle diameter of 0.27 μm. By the high-temperature heating treatment, diffusion of Fe and Ni within the iron (Fe)-nickel (Ni) alloy particle was enhanced to improve the compositional homogeneity within the particle, so that unevenness in properties within the particle was decreased.

### Example 9

In Example 9, an iron-nickel alloy powder having a nickel-rich surface composition and containing 65 mol % of iron (Fe) 35 mol % of nickel (Ni) (iron-nickel alloy powder) was produced according to the procedure illustrated in FIG. 6. In this process, an additional raw material liquid was added and mixed into the reaction liquid during the crystallization step. Specifically, a metal salt raw material solution at normal temperature was added and mixed into a reducing solution heated using a water bath to prepare a reaction liquid. First, crystallization of the iron-nickel alloy powder containing 67.4 mol % of iron (Fe) and 32.6 mol % of nickel (Ni) (iron-nickel alloy powder) was proceeded. During the crystallization, a water-soluble nickel salt aqueous solution as an additional raw material liquid was added and mixed into the reaction liquid.

### <Preparation Step>

The same raw materials as in Example 4 were prepared as a water-soluble iron salt, a water-soluble nickel salt, a nucleating agent, a reducing agent, a pH adjusting agent, a complexing agent, and an amine compound.

### <Crystallization Step>

### (a) Preparation of Metal Salt Raw Material Solution

A metal salt raw material solution containing ferrous sulfate heptahydrate (water-soluble iron salt), nickel sulfate hexahydrate (water-soluble nickel salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe and Ni) was 0.97 ppm by mass (0.52 mol ppm) in the obtained metal salt raw material solution. In addition, the weighing was carried out such that the molar ratio of trisodium citrate dihydrate to the total amount of the magnetic metals (Fe and Ni) was 0.750 (75.0 mol %). Specifically, ferrous sulfate heptahydrate: 318.1 g, nickel sulfate hexahydrate: 145.7 g, ammonium palladium (II) chloride: 250.0 μg, and trisodium citrate dihydrate: 374.7 g were dissolved in pure water: 500 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe and Ni) at the time of starting the reaction was 7.62 (the molar ratio of hydrazine to the total amount of the magnetic metals (Fe and Ni) at the time of adding the additional raw material liquid was 7.36) in a reaction liquid to be prepared in the subsequent crystallization step. In addition, the weighing was carried out such that the molar ratio of sodium hydroxide to the total amount of the magnetic metals (Fe and Ni) at the time of starting the reaction was 7.33 (the molar ratio of sodium hydroxide to the total amount of the magnetic metals (Fe and Ni) at the time of adding the additional raw material liquid was 7.07). Specifically, 497.5 g of sodium hydroxide was dissolved in 1218 mL of pure water to prepare a sodium hydroxide solution, and 1080 g of 60 mass %-water-holding hydrazine was added and mixed into this sodium hydroxide solution to prepare the reducing agent solution.

### (c) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe and Ni) after addition of the additional raw material liquid was as low as 0.01 (1.0 mol %) in a reaction liquid in the subsequent crystallization step. Specifically, 1.06 g of ethylenediamine was dissolved in 18 mL of pure water to prepare the amine compound solution.

(d) Preparation of Additional Raw material Liquid

An additional raw material liquid containing nickel sulfate hexahydrate (water-soluble nickel salt) and water was prepared. In this process, nickel sulfate hexahydrate was weighed out such that an amount of magnetic metal (Ni) in the obtained additional raw material liquid was 0.0616 mol, which was 0.035 times the total amount of 1.760 mol of the magnetic metals (Fe and Ni) in the metal salt raw material solution. Specifically, 16.2 g of nickel sulfate hexahydrate was dissolved in 200 mL of pure water to prepare the additional raw material liquid.

### (e) Preparation of Reaction Liquid and Precipitation of Crystallized Powder

The prepared reducing agent solution was placed in a Teflon (registered trademark)-coated stainless steel vessel (reaction tank) equipped with agitation blades disposed in a water bath, and heated while agitated such that the liquid temperature was 80° C. Then, the metal salt raw material solution at 25° C. was added and mixed into the reducing agent solution that had been heated in the water bath for a mixing time of 10 seconds to obtain a reaction liquid at 75° C. A concentration of the magnetic metals (Fe and Ni) in the reaction liquid was 29.1 g/L. Thereby, a reduction reaction (crystallization reaction) was started (reaction starting temperature: 75° C.). The temperature of the reaction liquid continued to rise by the heating with the water bath from the start of the reaction, and, 10 minutes after the start of the reaction, the liquid temperature was maintained at 80° C. (reaction maintaining temperature: 80° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂) and nickel hydroxide (Ni(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel crystallized powder was precipitated in the reaction liquid. From 25 minutes after the start of the reaction to 35 minutes later, the additional raw material liquid was added and mixed dropwise into the reaction liquid little by little to enhance reduction of iron ions (or iron hydroxide) that are difficult to reduce, meanwhile the reduction reaction was proceeded so that the surface of the precipitated iron-nickel crystallized powder became richer in nickel. A concentration of the magnetic metals (Fe and Ni) in the reaction liquid after addition of the additional raw material liquid was 28.4 g/L. At this time, the color tone of the reaction liquid was black, but a supernatant of the reaction liquid became transparent within 40 minutes from the start of the reaction. This may be because all of the iron and nickel components in the reaction liquid were reduced into metallic iron and metallic nickel after the reduction reaction was thoroughly completed. The reaction liquid after completion of the reaction was a slurry containing an iron-nickel crystallized powder.

### <Recovery Step>

The slurry reaction liquid obtained in the crystallization step was subjected to filtration washing and solid-liquid separation to recover a cake-like iron-nickel crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, the iron-nickel alloy powder was obtained. The obtained alloy powder was composed of spherical particles with a smooth surface. The alloy powder had a sharp particle size distribution and an average particle diameter of 0.39 μm.

### Example 10

In Example 10, an iron-nickel alloy powder having a composition with a high iron content and containing 80 mol % of iron (Fe), 20 mol % of nickel (Ni) (iron-nickel alloy powder) was produced according to the procedure illustrated in FIG. 6. In this process, an additional raw material liquid was added and mixed into the reaction liquid during the crystallization step. Specifically, a metal salt raw material solution at normal temperature was added and mixed into a reducing solution heated using a water bath to prepare a reaction liquid. First, crystallization of the iron-nickel alloy powder containing 83.3 mol % of iron (Fe) and 16.7 mol % of nickel (Ni) (iron-nickel alloy powder) was proceeded. During the crystallization, a water-soluble nickel salt aqueous solution as an additional raw material liquid was added and mixed into the reaction liquid.

### <Preparation Step>

The same raw materials as in Example 4 were prepared as a water-soluble iron salt, a water-soluble nickel salt, a nucleating agent, a reducing agent, a pH adjusting agent, a complexing agent, and an amine compound.

### <Crystallization Step>

(a) Preparation of metal Salt Raw Material Solution

A metal salt raw material solution containing ferrous sulfate heptahydrate (water-soluble iron salt), nickel sulfate hexahydrate (water-soluble nickel salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe and Ni) was 0.79 ppm by mass (0.42 mol ppm) in the obtained metal salt raw material solution. In addition, the weighing was carried out such that the molar ratio of trisodium citrate dihydrate to the total amount of the magnetic metals (Fe and Ni) was 0.754 (75.4 mol %). Specifically, ferrous sulfate heptahydrate: 394.3 g, nickel sulfate hexahydrate: 74.6 g, ammonium palladium (II) chloride: 201.6 μg, and trisodium citrate dihydrate: 377.5 g were dissolved in pure water: 836 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe and Ni) at the time of starting the reaction was 9.40 (the molar ratio of hydrazine to the total amount of the magnetic metals (Fe and Ni) at the time of adding the additional raw material liquid was 9.02) in a reaction liquid to be prepared in the subsequent crystallization step. In addition, the weighing was carried out such that the molar ratio of sodium hydroxide to the total amount of the magnetic metals (Fe and Ni) at the time of starting the reaction was 7.37 (the molar ratio of sodium hydroxide to the total amount of the magnetic metals (Fe and Ni) at the time of adding the additional raw material liquid was 7.07). Specifically, 501.3 g of sodium hydroxide was dissolved in 1228 mL of pure water to prepare a sodium hydroxide solution, and 1334 g of 60 mass %-water-holding hydrazine was added and mixed into this sodium hydroxide solution to prepare the reducing agent solution.

### (c) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe and Ni) after addition of the additional raw material liquid was as low as 0.01 (1.0 mol %) in a reaction liquid in the subsequent crystallization step. Specifically, 1.07 g of ethylenediamine was dissolved in 18 mL of pure water to prepare the amine compound solution.

(d) Preparation of Additional Raw material Liquid

An additional raw material liquid containing nickel sulfate hexahydrate (water-soluble nickel salt) and water was prepared. In this process, nickel sulfate hexahydrate was weighed out such that an amount of the magnetic metal (Ni) in the obtained additional raw material liquid was 0.0709 mol, which was 0.04 times the total amount of 1.773 mol of the magnetic metals (Fe and Ni) in the metal salt raw material solution. Specifically, 18.64 g of nickel sulfate hexahydrate was dissolved in 200 mL of pure water to prepare the additional raw material liquid.

### (e) Preparation of Reaction Liquid and Precipitation of Crystallized Powder

The prepared reducing agent solution was placed in a Teflon (registered trademark)-coated stainless steel vessel (reaction tank) equipped with agitation blades disposed in a water bath, and heated while agitated such that the liquid temperature was 80° C. Then, the metal salt raw material solution at 25° C. was added and mixed into the reducing agent solution that had been heated in the water bath for a mixing time of 10 seconds to obtain a reaction liquid at 71° C. A concentration of the magnetic metals (Fe and Ni) in the reaction liquid was 24.5 g/L. Thereby, a reduction reaction (crystallization reaction) was started (reaction starting temperature: 71° C.). The temperature of the reaction liquid continued to rise by the heating with the water bath from the start of the reaction, and, 10 minutes after the start of the reaction, the liquid temperature was maintained at 80° C. (reaction maintaining temperature: 80° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂) and nickel hydroxide (Ni(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel crystallized powder was precipitated in the reaction liquid. From 8 minutes after the start of the reaction to 18 minutes later, the additional raw material liquid was added and mixed dropwise into the reaction liquid little by little to enhance reduction of iron ions (or iron hydroxide) that are difficult to reduce, meanwhile the reduction reaction was proceeded so that the surface of the precipitated iron-nickel crystallized powder became richer in nickel. A concentration of the magnetic metals (Fe and Ni) in the reaction liquid after addition of the additional raw material liquid was 24.2 g/L. At this time, the color tone of the reaction liquid was black, but a supernatant of the reaction liquid became transparent within 60 minutes from the start of the reaction. This may be because all of the iron and nickel components in the reaction liquid were reduced into metallic iron and metallic nickel after the reduction reaction was thoroughly completed. The reaction liquid after completion of the reaction was a slurry containing an iron-nickel crystallized powder.

### <Recovery Step>

The slurry reaction liquid obtained in the crystallization step was subjected to filtration washing and solid-liquid separation to recover a cake-like iron-nickel crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, the iron-nickel alloy powder was obtained. The obtained alloy powder was composed of spherical particles with a smooth surface. The alloy powder had a sharp particle size distribution and an average particle diameter of 0.48 μm.

### Example 11

In Example 11, an iron-nickel alloy powder having a composition with a high iron content and containing 90 mol % of iron (Fe), 10 mol % of nickel (Ni) (iron-nickel alloy powder) was produced according to the procedure illustrated in FIG. 6. In this process, an additional raw material liquid was added and mixed into the reaction liquid during the crystallization step. Specifically, a metal salt raw material solution at normal temperature was added and mixed into a reducing solution heated using a water bath to prepare a reaction liquid. First, crystallization of the iron-nickel alloy powder containing 91.8 mol % of iron (Fe) and 8.2 mol % of nickel (Ni) (iron-nickel alloy powder) was proceeded. During the crystallization, a water-soluble nickel salt aqueous solution as an additional raw material liquid was added and mixed into the reaction liquid.

### <Preparation Step>

The same raw materials as in Example 4 were prepared as a water-soluble iron salt, a water-soluble nickel salt, a nucleating agent, a reducing agent, a pH adjusting agent, a complexing agent, and an amine compound.

### <Crystallization Step>

### (a) Preparation of Metal Salt Raw Material Solution

A metal salt raw material solution containing ferrous sulfate heptahydrate (water-soluble iron salt), nickel sulfate hexahydrate (water-soluble nickel salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe and Ni) was 0.77 ppm by mass (0.41 mol ppm) in the obtained metal salt raw material solution. In addition, the weighing was carried out such that the molar ratio of trisodium citrate dihydrate to the total amount of the magnetic metals (Fe and Ni) was 0.369 (36.9 mol %). Specifically, ferrous sulfate heptahydrate: 446.0 g, nickel sulfate hexahydrate: 37.5 g, ammonium palladium (II) chloride: 202.6 μg, and trisodium citrate dihydrate: 189.7 g were dissolved in pure water: 720 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe and Ni) at the time of starting the reaction was 9.15 (the molar ratio of hydrazine to the total amount of the magnetic metals (Fe and Ni) at the time of adding the additional raw material liquid was 8.97) in a reaction liquid to be prepared in the subsequent crystallization step. In addition, the weighing was carried out such that the molar ratio of sodium hydroxide to the total amount of the magnetic metals (Fe and Ni) at the time of starting the reaction was 8.29 (the molar ratio of sodium hydroxide to the total amount of the magnetic metals (Fe and Ni) at the time of adding the additional raw material liquid was 8.13). Specifically, 579 g of sodium hydroxide was dissolved in 1418 mL of pure water to prepare a sodium hydroxide solution, and 1334 g of 60 mass %-water-holding hydrazine was added and mixed into this sodium hydroxide solution to prepare the reducing agent solution.

### (c) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe and Ni) was as low as 0.01 (1.0 mol %) in a reaction liquid in the subsequent crystallization step. Specifically, 1.07 g of ethylenediamine was dissolved in 18 mL of pure water to prepare the amine compound solution.

(d) Preparation of Additional Raw material Liquid

An additional raw material liquid containing nickel sulfate hexahydrate (water-soluble nickel salt) and water was prepared. In this process, nickel sulfate hexahydrate was weighed out such that an amount of the magnetic metal (Ni) in the obtained additional raw material liquid was 0.0356 mol, which was 0.02 times the total amount of 1.747 mol of the magnetic metals (Fe and Ni) in the metal salt raw material solution. Specifically, 9.37 g of nickel sulfate hexahydrate was dissolved in 100 mL of pure water to prepare the additional raw material liquid.

### (e) Preparation of Reaction Liquid and Precipitation of Crystallized Powder

The prepared reducing agent solution was placed in a Teflon (registered trademark)-coated stainless steel vessel (reaction tank) equipped with agitation blades disposed in a water bath, and heated while agitated such that the temperature was 85° C. Then, the metal salt raw material solution at 25° C. was added and mixed into the reducing agent solution that had been heated in the water bath for a mixing time of 10 seconds to obtain a reaction liquid at 78° C. A concentration of the magnetic metals (Fe and Ni) in the reaction liquid was 25.0 g/L. Thereby, a reduction reaction (crystallization reaction) was started (reaction starting temperature: 78° C.). The temperature of the reaction liquid continued to rise by the heating with the water bath from the start of the reaction, and, 10 minutes after the start of the reaction, the liquid temperature was maintained at 85° C. (reaction maintaining temperature: 85° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂) and nickel hydroxide (Ni(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel crystallized powder was precipitated in the reaction liquid. From 8 minutes after the start of the reaction to 18 minutes later, the additional raw material liquid was added and mixed dropwise into the reaction liquid little by little to enhance reduction of iron ions (or iron hydroxide) that are difficult to reduce, meanwhile the reduction reaction was proceeded so that the surface of the precipitated iron-nickel crystallized powder became richer in nickel. A concentration of the magnetic metals (Fe and Ni) in the reaction liquid after addition of the additional raw material liquid was 24.8 g/L. At this time, the color tone of the reaction liquid was black, but a supernatant of the reaction liquid became transparent within 50 minutes from the start of the reaction. This may be because all of the iron and nickel components in the reaction liquid were reduced into metallic iron and metallic nickel after the reduction reaction was thoroughly completed. The reaction liquid after completion of the reaction was a slurry containing an iron-nickel crystallized powder.

### <Recovery Step>

The slurry reaction liquid obtained in the crystallization step was subjected to filtration washing and solid-liquid separation to recover a cake-like iron-nickel crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, the iron-nickel alloy powder was obtained. The obtained alloy powder was composed of spherical particles with a smooth surface. The alloy powder had a sharp particle size distribution and an average particle diameter of 0.38 μm.

### Example 12

In Example 12, the crystallized powder obtained according to the procedure illustrated in FIG. 5 was subjected to an insulative coating treatment to produce an iron-nickel alloy powder coated with silicon dioxide (SiO₂) as an insulative metal oxide and containing 55 mol % of iron (Fe) and 45 mol % of nickel (Ni) (iron-nickel alloy powder). In Example 12, when preparing a reaction liquid, a metal salt raw material solution at normal temperature was added and mixed into a reducing solution heated using a water bath.

### <Preparation Step>

The same raw materials as in Example 4 were prepared as a water-soluble iron salt, a water-soluble nickel salt, a nucleating agent, a reducing agent, a pH adjusting agent, a complexing agent, and an amine compound.

### <Crystallization Step>

(a) Preparation of metal Salt Raw Material Solution

A metal salt raw material solution containing ferrous sulfate heptahydrate (water-soluble iron salt), nickel sulfate hexahydrate (water-soluble nickel salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe and Ni) was 0.56 ppm by mass (0.3 mol ppm) in the obtained metal salt raw material solution. In addition, the weighing was carried out such that the molar ratio of trisodium citrate dihydrate to the total amount of the magnetic metals (Fe and Ni) was 0.543 (54.3 mol %). Specifically, ferrous sulfate heptahydrate: 267.7 g, nickel sulfate hexahydrate: 207.1 g, ammonium palladium (II) chloride: 149.3 μg, and trisodium citrate dihydrate: 279.6 g were dissolved in pure water: 950 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe and Ni) was 4.85 in a reaction liquid to be prepared in the subsequent crystallization step. In addition, the weighing was carried out such that the molar ratio of sodium hydroxide to the total amount of the magnetic metals (Fe and Ni) was 4.95. Specifically, 346 g of sodium hydroxide was dissolved in 848 mL of pure water to prepare a sodium hydroxide solution, and 709 g of 60 mass %-water-holding hydrazine was added and mixed into this sodium hydroxide solution to prepare the reducing agent solution.

### (c) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe and Ni) after addition of the additional raw material liquid was as low as 0.01 (1.0 mol %) in a reaction liquid in the subsequent crystallization step. Specifically, 1.05 g of ethylenediamine was dissolved in 18 mL of pure water to prepare the amine compound solution.

### (d) Preparation of Reaction Liquid and Precipitation of Crystallized Powder

The prepared reducing agent solution was placed in a Teflon (registered trademark)-coated stainless steel vessel (reaction tank) equipped with agitation blades disposed in a water bath, and heated while agitated such that the liquid temperature was 70° C. Then, the metal salt raw material solution at 25° C. was added and mixed into the reducing agent solution that had been heated in the water bath for a mixing time of 10 seconds to obtain a reaction liquid at 59° C. A concentration of the magnetic metals (Fe and Ni) in the reaction liquid was 33.9 g/L. Thereby, a reduction reaction (crystallization reaction) was started (reaction starting temperature: 59° C.). The temperature of the reaction liquid continued to rise by the heating with the water bath from the start of the reaction, and, 10 minutes after the start of the reaction, the liquid temperature was maintained at 70° C. (reaction maintaining temperature: 70° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂) and nickel hydroxide (Ni(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel crystallized powder was precipitated in the reaction liquid. At this time, the color tone of the reaction liquid was black, but a supernatant of the reaction liquid became transparent within 30 minutes from the start of the reaction. This may be because all of the iron and nickel components in the reaction liquid were reduced into metallic iron and metallic nickel after the reduction reaction according to Eq. (6) above was completed. The reaction liquid after completion of the reaction was a slurry containing an iron-nickel crystallized powder.

### <Recovery Step>

The slurry reaction liquid obtained in the crystallization step was subjected to filtration washing and solid-liquid separation to recover a cake-like iron-nickel crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, a crystallized powder (iron-nickel alloy powder) was obtained as a dry powder. The obtained crystallized powder (alloy powder) was composed of spherical particles with a smooth surface. The alloy powder had a sharp particle size distribution and an average particle diameter of 0.39 μm.

### <Insulative Coating Step>

Into a sealed polypropylene container, 50.0 g of the crystallized powder (alloy powder) obtained in the above recovery step was placed, to which 7.0 g of pure water and 50.0 g of ethyl alcohol (C₂H₅₀H, molecular weight: 46.07, a reagent manufactured by Wako Pure Chemical Industries, Ltd.) were further added. The crystallized powder (alloy powder) was dispersed in a mixed solvent of water and ethyl alcohol, to which 9.8 g of tetraethoxysilane (another name: tetraethyl ortho silicate, tetraethyl silicate) (abbreviation: TEOS) (Si(OC₂H₅)₄, molecular weight: 208.33, a reagent manufactured by Wako Pure Chemical Industry Co., Ltd.) as a silicon alkoxide was added and mixed thoroughly, to which 2.4 g of 1 mass %-ammonia water as a base catalyst (alkali catalyst) for hydrolysis of silicon alkoxide was further added while agitated to prepare a homogeneous slurry. The aforementioned 1 mass %-ammonia water was a reagent 28-30 mass %-ammonia water (NH₃, molecular weight: 17.03, a reagent manufactured by Wako Pure Chemical Industries, Ltd.) diluted with pure water. The crystallized powder (alloy powder), water, ethyl alcohol, tetraethoxysilane, and 1 mass %-ammonia water were all used at room temperature. Also, additions and mixing are all carried out at room temperature.

The slurry containing the crystallized powder (alloy powder), water, ethyl alcohol, tetraethoxysilane, and ammonia was maintained in a rotating polypropylene sealed container at 40° C. for 2 days. Hydrolysis and dehydration-condensation polymerization of tetraethoxysilane are proceeded while agitating the slurry, so that an insulative coat layer composed mainly of hydrolyzed polymer of tetraethoxysilane (with a composition containing a small amount of silanol groups (Si—OH) but composed substantially mainly of silicon dioxide (SiO₂)) was formed on the particle surface of the crystallized powder (alloy powder). Then, the slurry was subjected to filtration washing and solid-liquid separation to recover a cake-like crystallized powder (alloy powder). For the filtration washing was carried out using, first, ethanol containing 50% pure water by mass, and then using ethanol. The hydrolyzed polymer of tetraethoxysilane that has not been consumed by the insulative coat on the particle surface of the crystallized powder (alloy powder) and remains in the slurry is a particle (silica sol) with a very small molecular weight, which is removed as a filtrate during the filtration washing and therefore does not remain in the recovered cake-like crystallized powder (alloy powder).

The recovered cake-like crystallized powder (alloy powder) was dried at 50° C. in a vacuum dryer, followed by heating treatment under vacuum at 150° C. for 2 hours. By this heating treatment, the hydrolyzed polymer of tetraethoxysilane constituting the insulative coat layer was further progressively dehydration-condensation polymerized to become a harder and denser silicon dioxide (SiO₂), so that the insulating property of the insulative coat layer was further improved. This insulative coating treatment resulted in an iron-nickel alloy powder having a particle surface with an insulative coat layer composed of highly resistive silicon dioxide (SiO₂). The obtained alloy powder was composed of spherical particles with a smooth surface. The alloy powder had a sharp particle size distribution and an average particle diameter of 0.42 μm. The thickness of the insulative coat layer was estimated to be about 0.015 μm (about 15 nm). Also, the insulative coating treatment significantly increased the green compact resistivity (applied pressure: 64 MPa) from 0.04 Ω·cm before the insulative coating treatment to over a measurement range (>10⁷ Ω·cm).

### Example 13

In Example 13, an iron-nickel alloy powder containing 80 mol % of iron (Fe), 10 mol % of nickel (Ni), and 10 mol % of cobalt (Co) (iron-nickel-cobalt alloy powder) was produced according to the procedure illustrated in FIG. 5. In Example 13, when preparing the reaction liquid, a metal salt raw material solution at normal temperature was added and mixed into a reducing solution heated using a water bath.

### <Preparation Step>

The same raw materials as in Example 4 were prepared as a water-soluble iron salt, a water-soluble nickel salt, a nucleating agent, a complexing agent, a reducing agent, a pH adjusting agent, and an amine compound. Besides, cobalt sulfate heptahydrate (CoSO₄·7H₂O, molecular weight: 281.103, a reagent manufactured by Wako Pure Chemical Industries, Ltd.) was prepared as a water-soluble cobalt salt.

### <Crystallization Step>

(a) Preparation of metal Salt Raw Material Solution

A metal salt raw material solution containing ferrous sulfate heptahydrate (water-soluble iron salt), nickel sulfate hexahydrate (water-soluble nickel salt), cobalt sulfate heptahydrate (water-soluble cobalt salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe, Ni, and Co) was 0.38 ppm by mass (0.2 mol ppm) in the obtained metal salt raw material solution. In addition, the weighing was carried out such that the molar ratio of trisodium citrate to the total amount of the magnetic metals (Fe, Ni, and Co) was 0.362 (36.2 mol %). Specifically, ferrous sulfate heptahydrate: 394.1 g, nickel sulfate hexahydrate: 46.6 g, cobalt sulfate heptahydrate: 49.8 g, ammonium palladium (II) chloride: 100.8 μg, and trisodium citrate dihydrate: 188.7 g were dissolved in pure water: 1000 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe, Ni, and Co) was 3.65 in a reaction liquid to be prepared in the subsequent crystallization step. In addition, the weighing was carried out such that the molar ratio of sodium hydroxide to the total amount of the magnetic metals (Fe, Ni, and Co) was 7.07. Specifically, 501 g of sodium hydroxide was dissolved in 1227 mL of pure water to prepare a sodium hydroxide solution, and 540 g of 60 mass %-water-holding hydrazine was added and mixed into this sodium hydroxide solution to prepare the reducing agent solution.

### (d) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe, Ni, and Co) was as low as 0.01 (1.0 mol %) in a reaction liquid to be prepared in the subsequent crystallization step. Specifically, 1.07 g of ethylenediamine was dissolved in 18 mL of pure water to prepare the amine compound solution.

### (e) Preparation of Reaction Liquid and Precipitation of Crystallized Powder

The prepared metal salt raw material solution was placed in a Teflon (registered trademark)-coated stainless steel vessel (reaction tank) equipped with agitation blades disposed in a water bath, and heated while agitated such that the liquid temperature was 85° C. Then, the metal salt raw material solution at 25° C. was added and mixed into the reducing agent solution that had been heated in the water bath for a mixing time of 10 seconds to obtain a reaction liquid at 70° C. A concentration of the magnetic metals (Fe, Ni, and Co) in the reaction liquid was 31.2 g/L. Thereby, a reduction reaction (crystallization reaction) was started (reaction starting temperature: 70° C.). The temperature of the reaction liquid continued to rise by the heating with the water bath from the start of the reaction, and, 10 minutes after the start of the reaction, the liquid temperature was maintained at 85° C. (reaction maintaining temperature: 85° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂), nickel hydroxide (Ni(OH)₂), and cobalt hydroxide (Co(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel-cobalt crystallized powder was precipitated in the reaction liquid. At this time, the color tone of the reaction liquid was black, but a supernatant of the reaction liquid became transparent within 40 minutes from the start of the reaction. This may be because all of the iron, nickel, and cobalt components in the reaction liquid were reduced into metallic iron, metallic nickel, and metallic cobalt after the reduction reaction according to Eq. (6) above was completed. The reaction liquid after completion of the reaction was a slurry containing an iron-nickel-cobalt crystallized powder.

### <Recovery Step>

The slurry reaction liquid obtained in the crystallization step was subjected to filtration washing and solid-liquid separation to recover a cake-like iron-nickel-cobalt crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, the iron-nickel-cobalt alloy powder was obtained. The obtained alloy powder was composed of spherical particles with a smooth surface. The alloy powder had a sharp particle size distribution and an average particle diameter of 0.42 μm.

### Example 14

In Example 14, an iron-nickel alloy powder containing 70 mol % of iron (Fe), 10 mol % of nickel (Ni), and 20 mol % of cobalt (Co) (iron-nickel-cobalt alloy powder) was produced according to the procedure illustrated in FIG. 5. In Example 14, when preparing the reaction liquid, a metal salt raw material solution at normal temperature was added and mixed into a reducing solution heated using a water bath.

### <Preparation Step>

The same raw materials as in Example 13 were prepared as a water-soluble iron salt, a water-soluble nickel salt, a water-soluble cobalt salt, a nucleating agent, a complexing agent, a reducing agent, a pH adjusting agent, and an amine compound.

### <Crystallization Step>

(a) Preparation of metal Salt Raw Material Solution

A metal salt raw material solution containing ferrous sulfate heptahydrate (water-soluble iron salt), nickel sulfate hexahydrate (water-soluble nickel salt), cobalt sulfate heptahydrate (water-soluble cobalt salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe, Ni, and Co) was 0.38 ppm by mass (0.2 mol ppm) in the obtained metal salt raw material solution. In addition, the weighing was carried out such that the molar ratio of trisodium citrate to the total amount of the magnetic metals (Fe, Ni, and Co) was 0.362 (36.2 mol %). Specifically, ferrous sulfate heptahydrate: 343.0 g, nickel sulfate hexahydrate: 46.3 g, cobalt sulfate heptahydrate: 99.1 g, ammonium palladium (II) chloride: 100.2 μg, and trisodium citrate dihydrate: 187.6 g were dissolved in pure water: 1100 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe, Ni, and Co) was 1.46 in a reaction liquid to be prepared in the subsequent crystallization step. In addition, the weighing was carried out such that the molar ratio of sodium hydroxide to the total amount of the magnetic metals (Fe, Ni, and Co) was 7.07. Specifically, 499 g of sodium hydroxide was dissolved in 1221 mL of pure water to prepare a sodium hydroxide solution, and 215 g of 60 mass %-water-holding hydrazine was added and mixed into this sodium hydroxide solution to prepare the reducing agent solution.

### (d) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe, Ni, and Co) was as low as 0.01 (1.0 mol %) in a reaction liquid to be prepared in the subsequent crystallization step. Specifically, 1.06 g of ethylenediamine was dissolved in 18 mL of pure water to prepare the amine compound solution.

### (e) Preparation of Reaction Liquid and Precipitation of Crystallized Powder

The prepared metal salt raw material solution was placed in a Teflon (registered trademark)-coated stainless steel vessel (reaction tank) equipped with agitation blades disposed in a water bath, and heated while agitated such that the liquid temperature was 85° C. Then, the metal salt raw material solution at 25° C. was added and mixed into the reducing agent solution that had been heated in the water bath for a mixing time of 10 seconds to obtain a reaction liquid at 67° C. A concentration of the magnetic metals (Fe, Ni, and Co) in the reaction liquid was 33.7 g/L. Thereby, a reduction reaction (crystallization reaction) was started (reaction starting temperature: 67° C.). The temperature of the reaction liquid continued to rise by the heating with the water bath from the start of the reaction, and, 10 minutes after the start of the reaction, the liquid temperature was maintained at 85° C. (reaction maintaining temperature: 85° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂), nickel hydroxide (Ni(OH)₂), and cobalt hydroxide (Co(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel-cobalt crystallized powder was precipitated in the reaction liquid. At this time, the color tone of the reaction liquid was black, but a supernatant of the reaction liquid became transparent within 40 minutes from the start of the reaction. This may be because all of the iron, nickel, and cobalt components in the reaction liquid were reduced into metallic iron, metallic nickel, and metallic cobalt after the reduction reaction according to the Eq. (6) above was completed. The reaction liquid after completion of the reaction was a slurry containing an iron-nickel-cobalt crystallized powder.

### <Recovery Step>

The slurry reaction liquid obtained in the crystallization step was subjected to filtration washing and solid-liquid separation to recover a cake-like iron-nickel-cobalt crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, the iron-nickel-cobalt alloy powder was obtained. The obtained alloy powder was composed of spherical particles with a smooth surface. The alloy powder had a sharp particle size distribution and an average particle diameter of 0.40 μm.

### Example 15

In Example 15, an iron-nickel alloy powder containing 65 mol % of iron (Fe), 10 mol % of nickel (Ni), and 25 mol % of cobalt (Co) (iron-nickel-cobalt alloy powder) was produced according to the procedure illustrated in FIG. 5. In Example 15, when preparing the reaction liquid, a metal salt raw material solution at normal temperature was added and mixed into a reducing solution heated using a water bath.

### <Preparation Step>

The same raw materials as in Example 13 were prepared as a water-soluble iron salt, a water-soluble nickel salt, a water-soluble cobalt salt, a nucleating agent, a complexing agent, a reducing agent, a pH adjusting agent, and an amine compound.

### <Crystallization Step>

(a) Preparation of metal Salt Raw Material Solution

A metal salt raw material solution containing ferrous sulfate heptahydrate (water-soluble iron salt), nickel sulfate hexahydrate (water-soluble nickel salt), cobalt sulfate heptahydrate (water-soluble cobalt salt), ammonium palladium (II) chloride (nucleating agent), trisodium citrate dihydrate (complexing agent), and water was prepared. In this process, the components were weighed out such that an amount of palladium (Pd) based on the total amount of the magnetic metals (Fe, Ni, and Co) was 0.37 ppm by mass (0.2 mol ppm) in the obtained metal salt raw material solution. In addition, the weighing was carried out such that the molar ratio of trisodium citrate to the total amount of the magnetic metals (Fe, Ni, and Co) was 0.362 (36.2 mol %). Specifically, ferrous sulfate heptahydrate: 317.6 g, nickel sulfate hexahydrate: 46.2 g, cobalt sulfate heptahydrate: 123.5 g, ammonium palladium (II) chloride: 100.0 μg, and trisodium citrate dihydrate: 187.1 g were dissolved in pure water: 1100 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe, Ni, and Co) was 1.47 in a reaction liquid to be prepared in the subsequent crystallization step. In addition, the weighing was carried out such that the molar ratio of sodium hydroxide to the total amount of the magnetic metals (Fe, Ni, and Co) was 7.07. Specifically, 497 g of sodium hydroxide was dissolved in 1216 mL of pure water to prepare a sodium hydroxide solution, and 215 g of 60 mass %-water-holding hydrazine was added and mixed into this sodium hydroxide solution to prepare the reducing agent solution.

### (d) Preparation of Amine Compound Solution

An amine compound solution containing ethylenediamine (amine compound) and water was prepared. In this process, ethylenediamine was weighed out such that the molar ratio of ethylenediamine to the total amount of the magnetic metals (Fe, Ni, and Co) was as low as 0.01 (1.0 mol %) in a reaction liquid to be prepared in the subsequent crystallization step. Specifically, 1.06 g of ethylenediamine was dissolved in 18 mL of pure water to prepare the amine compound solution.

### (e) Preparation of Reaction Liquid and Precipitation of Crystallized Powder

The prepared metal salt raw material solution was placed in a Teflon (registered trademark)-coated stainless steel vessel (reaction tank) equipped with agitation blades disposed in a water bath, and heated while agitated such that the liquid temperature was 85° C. Then, the metal salt raw material solution at 25° C. was added and mixed into the reducing agent solution that had been heated in the water bath for a mixing time of 10 seconds to obtain a reaction liquid at 67° C. A concentration of the magnetic metals (Fe, Ni, and Co) in the reaction liquid was 33.7 g/L. Thereby, a reduction reaction (crystallization reaction) was started (reaction starting temperature: 67° C.). The temperature of the reaction liquid continued to rise by the heating with the water bath from the start of the reaction, and, 10 minutes after the start of the reaction, the liquid temperature was maintained at 85° C. (reaction maintaining temperature: 85° C.). A color tone of the reaction liquid was dark green immediately after the start of the reaction (reaction liquid preparation), but changed to dark gray a few minutes later. The reason why the color tone was dark green immediately after the start of the reaction may be because a coprecipitate of iron hydroxide (Fe(OH)₂), nickel hydroxide (Ni(OH)₂), and cobalt hydroxide (Co(OH)₂) was formed in the reaction liquid as the reaction according to Eq. (6) above proceeded. In addition, the reason why the color tone changed to dark gray a few minutes after the start of the reaction may be because nucleation occurred by the action of the nucleating agent (palladium salt).

For 10 minutes from 3 minutes after the start of the reaction to 13 minutes later, while which the color tone of the reaction liquid changed to dark gray, the amine compound solution was mixed dropwise into the reaction liquid to proceed the reduction reaction. Thereby, an iron-nickel-cobalt crystallized powder was precipitated in the reaction liquid. At this time, the color tone of the reaction liquid was black, but a supernatant of the reaction liquid became transparent within 30 minutes from the start of the reaction. This may be because all of the iron, nickel, and cobalt components in the reaction liquid were reduced into metallic iron, metallic nickel, and metallic cobalt after the reduction reaction according to Eq. (6) above was completed. The reaction liquid after completion of the reaction was a slurry containing an iron-nickel-cobalt crystallized powder.

### <Recovery Step>

The slurry reaction liquid obtained in the crystallization step was subjected to filtration washing and solid-liquid separation to recover a cake-like iron-nickel-cobalt crystallized powder. The filtration washing was carried out using pure water with an electrical conductivity of 1 μS/cm until an electrical conductivity of a filtrate filtered from the slurry was 10 μS/cm or lower. The recovered cake-like crystallized powder was dried in a vacuum dryer set at 50° C. Subsequently, the dried crystallized powder was cooled to 35° C. under vacuum, and then the crystallized powder was subjected to a slow oxidation treatment by feeding nitrogen gas containing 1.0% oxygen by volume. As described above, the iron-nickel-cobalt alloy powder was obtained. The obtained alloy powder was composed of spherical particles with a smooth surface. The alloy powder had a sharp particle size distribution and an average particle diameter of 0.42 μm.

### Comparative Example 1

In Comparative Example 1, ammonium palladium (II) chloride (nucleating agent) was not compounded when preparing the metal salt raw material solution. However, otherwise, the preparation of the reaction liquid and the precipitation of the crystallized powder were carried out in the same manner as in Example 1 to produce an iron-nickel alloy powder containing 50 mol % of iron (Fe) and 50 mol % of nickel (Ni) (iron-nickel alloy powder). A concentration of the magnetic metals (Fe and Ni) in the reaction liquid was 32.3 g/L. The obtained alloy powder was composed of spherical particles having an irregular surface. The alloy powder had a sharp particle size distribution and an average particle diameter of 0.65 μm.

### Comparative Example 2

In Comparative Example 2, trisodium citrate dihydrate (complexing agent) was not compounded when preparing the metal salt raw material solution. However, otherwise, the preparation of the reaction liquid and the precipitation of the crystallized powder were carried out in the same manner as in Example 1 to produce an iron-nickel alloy powder containing 50 mol % of iron (Fe) and 50 mol % of nickel (Ni) (iron-nickel alloy powder). A concentration of the magnetic metals (Fe and Ni) in the reaction liquid was 33.3 g/L. The obtained alloy powder was composed of distorted particles having an irregular surface. The alloy powder had a broad particle size distribution, and an average particle diameter of 0.26 μm.

### Comparative Example 3

In Comparative Example 3, ammonium palladium (II) chloride (nucleating agent) and trisodium citrate dihydrate (complexing agent) were not compounded when preparing the metal salt raw material solution. In addition, a large amount of hydrazine (reducing agent) was compounded when preparing the reducing agent solution. However, otherwise, the alloy powder based on iron and nickel (iron-nickel alloy powder) was produced in the same manner as in Example 1. The metal salt raw material solution and the reducing agent solution were prepared as below.

(a) Preparation of metal Salt Raw Material Solution

A metal salt raw material solution containing ferrous chloride tetrahydrate (water-soluble iron salt), nickel chloride hexahydrate (water-soluble nickel salt), and water was prepared. Specifically, ferrous chloride tetrahydrate: 173.60 g, nickel chloride hexahydrate: 207.55 g were dissolved in pure water: 1200 mL to prepare the metal salt raw material solution.

### (b) Preparation of Reducing Agent Solution

A reducing agent solution containing sodium hydroxide (pH adjusting agent), hydrazine (reducing agent), and water was prepared. In this process, the components were weighed out such that the molar ratio of hydrazine to the total amount of the magnetic metals (Fe and Ni) was 19.4 in a reaction liquid to be prepared in the subsequent crystallization step. In addition, the weighing was carried out such that the molar ratio of sodium hydroxide to the amount of the magnetic metals (Fe and Ni) was 4.96. Specifically, 346 g of sodium hydroxide was dissolved in 850 mL of pure water to prepare a sodium hydroxide solution, and 2828 g of 60 mass %-water-holding hydrazine was added and mixed into this sodium hydroxide solution to prepare the reducing agent solution. The reducing agent solution was used after heated to 37° C. such that the reaction starting temperature was 55° C. when the reducing agent solution was added and mixed into the metal salt raw material solution.

The obtained alloy powder was composed of spherical particles with a relatively smooth surface. The alloy powder had a broad particle size distribution and an average particle diameter of 0.22 μm.

Manufacture conditions of the alloy powders in Examples 1 to 15 and Comparative Examples 1 to 3 described above are summarized in Table 1.

TABLE 1
Manufacture Conditions of Iron-Nickel Alloy Powder

| | | | | | | Reducing agent solution (reducing agent + pH adjusting agent), | | | | | | | | |
|---|---|---|---|---|---|---|---|---|---|---|---|---|---|---|
| | | | | | | or reducing agent solution (reducing agent) and pH adjusting | | | | | Amine compound | | | |
| | Metal salt raw material solution | | | | | solution (pH adjusting agent) | | | | | solution | | Reaction liquid | |
| | | Nucleating agent | | Complexing agent | | | Reducing agent | | pH adjusting agent | | Amine compound | | Reaction | Reaction |
| | Magnetic metal source | | Blended | | Blended | | | Blended | | Blended | | Blended | starting | maintaining |
| | Fe salt/Ni salt/Co salt | Type of | amount | | amount | Type of | | amount | | amount | | amount | temperature | temperature |
| | (Molar ratio) | metal | (mol ppm) | Substance | (mol %) | solution | Substance | (Molar ratio) | Substance | (Molar ratio) | Substance | (mol %) | (° C.) | (° C.) |
| Example1 | FeCl₂/NiCl₂/CoCl₂ = | Pd | 0.02 | Sodium | 36.2 | Reducing agent | Hydrazine | 4.85 | NaOH | 4.96 | EDA | 1.0 | 55 | 70 |
| | 50/50/0 | | | citrate | | solution | | | | | | | | |
| Example2 | FeCl₂/NiCl₂/CoCl₂ = | Pd | 0.02 | Sodium | 36.2 | Reducing agent | Hydrazine | 4.85 | NaOH | 4.96 | EDA | 1.0 | 55 | 70 |
| | 50/40/10 | | | citrate | | solution & pH | | | | | | | | |
| | | | | | | adjusting agent | | | | | | | | |
| | | | | | | solution | | | | | | | | |
| Example3 | FeCl₂/NiCl₂/CoCl₂ = | Pd | 0.02 | Tartaric | 20.0 | Reducing agent | Hydrazine | 4.85 | NaOH | 4.96 | EDA | 1.0 | 55 | 70 |
| | 50/50/0 | | | acid | | solution | | | | | | | | |
| Example4 | FeSO₄/NiSO₄/CoSO₄ = | Pd | 0.20 | Sodium | 31.8 | Reducing agent | Hydrazine | 6.41 | NaOH | 4.67 | EDA | 1.0 | 60 | 70 |
| | 56/44/0 | | | citrate | | solution | | | | | | | | |
| Example5 | [Before addition of additional | Pd | 0.20 | Sodium | 31.8 | Reducing agent | Hydrazine | 4.41 | NaOH | 4.24 | EDA | 1.0 | 59 | 70 |
| | raw material liquid] | | (Note 2) | citrate | (Note 2) | solution | | (Note 3) | | (Note 3) | | (Note 3) | | |
| | FeSO4/NiSO4/CoSO4 = | | | | | | | | | | | | | |
| | 56/44/0 | | | | | | | | | | | | | |
| | [After addition of additional | | | | | | | | | | | | | |
| | raw material liquid] | | | | | | | | | | | | | |
| | FeSO4/NiSO4/CoSO4 = | | | | | | | | | | | | | |
| | 51/49/0 | | | | | | | | | | | | | |
| Example6 | FeCl₂/NiCl₂/CoCl₂ = | Pd | 0.02 | Sodium | 36.2 | Reducing agent | Hydrazine | 4.85 | NaOH | 4.96 | EDA | 1.0 | 55 | 70 |
| | 50/50/0 | | | citrate | | solution | | | | | | | | |
| Example7 | FeCl₂/NiCl₂/CoCl₂ = | Pd | 0.02 | Sodium | 36.2 | Reducing agent | Hydrazine | 4.85 | NaOH | 4.96 | EDA | 1.0 | 55 | 70 |
| | 50/50/0 | | | citrate | | solution | | | | | | | | |
| Example8 | FeSO₄/NiSO₄/CoSO₄ = | Pd | 1.50 | Sodium | 72.4 | Reducing agent | Hydrazine | 8.98 | NaOH | 7.07 | EDA | 1.0 | 71 | 80 |
| | 65/35/0 | | | citrate | | solution | | | | | | | | |
| Example9 | [Before addition of additional | Pd | 0.52 | Sodium | 75.0 | Reducing agent | Hydrazine | 7.36 | NaOH | 7.07 | EDA | 1.0 | 75 | 80 |
| | raw material liquid] | | (Note 2) | citrate | (Note 2) | solution | | (Note 3) | | (Note 3) | | (Note 3) | | |
| | FeSO4/NiSO4/CoSO4 = | | | | | | | | | | | | | |
| | 67.4/32.6/0 | | | | | | | | | | | | | |
| | [After addition of additional | | | | | | | | | | | | | |
| | raw material liquid] | | | | | | | | | | | | | |
| | FeSO4/NiSO4/CoSO4 = | | | | | | | | | | | | | |
| | 65/35/0 | | | | | | | | | | | | | |
| Example10 | [Before addition of additional | Pd | 0.42 | Sodium | 75.4 | Reducing agent | Hydrazine | 9.02 | NaOH | 7.07 | EDA | 1.0 | 71 | 80 |
| | raw material liquid] | | (Note 2) | citrate | (Note 2) | solution | | (Note 3) | | (Note 3) | | (Note 3) | | |
| | FeSO4/NiSO4/CoSO4 = | | | | | | | | | | | | | |
| | 83.3/16.7/0 | | | | | | | | | | | | | |
| | [After addition of additional | | | | | | | | | | | | | |
| | raw material liquid] | | | | | | | | | | | | | |
| | FeSO4/NiSO4/CoSO4 = | | | | | | | | | | | | | |
| | 80/20/0 | | | | | | | | | | | | | |
| Example11 | [Before addition of additional | Pd | 0.41 | Sodium | 36.9 | Reducing agent | Hydrazine | 8.97 | NaOH | 8.13 | EDA | 1.0 | 78 | 85 |
| | raw material liquid] | | (Note 2) | citrate | (Note 2) | solution | | (Note 3) | | (Note 3) | | (Note 3) | | |
| | FeSO4/NiSO4/CoSO4 = | | | | | | | | | | | | | |
| | 91.8/8.2/0 | | | | | | | | | | | | | |
| | [After addition of additional | | | | | | | | | | | | | |
| | raw material liquid] | | | | | | | | | | | | | |
| | FeSO4/NiSO4/CoSO4 = | | | | | | | | | | | | | |
| | 90/10/0 | | | | | | | | | | | | | |
| Example12 | FeSO₄/NiSO₄/CoSO₄ = | Pd | 0.30 | Sodium | 54.3 | Reducing agent | Hydrazine | 4.85 | NaOH | 4.95 | EDA | 1.0 | 59 | 70 |
| | 55/45/0 | | | citrate | | solution | | | | | | | | |
| Example13 | FeSO₄/NiSO₄/CoSO₄ = | Pd | 0.20 | Sodium | 36.2 | Reducing agent | Hydrazine | 3.65 | NaOH | 7.07 | EDA | 1.0 | 70 | 85 |
| | 80/10/10 | | | citrate | | solution | | | | | | | | |
| Example14 | FeSO₄/NiSO₄/CoSO₄ = | Pd | 0.20 | Sodium | 36.2 | Reducing agent | Hydrazine | 1.46 | NaOH | 7.07 | EDA | 1.0 | 67 | 85 |
| | 70/10/20 | | | citrate | | solution | | | | | | | | |
| Example15 | FeSO₄/NiSO₄/CoSO₄ = | Pd | 0.20 | Sodium | 36.2 | Reducing agent | Hydrazine | 1.47 | NaOH | 7.07 | EDA | 1.0 | 67 | 85 |
| | 65/10/25 | | | citrate | | solution | | | | | | | | |
| Comparative | FeCl₂/NiCl₂/CoCl₂ = | None | None | Sodium | 36.2 | Reducing agent | Hydrazine | 4.85 | NaOH | 4.96 | EDA | 1.0 | 55 | 70 |
| Example1 | 50/50/0 | | | citrate | | solution | | | | | | | | |
| Comparative | FeCl₂/NiCl₂/CoCl₂ = | Pd | 0.02 | None | None | Reducing agent | Hydrazine | 4.85 | NaOH | 4.96 | EDA | 1.0 | 55 | 70 |
| Example2 | 50/50/0 | | | | | solution | | | | | | | | |
| Comparative | FeCl₂/NiCl₂/CoCl₂ = | None | None | None | None | Reducing agent | Hydrazine | 19.4 | NaOH | 4.96 | None | — | 55 | 70 |
| Example3 | 50/50/0 | | | | | solution | | | | | | | | |

Note 1)
The blended amounts of the nucleating agent, the complexing agent, the pH adjusting agent, and the amine compound (mol ppm, % by mol, and molar ratio) are represented by a ratio relative to the total amount of the magnetic metals (Fe, Ni, and Co).
(Note 2)
The blended amount with respect to the crystallization reaction before addition of the additional raw material liquid.
(Note 3)
The blended amount with respect to the crystallization reaction including the additional raw material liquid.

### (2) Evaluation of Iron-Nickel Alloy Powder

The iron-nickel alloy powder obtained in Examples 1 to 15 and Comparative Examples 1 to 3 were evaluated for various properties as follows.

### <Compositional Analysis>

An X-ray diffraction (XRD) measurement was performed using an X-ray diffractometer, and the presence or absence of alloy powder production was confirmed from the obtained XRD data.

### <Analysis of Metal Impurities>

The content of impurities was analyzed. The amount of oxygen was measured by an inert gas fusion method using an oxygen analyzer (TC436, manufactured by LECO Corporation), and the amounts of carbon and sulfur were measured by a combustion method using a carbon-sulfur analyzer (CS600, manufactured by LECO Corporation). The amount of chlorine was measured using a fluorescent X-ray analyzer (Magix, manufactured by Spectris Co., Ltd.), and the amount of silicon and sodium were measured using an inductively coupled plasma (ICP) emission spectrometer (5100, manufactured by Agilent Technologies, Inc.).

### <Particle Size (Average Particle Diameter, Coefficient of Variation)>

The alloy powder was observed with a scanning electron microscope (SEM; JSM-7100F, manufactured by JEOL Ltd.) (magnification: 5,000 to 80,000×). The observed images (SEM images) were analyzed and their results were used to calculate an average particle diameter as a number average and a standard deviation of the particle diameters. Furthermore, the coefficient of variation (CV value) was calculated according to formula (14) below to determine the particle size (average particle diameter and coefficient of variation) of the alloy powder.

$$\begin{matrix}[ Eq . 15 ] & \\ CV value ( \% ) = \frac{standard deviation of particle diameter}{a v erage particle diameter} \times 100 & ( 14 )\end{matrix}$$

### <Intra-Particle Compositional Analysis>

The alloy powder embedded in resin was processed into a thin film with a thickness of about 100 nm using a focused ion beam (FIB) appliance, and cross-sections of the alloy particles in the processed sample were observed using a scanning transmission electron microscope (STEM; HD-2300A, manufactured by Hitachi High-Tech Corporation). The observation was carried out under a condition of magnification: 100,000 to 200,000×. The compositional distribution within the alloy particle was determined by a spectral analysis using an energy dispersive x-ray spectroscopy (EDS) appliance. At this time, the composition was determined by calculation from the detected count number of characteristic X-rays (K-rays) of the measured elements.

### <Crystallite Diameter>

The alloy powder was analyzed by an X-ray diffraction (XRD) method, and the crystallite diameter was evaluated from a half width of an X-ray diffraction peak on a (111) plane in accordance with Scherrer's formula. The XRD measurement was carried out under the same condition as for the compositional analysis. The crystallite diameter represents a degree of crystallization. The larger the crystallite diameter is, the higher the crystallinity is.

### <Green Compact Density>

A green compact density of the alloy powder was evaluated. Specifically, cylindrical holes (inner diameter: 5 mm) of a die were filled with about 0.3 g of alloy powder. Subsequently, the alloy powder was formed into pellets with a diameter of 5 mm and a height of 3 to 4 mm at a pressure of 100 MPa using a press. Masses and heights of the obtained pellets were measured at room temperature to calculate the green compact density.

### <Green Compact Resistivity>

The green compact resistivity of the alloy powder was measured using a powder resistivity measurement system (MCP-PD51, manufactured by Mitsubishi Chemical Analytech) to evaluate electrical conductivity (insulating property). Specifically, a cylindrical sample chamber of the system was filled with about 4 g of alloy powder, and a pressure of 64 MPa was applied to the alloy powder using a press attached to the system to determine the green compact resistivity (unit: Ω·cm).

### <Magnetic Properties (Saturation Magnetic Flux Density, Coercive Force)>

The magnetic properties (saturation magnetic flux density (T: tesla), coercive force (A/m)) of the alloy powder were evaluated by measurement using a vibrating sample magnetometer (VSM). Values of the saturation magnetic flux density and the coercive force were calculated from a B-H curve (magnetic hysteresis curve) obtained in the measurement. The alloy powder obtained in Comparative Example 2 was not measured for its magnetic properties because its shape was too distorted to apply to elements such as an inductor.

### (3) Evaluation Results

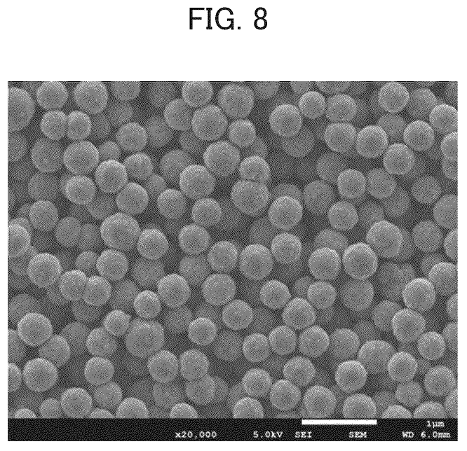

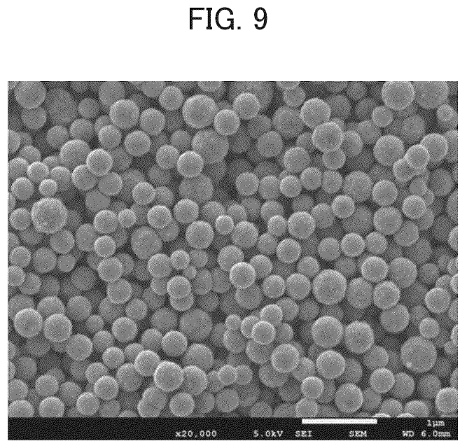

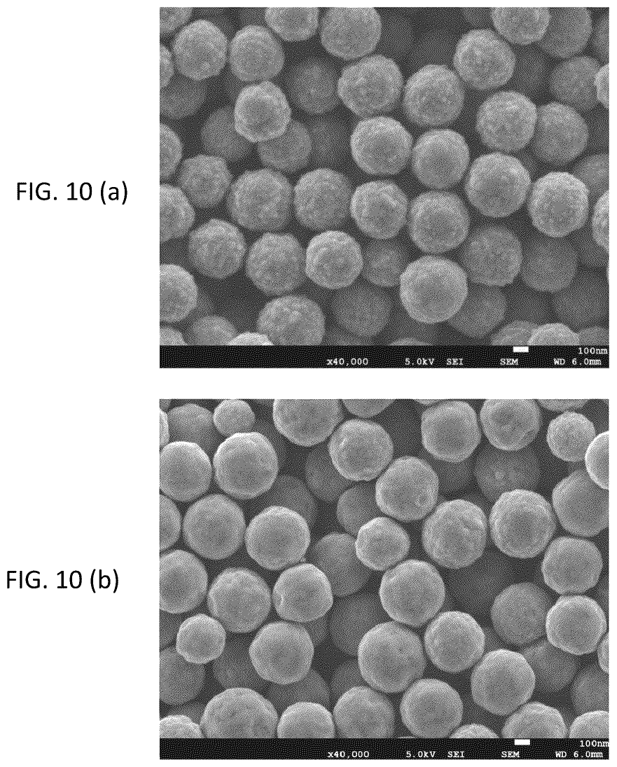

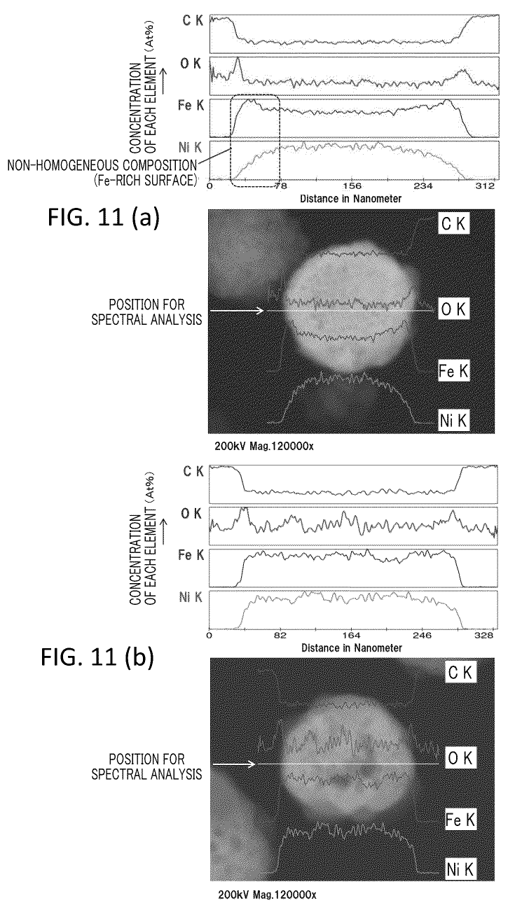

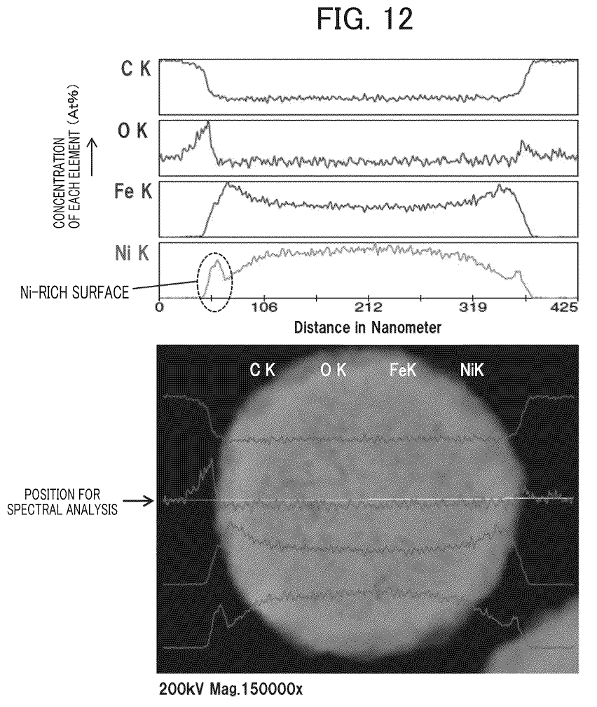

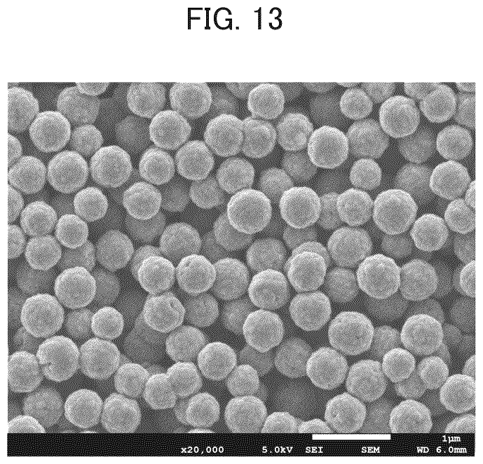

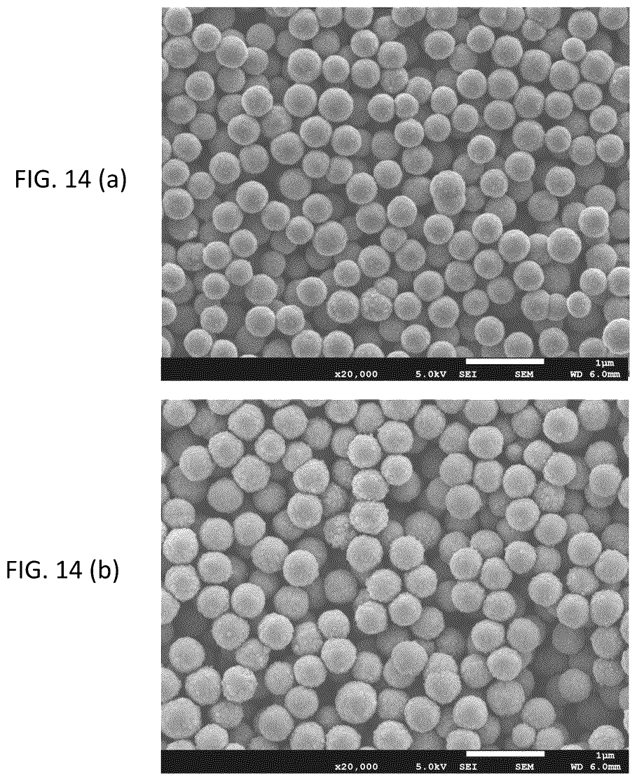

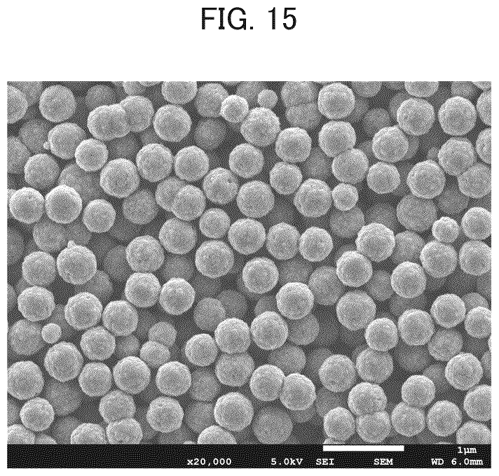

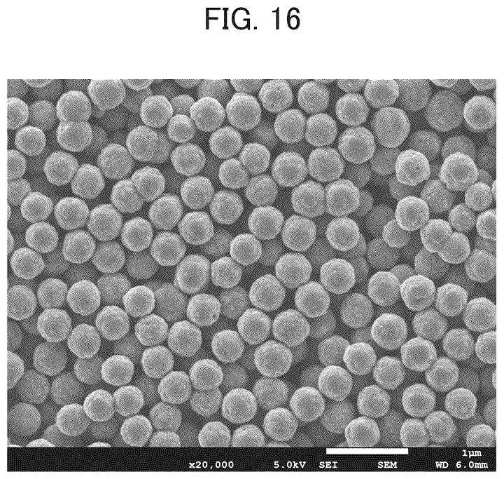

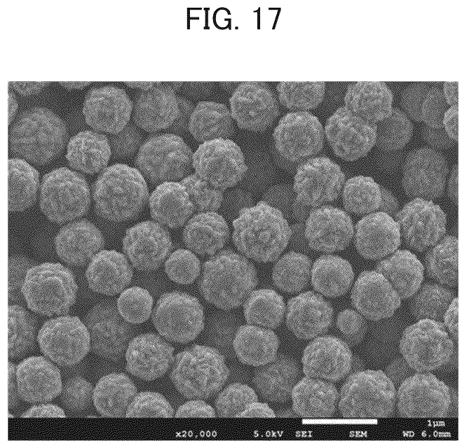

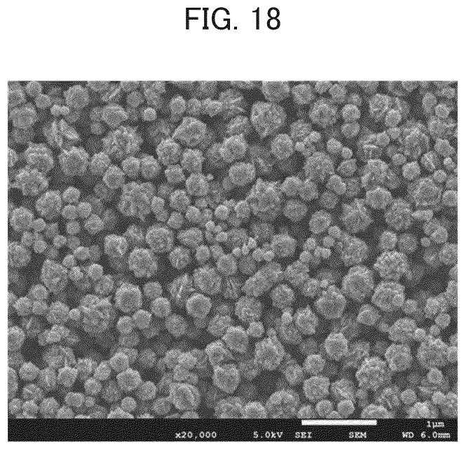

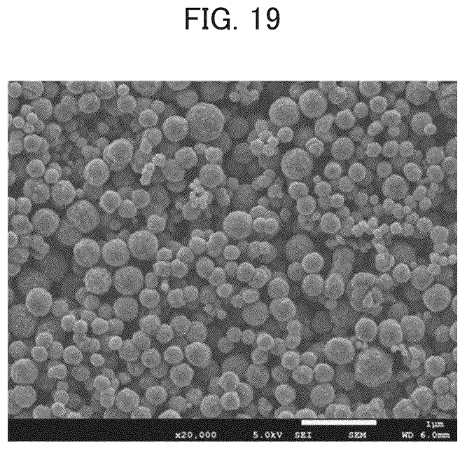

The evaluation results obtained for Examples 1 to 15 and Comparative Examples 1 to 3 are summarized in Table 2. The SEM images of the alloy powders obtained in Examples 1, 2, 10, 13, and 14 are presented in FIG. 8, FIG. 9, FIG. 13, FIG. 15, and FIG. 16 respectively, and the SEM images of the alloy powder obtained in Example 6 are presented in FIG. 10(a) and FIG. 10(b). Herein, FIG. 10(a) presents an SEM image of the alloy powder before the spiral jet crushing treatment, and FIG. 10(b) presents an SEM image of the alloy powder after the spiral jet crushing treatment. The STEM images and EDS spectral analysis results of the particle cross sections of the alloy powders obtained in Examples 8 and 9 are presented in FIG. 11(a) and FIG. 11(b), and FIG. 12 respectively. Herein, FIG. 11(a) presents a particle cross-section STEM image and an EDS spectral analysis result of the alloy powder before high-temperature heating treatment, and FIG. 11(b) presents a particle cross-section STEM image and an EDS spectral analysis result of the alloy powder after high-temperature heating treatment. The SEM images of the alloy powder obtained in Example 12 are presented in FIG. 14(a) and FIG. 14(b). Herein, FIG. 14(a) presents an SEM image of the alloy powder before the insulative coating treatment, and FIG. 14 (b) presents an SEM image of the alloy powder after the insulative coating treatment. Furthermore, SEM images of the alloy powders obtained in Comparative Examples 1 to 3 are presented in FIG. 17 to FIG. 19 respectively.

In all of Example 1, Example 3, and Comparative Examples 1 to 3, the iron-nickel alloy powder was manufactured at a reaction starting temperature of 55° C. and a reaction maintaining temperature of 70° C. in the crystallization step. In Examples 1 and 3 using a very small amount of a specific nucleating agent and complexing agent, the obtained alloy powder had an average particle diameter as small as 0.40 to 0.41 μm, and a sharp particle size distribution with a low CV value, despite the fact that the amount of hydrazine used as the reducing agent was small. The alloy powder was spherical and had a smooth surface.

On the other hand, in Comparative Example 1 using no nucleating agent, the obtained alloy powder had a larger average particle diameter of 0.65 μm compared to Examples 1 and 3, and was difficult to refine. In addition, the alloy powder was spherical but had a significant surface irregularity. In Comparative Example 2 using no complexing agent, the obtained alloy powder had a small average particle diameter of 0.26 μm but had a high CV value and a broad particle size distribution. In addition, the alloy powder had a significant surface irregularity and a distorted form. In Comparative Example 3 using no nucleating agent and complexing agent but a large amount of reducing agent (hydrazine), the obtained alloy powder was a spherical powder with a relatively smooth surface. This may be because the reduction reaction strongly acted due to a large amount of hydrazine blended. The obtained alloy powder was fine, with an average particle diameter of 0.22 μm. However, the alloy powder had a high CV value and a broad particle size distribution.

In Example 2, an iron-nickel-cobalt alloy powder was manufactured using a specific nucleating agent and complexing agent at a reaction starting temperature of 55° C. and a reaction maintaining temperature of 70° C. in the crystallization step. Despite the fact that the amount of hydrazine used as the reducing agent was small, the obtained alloy powder was fine with an average particle diameter of about 0.3 μm, and had a sharp particle size distribution. The alloy powder had a smooth surface and a spherical shape. The alloy powder had a high saturation magnetization.

In Example 5, an iron-nickel alloy powder containing 51 mol % of iron (Fe) and 49 mol % of nickel (Ni) and having a nickel-rich surface composition was manufactured by adding and mixing an additional raw material liquid containing a water-soluble nickel salt into a reaction liquid during the crystallization. The amount of oxides of the particle surface is suppressed because of formation of a dense oxide film resulting from the nickel-rich surface composition. Consequently, this alloy powder is not only more stable in ambient air but also excellent in magnetic properties such as saturation magnetic flux density.

In Example 6, a crystallized powder as a dry powder obtained through the crystallization step and recovery step was subjected to a spiral jet crushing treatment to manufacture a spherical iron-nickel alloy powder having a very smooth surface. In Example 7, a slurry crystallized powder was subjected to a high-pressure fluid collision crushing treatment after the crystallization step and during the recovery step to manufacture a spherical iron-nickel alloy powder having a very smooth surface. These alloy powders have not only smooth surfaces but also decreased agglomerated particles. As a result, the filling property was improved (green compact density was increased). Also, it is expected that the eddy current loss between particles can be improved by the decreased agglomerated particles.

In Example 8, a crystallized powder obtained at a reaction starting temperature of 71° C. and a reaction maintaining temperature of 80° C. in the crystallization step was subjected to a high-temperature heating treatment to manufacture an iron-nickel alloy powder containing 65 mol % of iron (Fe) and 35 mol % of nickel (Ni) and having improved composition homogeneity within the particle. As is evident from FIG. 11(b), this alloy powder achieved a homogeneous composition (65 mol % of iron and 35 mol % of nickel) within the particle, and is also expected to be used not only as a soft magnetic material but also as a low thermal expansion material (invar alloy).

In Example 9, an additional raw material liquid containing a water-soluble nickel salt was added and mixed into a reaction liquid during the crystallization to manufacture an iron-nickel alloy powder containing 65 mol % of iron (Fe) and 35 mol % of nickel (Ni) and having a nickel-rich surface composition. As is evident from FIG. 12, a nickel-rich layer with a thickness of about 10 to 15 nm is formed on the particle surface, and a dense oxide film resulting from this nickel-rich surface composition is formed to suppress the amount of oxides on the particle surface. Consequently, this alloy powder is not only more stable in ambient air but also excellent in magnetic properties such as saturation magnetic flux density.

In Examples 10 and 11, an iron-nickel alloy powder containing 80 mol % of iron (Fe) and 20 mol % of nickel (Ni) i.e. a high iron content and having a nickel-rich particle surface, and an iron-nickel alloy powder containing 90 mol % of iron (Fe) and 10 mol % of nickel (Ni) were manufactured while an additional raw material liquid containing a water-soluble nickel salt was added and mixed into a reaction liquid during the crystallization to enhance the reduction of iron ions (or iron hydroxide) that are difficult to reduce. Spherical alloy powders having a smooth surface, an average particle diameter of as small as 0.4 to 0.5 μm, and a sharp particle size distribution were obtained without poor reduction even with a relatively small amount of hydrazine used as a reducing agent, despite the composition close to that of pure iron due to an iron content of as large as 80 mol % to 90 mol %. The alloy powder had a saturation magnetization as high as that of pure iron powder (1.95 T to 2.0 T).

In Examples 8 to 11, the obtained iron-nickel alloy powders have a lower green compact density than those in Examples 1 to 7. However, the iron-nickel alloy powders in Examples 1 to 7 (iron-nickel alloy powder containing 56 to 50 mol % of Fe and 44 to 50 mol % of Ni, and iron-nickel-cobalt alloy powder containing 50 mol % of Fe, 40 mol % of Ni, and 10 mol % of Co) have a true specific gravity of 8.2 to 8.25, whereas the iron-nickel alloy powders in Examples 8 and 9 (iron-nickel alloy powder containing 65 mol % of Fe and 35 mol % of Ni) have a true specific gravity of 8.1, the iron-nickel alloy powder in Example 10 (iron-nickel alloy powder containing 80 mol % of Fe and 20 mol % of Ni) has a true specific gravity of 8.0, the iron-nickel alloy powder in Example 11 (iron-nickel alloy powder containing 90 mol % of Fe and 10 mol % of Ni) has a true specific gravity of 7.9. Considering that the higher the iron content is, the lower the true specific gravity of the iron-nickel alloy powder is, it is found that the green compact densities in Examples are all desirable.

In Example 12, a crystallized powder as a dry powder obtained through the crystallization step and the recovery step was subjected to an insulative coating treatment to manufacture an iron-nickel alloy powder having a particle surface coated with a highly resistive silicon dioxide (SiO₂). This alloy powder can be expected to improve the eddy current loss between the particles because the insulating property between the particles was considerably improved (the resistivity of the green compact significantly increased).

In Examples 13 to 15, a water-soluble iron salt, a water-soluble nickel salt, as well as a water-soluble cobalt salt were added to a magnetic metal source to enhance reduction of iron ions (or iron hydroxide) that are difficult to reduce, to manufacture an iron-nickel alloy powder with a cobalt content of 10 mol % to 25 mol % and a high iron content of 65 mol % to 80 mol %. Specifically, Examples 13 to 15 describe cases of manufacturing an iron-nickel-cobalt alloy powder containing 80 mol % of Fe, 10 mol % of Ni, and 10 mol % of Co; an iron-nickel-cobalt alloy powder containing 70 mol % of Fe, 10 mol % of Ni, and 20 mol % of Co; and an iron-nickel-cobalt alloy powder containing 65 mol % of Fe, 10 mol % of Ni, and 25 mol % of Co. Owing to a reduction reaction enhancing action resulting from addition of cobalt, spherical alloy powders were obtained without poor reduction even with an extremely small amount of hydrazine used as a reducing agent, despite the composition with an iron content of as large as 65 mol % to 80 mol %. The alloy powders were fine with an average particle diameter of about 0.4 μm, and had a sharp particle size distribution and a smooth surface. The alloy powders had a saturation magnetization as high as or higher than that of pure iron powder (1.95 T to 2.0 T).

Furthermore, the true specific gravities of the iron-nickel alloy powders obtained in Examples 13 to 15 (iron-nickel-cobalt alloy powders) were estimated to be about 8.0 to 8.1, but the green compact densities in all examples were high and desirable. This may be because the reduction reaction was completed before agglomeration between the particles proceeded due to the reduction reaction enhancing effect resulting from the cobalt addition, and as a result, agglomeration between the particles during the crystallization was suppressed. This may also be because the filling property of the particles was improved by spheroidization enhancement as another action resulting from the cobalt addition.

TABLE 2
Properties of Iron-Nickel Alloy Powder

| | | | | Particle diameter | | | | |
|---|---|---|---|---|---|---|---|---|
| | | | | Average | | | | |
| | | Particle properties | | particle | CV | Impurities (% by mass) | | |
| | Alloy | | Surface | diameter | value | Oxygen | Carbon | Chlorine |
| | composition | Shape | properties | (μm) | (%) | (O) | (C) | (Cl) |
| Example1 | Fe50—Ni50 | Spherical | Smooth | 0.41 | 9.0 | 1.9 | 0.05 | 0.003 |
| Example2 | Fe50—Ni40—Co10 | Spherical | Smooth | 0.33 | 19.9 | 1.6 | 0.04 | 0.002 |
| Example3 | Fe50—Ni50 | Spherical | Smooth | 0.40 | 15.1 | 1.8 | 0.04 | 0.003 |
| Example4 | Fe56—Ni44 | Spherical | Smooth | 0.38 | 11.7 | 2.0 | 0.04 | <0.001 |
| Example5 | Fe51—Ni49 | Spherical | Smooth | 0.40 | 13.5 | 1.2 | 0.04 | <0.001 |
| Example6 | Fe50—Ni50 | Spherical | Very smooth | 0.41 | 9.0 | 2.2 | 0.05 | 0.003 |
| Example7 | Fe50—Ni50 | Spherical | Very smooth | 0.41 | 9.0 | 2.1 | 0.05 | 0.003 |
| Example8 | Fe65—Ni35 | Spherical | Smooth | 0.27 | 14.1 | 1.9 | 0.05 | <0.001 |
| Example9 | Fe65—Ni35 | Spherical | Smooth | 0.39 | 11.5 | 1.3 | 0.04 | <0.001 |
| Example10 | Fe80—Ni20 | Spherical | Smooth | 0.48 | 10.4 | 1.2 | 0.02 | <0.001 |
| Example11 | Fe90—Ni10 | Spherical | Smooth | 0.38 | 9.9 | 0.9 | 0.01 | <0.001 |
| Example12 | Fe55—Ni45 | Spherical | Smooth | 0.43 | 8.2 | — | — | <0.001 |
| | (Insulative coat) | | | (0.39) | (8.1) | (2.0) | (0.05) | (<0.001) |
| Example13 | Fe80—Ni10—Co10 | Spherical | Smooth | 0.42 | 13.7 | 1.0 | 0.02 | <0.001 |
| Example14 | Fe70—Ni10—Co20 | Spherical | Smooth | 0.40 | 6.8 | 0.9 | 0.02 | <0.001 |
| Example15 | Fe65—Ni10—Co25 | Spherical | Smooth | 0.42 | 12.5 | 0.8 | 0.02 | <0.001 |
| Comparative | Fe50—Ni50 | Spherical | Very | 0.65 | 14.8 | 1.6 | 0.05 | 0.003 |
| Example1 | | | irregular | | | | | |
| Comparative | Fe50—Ni50 | Distorted | Very | 0.26 | 40.5 | 2.3 | 0.02 | 0.002 |
| Example2 | | | irregular | | | | | |
| Comparative | Fe50—Ni50 | Spherical | Relatively | 0.22 | 42.4 | 2.1 | 0.01 | 0.002 |
| Example3 | | | smooth | | | | | |

| | | | | | Magnetic properties | | |
|---|---|---|---|---|---|---|---|
| | | | | | Saturation | | Green |
| | Impurities (% by mass) | | | Crystallite | magnetic | Coercive | compact |
| | Sulfur | Sodium | Silicon | diameter | flux density | force | density |
| | (S) | (Na) | (Si) | (nm) | (T) | (A/m) | (g/cm3 |
| Example1 | <0.01 | 0.13 | <0.1 | 6.4 | 1.22 | 1194 | 3.70 |
| Example2 | <0.01 | 0.09 | <0.1 | 9.2 | 1.42 | 1194 | 3.94 |
| Example3 | <0.01 | 0.13 | <0.1 | 8.4 | 1.23 | 1194 | 3.75 |
| Example4 | <0.01 | 0.20 | <0.1 | 5.5 | 1.40 | 1600 | 3.70 |
| Example5 | <0.01 | 0.19 | <0.1 | 5.7 | 1.36 | 1660 | 3.73 |
| Example6 | <0.01 | 0.13 | <0.1 | 5.2 | 1.22 | 1194 | 4.05 |
| Example7 | <0.01 | 0.13 | <0.1 | 5.5 | 1.22 | 1194 | 3.96 |
| Example8 | <0.01 | 0.16 | <0.1 | 10.3 | 1.55 | 2590 | 3.49 |
| Example9 | <0.01 | 0.15 | <0.1 | 11.4 | 1.55 | 1790 | 3.64 |
| Example10 | <0.01 | 0.09 | <0.1 | 20.6 | 1.80 | 1220 | 3.61 |
| Example11 | <0.01 | 0.02 | <0.1 | 26.1 | 1.91 | 2662 | 3.55 |
| Example12 | <0.01 | 0.20 | 1.0 | 4.8 | 1.33 | 1230 | 3.52 |
| | (<0.01) | (0.20) | (<0.1) | (4.6) | (1.38) | (1530) | (3.69) |
| Example13 | <0.01 | 0.03 | <0.1 | 19.6 | 2.00 | 1100 | 3.84 |
| Example14 | <0.01 | 0.03 | <0.1 | 18.3 | 2.06 | 1090 | 4.07 |
| Example15 | <0.01 | 0.03 | <0.1 | 16.4 | 2.10 | 1280 | 4.02 |
| Comparative | <0.01 | 0.13 | <0.1 | 10.3 | 1.18 | 1353 | 3.72 |
| Example1 | | | | | | | |
| Comparative | <0.01 | 0.05 | <0.1 | 11.7 | — | — | 3.42 |
| Example2 | | | | | | | |
| Comparative | <0.01 | 0.06 | <0.1 | 11.3 | 1.19 | 1194 | 3.58 |
| Example3 | | | | | | | |

Note 1)
“—” represents “unmeasured”.
Note 2)
The value in the parentheses represents a value before the insulative coating treatment.

1. A method for manufacturing an iron (Fe)-nickel (Ni) alloy powder comprising at least iron (Fe) and nickel (Ni) as magnetic metals, the method comprising;
a preparation step in which a magnetic metal source, a nucleating agent, a complexing agent, a reducing agent, and a pH adjusting agent are prepared as a starting material;
a crystallization step in which a reaction liquid comprising the starting material and water is prepared, and a crystallization powder comprising the magnetic metals is crystallized by a reduction reaction in the reaction liquid; and
a recovery step in which the crystallized powder is recovered from the reaction liquid,
the magnetic metal source comprising a water-soluble iron salt and a water-soluble nickel salt;
the nucleating agent comprising a water-soluble salt of a metal more noble than nickel;
the complexing agent comprising at least one selected from a group consisting of hydroxycarboxylic acids, hydroxycarboxylic acid salts, and hydroxycarboxylic acid derivatives;
the reducing agent comprising hydrazine (N₂H₄);
the pH adjusting agent comprising an alkali hydroxide.

2. The method according to claim 1, wherein the water-soluble iron salt is at least one selected from a group consisting of ferrous chloride (FeCl₂), ferrous sulfate (FeSO₄), and ferrous nitrate (Fe(NO₃)₂).

3. The method according to claim 1, wherein the water-soluble nickel salt is at least one selected from a group consisting of nickel chloride (NiCl₂), nickel sulfate (NiSO₄), and nickel nitrate (Ni(NO₃)₂).

4. The method according to claim 1, wherein
the nucleating agent is at least one selected from a group consisting of a copper salt, a palladium salt, and a platinum salt.

5. The method according to claim 1, wherein the complexing agent is at least one hydroxycarboxylic acid selected from tartaric acid ((CH(OH)COOH)₂) and citric acid (C(OH)(CH₂COOH)₂COOH).

6. The method according to claim 1, wherein the pH adjusting agent is at least one selected from sodium hydroxide (NaOH) and potassium hydroxide (KOH).

7. The method according to claim 1, wherein
the magnetic metals further comprise cobalt (Co), and
the magnetic metal source further comprises a water-soluble cobalt salt.

8. The method according to claim 7, wherein in the magnetic metals, an iron (Fe) content is 60 mol % or more and 85 mol % or less, and a cobalt (Co) content is 10 mol % or more and 30 mol % or less, and
the magnetic metal source comprises 60 mol % or more and 85 mol % or less of the water-soluble iron salt and 10 mol % or more and 30 mol % or less of the water-soluble cobalt salt.

9. The method according to claim 7, wherein the water-soluble cobalt salt is at least one selected from a group consisting of cobalt chloride (CoCl₂), cobalt sulfate (CoSO₄), and cobalt nitrate (Co(NO₃)₂).

10. The method according to claim 1, wherein the starting material further comprises an amine compound having two or more primary amino groups (—NH₂), one primary amino group (—NH₂) and one or more secondary amino group (—NH—), or two or more secondary amino groups (—NH—) in a molecule thereof.

11. The method according to claim 10, wherein the amine compound is at least one of an alkyleneamine or an alkyleneamine derivative.

12. The method according to claim 11, wherein the alkyleneamine and/or the alkyleneamine derivative has at least a structure represented by formula (A) below in which nitrogen atoms of an amino group in its molecule bind to each other via a carbon chain having 2 carbon atoms.

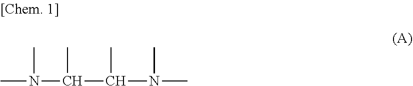

13. The method according to claim 10, wherein the amine compound is at least one alkyleneamine selected from a group consisting of ethylenediamine (H₂NC₂H₄NH₂), diethylene triamine (H₂NC₂H₄NHC₂H₄NH₂), triethylene tetramine (H₂N(C₂H₄NH)₂C₂H₄NH₂), tetraethylene pentamine (H₂N(C₂H₄NH)₃C₂H₄NH₂), pentaethylene hexamine (H₂N(C₂H₄NH)₄C₂H₄NH₂), and propylene diamine (CH₃CH(NH₂)CH₂NH₂), and/or at least one alkyleneamine derivative selected from a group consisting of tris(2-aminoethyl)amine (N(C₂H₄NH₂)₃), N-(2-aminoethyl)ethanolamine (H₂NC₂H₄NHC₂H₄OH), N-(2-aminoethyl)propanolamine (H₂NC₂H₄NHC₃H₆OH), 2,3-diaminopropionic acid (H₂NCH₂CH(NH)COOH), ethylenediamine-N,N′-diacetic acid (HOOCCH₂NHC₂H₄NHCH₂COOH), and 1,2-cyclohexane diamine (H₂NC₆H₁₀NH₂).

14. The method according to claim 10, wherein a blended amount of the amine compound with respect to a total amount of the magnetic metals is 0.01 mol % or more and 5.00 mol % or less.

15. The method according to claim 1, wherein, when preparing the reaction liquid in the crystallization step, a metal salt raw material solution comprising the magnetic metal source, the nucleating agent, and the complexing agent that are dissolved in water; a reducing agent solution comprising the reducing agent that is dissolved in water; and a pH adjusting solution comprising the pH adjusting agent that is dissolved in water, are individually prepared, the metal salt raw material solution and the pH adjusting solution are mixed to prepare a mixed solution, and the mixed solution and the reducing agent solution are mixed.

16. The method according to claim 15, wherein, when preparing the reaction liquid, the pH adjusting solution and the reducing agent solution are sequentially added and mixed into the metal salt raw material solution.

17. The method according to claim 15, wherein a time required for mixing the mixed solution and the reducing agent solution is set to 1 second or longer and 180 seconds or shorter.

18. The method according to claim 1, wherein, when preparing the reaction liquid in the crystallization step, the metal salt raw material solution comprising the magnetic metal source, the nucleating agent, and the complexing agent that are dissolved in water, and a reducing agent solution comprising the reducing agent and the pH adjusting agent that are dissolved in water are individually prepared, and the metal salt raw material solution and the reducing agent solution are mixed.

19. The method according to claim 18, wherein, when preparing the reaction liquid, the reducing agent solution is added to the metal salt raw material solution, or conversely, the metal salt raw material solution is added and mixed into the reducing agent solution.

20. The method according to claim 18, wherein a time required for mixing the metal salt raw material solution and the reducing agent solution is set to 1 second or longer and 180 seconds or shorter.

21. The method according to claim 1, wherein, in the crystallization step, before the reduction reaction is completed, an additional raw material liquid comprising at least any one of the water-soluble nickel salt or the water-soluble cobalt salt that is dissolved in water is further added and mixed into the reaction liquid.

22. The method according to claim 15, wherein an amine compound is added to at least one of the metal salt raw material solution, the reducing agent solution, the pH adjusting solution, or the reaction liquid.

23. The method according to claim 1, wherein a temperature of the reaction liquid at the time of starting the crystallization of the crystallization powder (reaction starting temperature) is 40° C. or higher and 90° C. or lower, and a temperature of the reaction liquid maintained during the crystallization after the start of the crystallization (reaction maintaining temperature) is 60° C. or higher and 99° C. or lower.

24. The method according to claim 1, further comprising a crushing step in which the crystallized powder after the recovery step or the crystallized powder during the recovery step is subjected to a crushing treatment using a collision energy to crush agglomerated particles contained in the crystallized powder.

25. The method according to claim 24, wherein the crystallized powder after the recovery step is crushed by a dry crushing or a wet crushing, or the crystallized powder during the recovery step is crushed by the wet crushing.

26. The method according to claim 25, wherein the dry crushing is spiral jet crushing.

27. The method according to claim 25, wherein the wet crushing is a high-pressure fluid collision crushing.

28. The method according to claim 1, further comprising a high-temperature heating step in which the crystallized powder after the recovery step or the crystallized powder during the recovery step is heated in an inert atmosphere, a reducing atmosphere, or a vacuum atmosphere at a temperature higher than 150° C. and 400° C. or lower to improve composition homogeneity within the particle of the iron (Fe)-nickel (Ni) alloy powder.

29. The method according to claim 1, further comprising an insulative coating step in which the crystallized powder obtained through the recovery step is subjected to an insulative coating treatment to form an insulative coat layer composed of a metal oxide on particle surfaces of the crystallized powder, thereby improving an insulating property between the particles.

30. The method according to claim 29, wherein, in the insulative coating step, the crystallized powder is dispersed in a mixed solvent comprising water and an organic solvent, and a metal alkoxide is further added and mixed into the mixed solvent to prepare a slurry, the metal alkoxide is subjected to hydrolysis and dehydration-condensation polymerization in the slurry to form an insulative coat layer composed of a metal oxide on the particle surfaces of the crystallized powder, and then the crystallized powder having the insulative coat layer is recovered from the slurry.

31. The method according to claim 30, wherein the metal alkoxide is composed mainly of a silicon alkoxide (alkyl silicate), and the metal oxide is composed mainly of silicon dioxide (SiO₂).

32. The method according to claim 30, wherein the hydrolysis of the metal alkoxide is carried out in the coexistence of a base catalyst (alkali catalyst).
